(19) United States
(12) Patent Application Publication
(10) Pub. No.: US 2026/0228395 A1
(43) Pub. Date: Aug. 6, 2026

(54) AI-ASSISTED SYSTEM AND METHOD FOR MANAGING AND EXECUTING CHANGE ORDERS IN BUILDING DESIGN PLANS

(71) Applicant: Togal.AI Inc., Miami, FL (US)

(72) Inventors: Patrick E Murphy, Miami, FL (US); Johnny Maghzal, Miami, FL (US); Thomas Patrick Murphy, Miami, FL (US)

(73) Assignee: Togal.AI Inc., Miami, FL (US)

(21) Appl. No.: 19/288,212

(22) Filed: Aug. 1, 2025

Related U.S. Application Data
(60) Provisional application No. 63/752,185, filed on Jan. 31, 2025.

(51) Int. Cl. G06F 30/27; G06F 30/13

(52) U.S. Cl. CPC G06F 30/27; G06F 30/13; G06F 2111/02

(57) ABSTRACT

Methods, systems, and apparatus for AI-assisted management of change orders in building design plans are disclosed. The system integrates a controller that processes a design plan, represents it as dynamic components, and generates an interactive user interface for initiating and managing change orders. Users can input change order details, including budget, timeline, and materials, while the controller analyzes potential conflicts with design considerations, surrounding spaces, and interdependent sub-plans. Notifications are sent to affected parties for review, approval, or modification. Upon approval, the system updates the design plan and related sub-plans and provides detailed construction constraints. Automated suggestions optimize materials, labor, costs, and timelines while enabling resource reallocation and utilization of surplus materials. By leveraging real-time collaboration and AI-driven analysis, the invention simplifies change order processes, streamlines execution, and enhances adaptability in complex construction projects.

### CROSS REFERENCE TO RELATED APPLICATIONS

This application claims the benefit of U.S. Provisional Patent Application Ser. No. 63/752,185, filed Jan. 31, 2025, and entitled AI-ASSISTED SYSTEM AND METHOD FOR MANAGING AND EXECUTING CHANGE ORDERS IN BUILDING DESIGN PLANS, the entire contents of which are incorporated herein by reference in their entirety.

### FIELD OF THE INVENTION

The present invention relates to systems, methods, and apparatuses for dynamically managing design plans and associated sub-plans for buildings and structures. Specifically, the invention pertains to a controller-based system utilizing artificial intelligence (AI) and generative adversarial networks (GANs) to process and implement change orders in real-time, while analyzing and updating architectural, electrical, plumbing, HVAC, and structural plans. The invention further facilitates collaboration among multiple stakeholders, including owners, contractors, and regulatory authorities, by providing automated suggestions, construction constraints, and interactive user interfaces. These features enhance the efficiency, accuracy, and adaptability of design plan modifications, addressing interconnected dependencies and optimizing resource allocation.

### BACKGROUND OF THE INVENTION

Construction projects are initiated with an extensive and detailed design plan that outlines every component of a building to be constructed. The design plan is a set of documents that provide a structured roadmap for the entire project, covering aspects such as layout, materials, and the sequence of construction. It is important for setting clear expectations among stakeholders, including clients, architects, engineers, and contractors, and for guiding all construction activities in a cohesive manner. The design plan serves as the foundation of the project, facilitating that each system and structural element is thoroughly mapped out before work begins.

Within a comprehensive design plan, there are multiple sub-plans, each addressing a specific building system or structural aspect. These sub-plans encompass architectural, structural, plumbing, electrical, HVAC (heating, ventilation, and air conditioning), fire safety, telecommunications, and sometimes even landscaping elements. Each of these sub-plans provides detailed instructions and specifications, enabling specialized contractors to complete their tasks with precision. The interplay between these plans is intricate, as each system must not only meet its functional requirements but also integrate seamlessly with the others, preventing conflicts during construction.

Each design plan in a construction project is interconnected, meaning that changes to one system can have wide-reaching effects on others. For example, relocating a load-bearing wall in the structural plan can disrupt the paths available for plumbing pipes, HVAC ducts, and electrical conduits. Such interdependencies necessitate rigorous coordination to avoid conflicts during construction. When a change is made to a design plan, the impact must be assessed across all other plans to avoid unintended consequences, highlighting the need for flexibility and accurate communication.

The complexity of design plans increases with the size and purpose of the building. In large commercial projects or multi-functional spaces, design documents may include dozens of individual plans, each with specialized requirements and highly detailed specifications. High-rise buildings, for example, require multiple structural plans to manage the weight distribution across floors, detailed HVAC layouts to control temperature on each level, and specific fire safety plans for emergency evacuation. Each plan must integrate seamlessly to maintain the project's overall integrity and functionality.

Construction projects often face unforeseen circumstances that necessitate deviations from the original design plans. These unexpected issues range from discovering unstable soil at the foundation site to encountering previously unknown underground utilities. Such discoveries require immediate adjustments to the structural plan and, in many cases, influence plumbing and electrical layouts. Documenting these changes through change orders is required to maintain clarity and prevent miscommunication among team members.

Changes in client preferences are another common reason for deviations from the original design plan. Clients frequently request additional features, room layout modifications, or aesthetic upgrades during construction. For example, a client may decide to add a larger conference room or additional amenities after construction has begun or even before construction starts. These changes affect multiple systems, including architectural, structural, HVAC, and electrical layouts, all of which must be revised to meet the client's updated requirements.

Construction delays due to weather, labor shortages, or supply chain issues can also necessitate design modifications. If certain materials are unavailable or if scheduling delays occur, contractors may need to substitute materials or alter construction sequences. Such substitutions or delays often impact design specifications, requiring changes to various plans to accommodate revised materials or timelines. A structured change order process is required to document these modifications and provide clear guidance to all stakeholders.

Securing approvals for change orders in a traditional process can be time-consuming, often resulting in bottlenecks that delay construction progress. Approval delays stem from inefficient communication, as stakeholders may lack access to complete information or may need to consult multiple sources. This lack of accessibility creates a slow feedback loop that hampers project momentum.

In construction projects, changes in one system can have a cascading effect on other systems, impacting cost, labor, and resource allocations that have often been pre-negotiated with different contractors. For example, if a structural modification is made, such as moving a load-bearing wall, this alteration may require adjustments in the electrical and plumbing plans to accommodate the new layout. The repositioning of wiring and pipes often means additional labor hours, new materials, or re-routing, directly affecting the previously agreed-upon terms with contractors responsible for electrical and plumbing systems. As a result, these contractors must review and approve any changes in labor requirements and material costs before proceeding with the revised work.

Furthermore, such changes may alter the original cost and labor agreements that were previously finalized through competitive bidding or negotiated contracts. A new round of approvals becomes necessary to update and formalize these revised terms, so that all parties are aligned on the budgetary and logistical shifts required to accommodate the changes. Contractors impacted by these adjustments must agree to the modified terms before moving forward, as these modifications can affect their resource allocation, scheduling, and profit margins. This interconnected process highlights the complexity of coordinating multiple contractors and underscores the importance of effective change order management to address both cost and labor implications across all impacted systems.

The effects of change orders permeate every stage of construction, necessitating careful documentation and communication to align all stakeholders. Traditional methods of handling these changes often struggle to keep up with the complexities of modern construction projects, as each change must be assessed for its impact on other systems. The limitations of manual processes reveal a need for a more advanced approach to change order management.

Real-time visibility into change orders is often lacking in traditional processes, complicating decision-making. Without up-to-date information, project managers, clients, and contractors may struggle to understand the full scope of each change and its effect on the project. This lack of clarity can lead to misaligned expectations and hinder timely responses to evolving construction needs.

The construction industry's reliance on manual and disconnected change order processes highlights the need for a streamlined, integrated approach. A system that connects design plan adjustments with cost, time, approvals, and labor projections would significantly enhance project efficiency. An advanced approach is needed to provide transparency, accountability, and adaptability in handling change orders across all systems of a construction project.

### SUMMARY OF THE DISCLOSURE

Accordingly, the present invention provides an innovative platform that receives an initial design plan, which may include a comprehensive set of design plans, various sub-design plans, or at least an interrelated design plan representing one or more building systems. The initial design plan may be processed by a controller running an AI engine and/or a Generative Adversarial Network (GAN) engine, which collectively interprets, analyzes, and manages each design element within the design plan. The controller analyzes the design plan to identify various design elements, such as structural components, electrical layouts, plumbing pathways, HVAC systems, fire safety mechanisms, and telecommunications frameworks. The controller may categorize each design element, allowing the controller to establish interdependencies and potential points of interaction between different building systems.

The controller presents the analyzed design plan on an interactive user interface, which visually displays the design elements as dynamic components, allowing users, such as contractors, engineers, architects, sub-contractors, or clients to interact with the design plan in real-time. Through the user interface, users can register, edit, or add a change order directly within the design plan. For example, if a contractor identifies the need to move a structural wall to accommodate a change in the layout, they can input this change order on the user interface. Similarly, a subcontractor may propose changes to plumbing routes to accommodate new water fixtures or update electrical wiring placements due to regulatory adjustments. The interactive user interface enables users to visualize how each change impacts other design elements, enhancing collaborative decision-making and minimizing the risk of isolated changes causing unforeseen conflicts in other building systems.

Once a change order is registered, the controller's AI engine may assess its potential impacts on related design elements and sub-plans. The controller's analytical capabilities allow it to calculate various consequences of the change, such as updated material requirements, additional labor hours, revised scheduling, and overall cost adjustments. For example, a change in HVAC duct placement may impact the architectural and structural layout, requiring the controller to recalculate load-bearing requirements or adjust wall placements. By identifying these interdependencies, the controller prevents costly errors and delays by facilitating that all necessary adjustments are accounted for in response to a single change.

Beyond impact assessment, the controller also analyzes the cost, labor, material, and timeline requirements of the impacted design plan relative to the initial agreed-upon design plan. This comparison enables the platform to provide a clear understanding of how changes may affect overall project costs and resources, helping stakeholders manage budgets more effectively. The AI engine is capable of predicting potential labor reallocations, additional material expenses, and time adjustments, thus facilitating that the implications of each modification are accurately documented and communicated to all parties.

After analyzing the changes, the controller may send notifications to involved parties, such as subcontractors, contractors, clients, and regulatory authorities outlining the revised cost, labor, and material requirements for their review and acceptance. For example, if a change to the structural design affects the electrical routing, the electrical contractor may receive a notification of the new labor and cost estimates associated with the change. This notification may include the comparison between the original and modified parameters, allowing contractors to understand the exact impact of the modification and make an informed decision on whether to accept or negotiate the new terms.

The controller may also support automated re-bidding when significant changes alter cost structures or contractual terms. If a modification substantially increases or decreases the scope of work, the controller generates updated project requirements and distributes these to relevant contractors for revised bids. This feature may foster a transparent bidding process that aligns with the revised project scope, allowing all impacted parties to accurately reassess labor and material costs. By providing these updates, the platform helps in determining compliance with contractual obligations and supports fair compensation for any additional work or resources necessitated by change orders.

Additionally, the platform maintains a centralized digital record of all registered changes, approvals, and communications related to each design plan. The digital record functions as a comprehensive audit trail, providing stakeholders with a reliable reference for every modification made throughout the project lifecycle. In doing so, the invention facilitates enhanced project transparency, enabling contractors, clients, and project managers to review the history of each design adjustment and its associated impacts on other systems.

The controller may further be equipped to support predictive analysis for future change orders by learning from previous adjustments. Through AI-driven analytics, the platform can predict common impact patterns, such as how structural changes frequently affect plumbing and electrical layouts. By identifying these patterns, the controller can provide proactive suggestions for design plans, reducing the need for future modifications and enhancing project efficiency from the outset.

The invention may also provide a modular user interface that allows different users to view and interact with specific design elements relevant to their role. For example, structural engineers may access detailed structural configurations, while HVAC contractors can view airflow and vent placements. This role-specific user interface design enhances usability and reduces information overload, providing each user with relevant data to facilitate focused and informed decision-making.

In some embodiments, the invention provides a method and apparatus for managing change orders in a building design plan through a combination of advanced Artificial Intelligence (AI) and Generative Adversarial Network (GAN) engines. The apparatus comprises a display screen configured to present an interactive user interface, a digital storage medium comprising executable software code, and a controller equipped with a processor to execute the software code. The apparatus facilitates the seamless integration, modification, and implementation of change orders within a design plan while considering associated initial constraints and interdependencies.

The process begins when the controller receives an initial design plan of at least a portion of a building. This design plan, which may include architectural blueprints, structural layouts, or other technical schematics, serves as the foundational representation of the building. The input file may be submitted in various formats, such as CAD files, PDFs, or raster images. The controller processes the design plan using AI analysis, identifying elements such as walls, doors, windows, and other architectural features or design elements. The resulting data forms the basis for the interactive user interface, enabling users to view and interact with the design.

The interactive user interface generated by the controller provides users with a dynamic platform to engage with the design plan. Users can view the spatial relationships and dimensions of various design elements and utilize functionalities like zooming, annotating, and selecting specific components for modification. For example, a contractor may view a detailed layout of a residential building and identify a wall section that needs to be relocated as a change order. The user interface may also incorporate drag-and-drop functionality, allowing users to move design elements, such as relocating windows, repositioning doors, or resizing rooms, with ease.

Through the interactive user interface, users can submit change order requests specifying modifications to one or more design elements. For example, a user may request the addition of a balcony, the installation of energy-efficient windows, or the removal of a partition wall. Each change order request can include a detailed description, supporting documents, and constraints such as a fixed budget or timeline. For example, a homeowner may request the installation of a skylight with a maximum cost constraint of $5,000.

Once the change order request is received, the controller analyzes its impact on the design plan. This analysis may include identifying conflicts with existing design considerations, such as regulatory requirements, structural integrity, or spatial interdependencies. For example, if a user requests a larger window in a load-bearing wall, the controller assesses whether this modification compromises the wall's structural integrity. The controller also simulates the requested change within the design plan to identify potential conflicts or challenges, such as overlapping systems, insufficient clearances, or compliance issues with preferred building practices.

In addition to identifying potential conflicts, the controller may calculate a set of updated constraints based on the change order request. These updated constraints may include recalculated values for one or more of time, cost, labor, and materials required to implement the changes. For example, if a change order involves the installation of high-grade flooring, the updated constraints may reflect an increase in material costs and labor hours. The recalculated constraints may be displayed on the interactive user interface, allowing the user to review and compare them with the initial constraints.

The interactive user interface may also provide automated recommendations to support the user's decision-making process. For example, the controller may recommend cost-optimized materials, such as alternative tiles or prefabricated components, which align with the user's budget constraints. The apparatus may be integrated with procurement systems, enabling users to view material availability, pricing, and delivery options in real time. For example, a user may select a recommended window type, place an order through the interface, and schedule its delivery to align with the construction timeline.

In scenarios where the change order affects other stakeholders, such as neighboring property owners, contractors, or regulatory authorities, the controller identifies these parties and sends them notifications through their respective user interfaces. These stakeholders can review the change order details, provide approvals or rejections, and propose conditions or modifications. For example, a contractor may approve a change order for a new balcony but request additional labor hours to complete the work. The controller consolidates these inputs and integrates them into the updated design plan and constraints.

The apparatus also supports the generation of sub-plans based on the change order and updated constraints. For example, if a change order involves adding a bathroom, the controller may generate corresponding sub-plans for plumbing, electrical systems, and HVAC. These sub-plans are automatically updated to reflect the new configuration and are displayed on the user interface for review. This feature facilitates that all interrelated systems are aligned with the requested modifications.

Further, the user interface may also include options for defining fixed or flexible construction constraints, allowing users to prioritize specific parameters. For example, a user may set a cost ceiling while allowing flexibility in the timeline. Based on these inputs, the controller generates tailored suggestions to optimize construction resources. For example, if the timeline is flexible, the controller may recommend staggered labor schedules to reduce costs.

In some embodiments, the controller integrates external data sources, such as weather forecasts, regulatory updates, and supplier inventories, to enhance its analysis and recommendations. For example, if a change order involves exterior work, the controller may recommend scheduling the construction during favorable weather conditions to avoid delays. Similarly, if a specific material is unavailable or costly, the controller suggests alternatives or adjusts the timeline to accommodate delays.

The apparatus also enables collaborative workflows, allowing multiple users to discuss, request, and approve change orders in real time. For example, an architect, contractor, and homeowner can simultaneously view the updated design plan, review constraints, and make collaborative decisions through shared annotations and notifications.

Upon finalizing the change order, the controller generates a comprehensive report summarizing the modifications, updated constraints, and sub-plans. This report may be accessible to all stakeholders, providing transparency and accountability. The apparatus streamlines the change order management process, facilitating efficient implementation while minimizing conflicts and optimizing resource allocation.

The integration of AI engine to generate dynamic and interactive user interfaces based upon static design plan documents presented new opportunities to overcome the limitations of traditional annotation methods. AI technologies are used to automate updating of annotations in response to changes in the dynamic interface based upon a static design plan, predict the impact of such changes (and/or annotations), and facilitate more effective communication among stakeholders over a time sequence. The present invention facilitates a shift towards more intelligent, responsive, and collaborative design tools allowing spatially relevant annotation provided by one or both of a user and an AI Engine (or other automation).

The proposed invention aims to significantly improve communication and efficiency among architects, engineers, and stakeholders by providing a shared space where users can collaboratively annotate, discuss, and modify design plans in real time. This environment fosters a more inclusive and dynamic design process, where feedback and changes are instantly shared and addressed (through AI-assisted analysis), reducing the need for multiple meetings or extensive email chains.

In some embodiments, the present disclosure provides methods, apparatus and systems for users (e.g.: architects, owners, developers, engineers, compliance reviewers, builders, and other users to annotate a dynamic interface based upon a static two-dimensional (sometimes referred to herein as “2D”) or three dimensional (sometimes referred to herein as “3D”) references, such as floorplans, design plans, blueprints, and the like, with the aid of artificial intelligence (sometimes referred to herein as “AI” and an AI platform programmed to accomplish the methods described herein as an “AI Engine”).

According to the present invention, automated systems, apparatus, and methods provide tools that empower users to select spatial designations, such as those associated with specific segments, elements or components within a design plan and associate one or more annotations with the spatial designation and/or segment, element, or component. In some embodiments, automated processes discern a specific type of element present within a design plan based on a pixel-level examination by the AI engine. Elements may encompass a diverse array of features, including but not limited to: walls, windows, doors, stairwells, staircases, ramps, ceilings, floors, columns, beams, roofs, skylights, facades, and an assortment of other architectural components. Furthermore, the present invention provides users with the capability to intelligently annotate these elements (including annotating lines and polygons), significantly enhancing the precision and utility of design plan modifications. This dynamic annotation process, (which may be powered by the AI engine) allows for annotations to adapt in real time to changes within the design plans.

In some embodiments, annotations may be designated to remain accurately aligned with an intended design element, even as modifications are made to the design element and/or other aspects of the design plan. The AI engine may facilitate spatial alignment of an annotation by automatically updating annotations based on the AI Engine's analysis of design components' spatial relationships and dimensions. This level of intelligence in annotation not only streamlines the design review and modification process but also enhances collaborative efforts by maintaining a consistent and up-to-date representation of the design intent across all user interactions.

By enabling detailed and dynamic annotations in a user interface based upon a static design plan, the present disclosure empowers stakeholders involved in a process referencing the design plan to achieve a higher degree of accuracy, efficiency, and collaboration, ultimately leading to the realization of more sophisticated and well-coordinated projects.

Artificial Intelligence (AI) has permeated various sectors, automating, and enhancing tasks that require data analysis, pattern recognition, and decision-making. In the context of design and planning, AI can dramatically transform how annotations, modifications, and interactions with design plans are handled. An AI-powered platform can intelligently interpret and process spatial annotations, automate repetitive tasks, and provide predictive insights, thereby enhancing the design process's efficiency and accuracy.

In some embodiments, automated systems described by the present invention may maintain a dynamic user interface similar to an up-to-date digital twin of a portion of a building. The dynamic user interface may reflect thought processes, alterations in a physical environment, or suggestions for improvements, back to the dynamic user interface based upon the static design plan. Such synchronization may facilitate (by way of non-limiting examples) more accurate material lists, cost assessments, workforce allocation, and adherence to best practices, thereby optimizing the collaborative process in planning, executing, and managing architectural projects.

In general, the present invention provides for apparatus and methods related to receiving as input static representations (either physical or electronic, and either two-dimensional or three-dimensional) and generating one or more pixel patterns based upon automated processing of the static representations. The pixel patterns are analyzed using computerized processing techniques to mimic the perception, learning, problem-solving, and decision-making formerly performed by human workers (sometimes referred to herein as artificial intelligence or “AI”). The AI analysis process may be repeated for multiple static representations over time, each static representation including a change to the design of a building. The AI processes denote, and track changes made in the sequence of static representations of design documents.

Based upon AI analysis of pixel patterns derived from the two-dimensional references and knowledge accumulated from increasing volumes of analyzed two-dimensional references, interactive user interfaces may be generated that allow for a user to modify dynamic static representations of features gleaned from the two-dimensional reference. The interactive user interfaces may enable users to select specific portions or segments on the design plans, wherein the AI engine employs AI processing to determine the elements or components present within the chosen segment by analyzing the pixel patterns of the two-dimensional references. AI processing of the pixel patterns, based upon the two-dimensional references, may include mathematical analysis of polygons formed by joining select vectors included in the two-dimensional reference. The analysis of pixel patterns and manipulatable vector interfaces and/or polygon-based interfaces is advantageous over human processing in that AI analysis of pixel patterns, vectors and polygons is capable of leveraging knowledge gained from previous work, whether or not a human was involved, hence the importance of integrating our AI with existing databases.

In still another aspect, in some embodiments, enhanced interactive interfaces may include one or more of: user definable and/or editable lines; user definable and/or editable vectors; and user-definable and/or editable polygons. The interactive interface may also be referenced to generate diagrams based on the lines, vectors and polygons defined in the interactive interface. Still further, various embodiments include values for variables that are definable via the interactive interface with AI processing and human input.

According to the present invention, analysis of pixel patterns and enhanced vector diagrams and/or polygon-based diagrams may include one or more of: neural network analysis, opposing (or adversarial) neural networks analysis, machine learning, deep learning, artificial intelligence techniques (including strong AI and weak AI), forward propagation, reverse propagation and other method steps that mimic capabilities normally associated with the human mind, including learning from examples and experience, recognizing patterns and/or objects, understanding and responding to patterns in positions relative to other patterns, making decisions, solving problems. The analysis also combines these and other capabilities to perform functions the skilled labor force traditionally performed.

The methods and apparatus of the present invention are presented herein generally, by way of example, to actions, processes, and deliverables important to industries such as the construction industry, by providing users with the capability to intelligently annotate design plan elements (including annotating lines and polygons). Building upon its innovative capabilities, the present invention further enhances the design and planning process by offering automated suggestions for annotating design plan elements. Leveraging the power of artificial intelligence, the system intelligently generates recommendations for annotations, streamlining the initial stages of the annotation process. This proactive feature is designed to facilitate the rapid identification and marking of key design elements, facilitating comprehensive and meaningful annotations from the outset.

Moreover, the invention dynamically updates annotations in response to modifications within the design plan. This responsiveness is not merely reactive; it may be anticipatory, guided by the AI engine's analysis of existing annotation threads and historical data pertaining to similar design elements or modifications. Through this advanced analysis, the platform identifies patterns and commonalities in how certain design changes have been annotated in the past, applying this insight to suggest or automatically adjust annotations in the current context. By integrating past learnings and contextual understanding, the system facilitates that annotations are consistently aligned with best practices and the specific nuances of the project at hand. Consequently, this invention not only adapts to the evolving needs of the design plan but also evolves itself, learning from each interaction to provide more informed, precise, and helpful annotations (or annotation suggestions) over time.

In some specific examples, the present invention uses machine learning and/or artificial intelligence to identify architectural aspects and materials, such as walls, stairwells, floors, ceilings, doors, windows, and HVAC components, within the selected portion of the design plan. The present invention identifies such architectural aspects, and other building features, and provides dynamic association between design plan elements such as objects, polygons, or lines and their corresponding annotations. Such embodiment facilitates that when a user moves a design plan element within the digital workspace as part of design plan modification, any associated annotations are automatically moved in tandem with the element. This feature is powered by the underlying AI engine, which intelligently recognizes the linkage between the spatial characteristics of design elements and their annotated descriptions or markers.

Upon initiating a move action, as part of a change order request, for a given design element, the system calculates the new position of the element and simultaneously updates the positions of all related annotations. This process is seamless and requires no additional input from the user, thereby enhancing the efficiency of the design modification process. The system facilitates that annotations retain their spatial relevance to the design elements they describe, regardless of how these elements are repositioned within the design plan. By automating the concurrent movement of annotations with their respective design elements, the invention significantly reduces the risk of errors and streamlines the workflow. Furthermore, the intelligent handling of this feature extends to the recognition of complex movements and transformations of design elements, such as rotations, scaling, or mirroring. The AI engine adeptly adjusts the annotations to maintain their correct orientation and relationship to the elements, providing a robust solution that supports a wide range of design activities.

Further, the system may be equipped to generate automated annotations in response to changes within the design plan or specific design plan elements, thereby offering a proactive approach to documenting and communicating these modifications. This functionality may particularly be valuable for tracking alterations over the course of a project's development, so that all stakeholders are promptly informed of updates. Additionally, in instances where changes occur to elements that previously lacked annotations, the system leverages its AI engine to intelligently create appropriate annotations for these newly modified elements. These automated annotations are generated based on a sophisticated analysis conducted by the AI engine, which considers the nature of the change, the context within the overall design plan, and historical data on similar modifications. This capability facilitates that every change, regardless of its prior annotation status, is accurately documented and communicated, enhancing the collaborative and iterative nature of the design process.

In some preferred embodiments, the AI Engine is seamlessly integrated with databases housing a repository of past similar projects. These databases serve as invaluable resources, facilitating the AI engine's learning process by drawing insights from diverse user decisions made in comparable prior works. This integration empowers the AI Engine with a wealth of accumulated knowledge, enhancing its ability to offer informed and contextually relevant recommendations.

Furthermore, according to some embodiments of the present invention, the system can be integrated with advertisement platforms that deliver advertisements to users on the interactive user interfaces. The advertisement may comprise but is not limited to: components from particular brands that align with both the required quality standards and the user's budget, alternative components from diverse brands, comprehensive lists of materials complete with pricing and purchase options and even contact information or details of contractors and architects available for hire, specializing in the realization of the actual building based on the design plan.

A two-dimensional reference, such as a design floorplan is input into an AI engine and the AI engine converts aspects of the floorplan into components that may be processed by the AI engine, such as, for example, a rasterized version of the floorplan. The floorplan is then processed with machine learning to specify portions that may be specified as discernable components. Discernable components may include, for example, rooms, residential units, hallways, stairs, dead ends, windows, or other discrete aspects of a building.

A scaling process is applied to the floorplan and size descriptors are assigned to the discernable components. In addition, distances, such as, for example, a distance to an exit from the furthest point in a residential unit are calculated.

In general, the present invention provides for apparatus and methods related to receiving as input design plans (either physical or electronic) and generating one or more pixel patterns based upon automated processing of the design plans. The pixel patterns are analyzed using computerized processing techniques to mimic the perception, learning, problem-solving, and decision-making formerly performed by human workers (such computerized processing techniques are sometimes referred to herein as artificial intelligence or “AI” processing or analysis).

Based upon AI analysis of pixel patterns derived from the two-dimensional references and knowledge accumulated from increasing volumes of analyzed two-dimensional references, interactive user interfaces may be generated that allow for a user to modify dynamic design plans of features gleaned from the two-dimensional reference. AI processing of the pixel patterns, based upon the two-dimensional references, may include mathematical analysis of polygons formed by joining select vectors included in the two-dimensional references.

In specific embodiments of the invention, the process of selecting a segment or design element for change order may involve one or both of the following actions: marking around or on the desired segment or design element directly within the user interface or utilizing a polygon shape tool accessible on the interface, enabling users to drag and position the shape onto the desired segment. Moreover, the selection of a segment can be initiated either manually by a user or automatically by the AI engine. Additionally, when employing the polygon shape tool, users may choose from a range of polygon shapes provided by the AI engine within the user interface for selection and placement.

In specific embodiments of the invention, the AI engine analyzes the selected segment or design element based on pixel-level analysis of the selected segment or design element area within the design plan covered by the user-provided marking or the selected polygon shape. The pixel-level analysis may comprise considering the pixels of the static representation for analysis if the pixels are at and/or around a tolerable distance from the marking or boundaries of the polygon shape. The pixel-level analysis may comprise analyzing the polygon pixel patterns of the segment covered by the selected polygon shape. The pixel-level analysis may further comprise considering the pixels of the static representation for analysis if the pixels are at a predefined distance from each other creating a particular spatial relationship. The spatial relationship may be defined by a user or automatically learned by the AI engine.

In some embodiments of the present invention, the system may include management and interaction of annotations within the design plan to facilitate the integrity and utility of collaborative feedback. In such a system, annotations made by any user cannot be directly deleted or significantly altered by others without the original annotator's consent. Should any user attempt to modify or delete an annotation, the system, powered by the AI Engine, automatically triggers a notification process. This notification is sent to the original user who added the annotation, providing them with the option to approve or disapprove the proposed change or deletion. This mechanism facilitates that each annotation's original intent and value are preserved until the contributor validates the necessity for alteration, thereby maintaining a coherent and collaborative annotation history.

Further enhancing user interaction with annotations, such embodiments may also incorporate features such as the ability for users to ‘like’ annotations made by others. These interactions serve a dual purpose: firstly, as a means of acknowledging the usefulness or relevance of specific annotations within the collaborative environment, and secondly, as a valuable dataset for the AI Engine. The AI Engine utilizes these interactions to learn about the relevance and utility of annotations in relation to the associated design elements. By analyzing patterns in which annotations receive positive engagement, the AI Engine can refine its understanding of what constitutes valuable and pertinent annotations within various contexts of the design plan.

Moreover, such embodiments may leverage additional innovative methods for the AI Engine to learn from annotations. For example, the system may analyze the frequency and context of annotations that consistently lead to design modifications, thereby identifying trends in important feedback that directly influence design outcomes. Another method involves the AI Engine examining the correlation between the spatial positioning of annotations and changes in design elements, enabling the system to predict areas within a design plan that may require more detailed scrutiny or are prone to revisions.

These unique learning mechanisms empower the AI Engine to not only facilitate a more dynamic and interactive annotation environment but also continuously improve the platform's capability to support effective design collaboration. By integrating these features, the invention fosters a rich, interactive, and intelligent design process, where annotations become a central component of learning, decision-making, and innovation in the collaborative development of design plans.

In some embodiments, the two-dimensional reference input may be file extensions that include but are not limited to: DWG, DXF, PDF, TIFF, PNG, JPEG, GIF, or other types of files based upon a set of engineering drawings. Some two-dimensional reference references may already be in a pixel format, such as, by way of a non-limiting example, a two-dimensional reference in a JPEG, GIF or PNG file format. The engineering drawings may be hand drawings, or they may be computer-generated drawings, such as may be created as the output of CAD files associated with software programs such as AutoDesk™, Microstation™, etc. As some architects, design firms and others who generate engineering designs for buildings may be reluctant to share raw CAD files with others, the present invention provides a solution that does not require raw CAD files.

In other examples, such as for older structures, a drawing or other 2D representation may be stored in paper format or digital version or may not exist or may never have existed. The input may also be in any raster graphics image or vector image format.

The input process may occur with a user creating, scanning into, or accessing such a file containing a raster graphics image or a vector graphics image. The user may access the file on a desktop or standalone computing device or In some embodiments, via an application running on a smart device. In some embodiments, a user may operate a scanner or a smart device with a camera to create the file containing the image on the smart device.

### BRIEF DESCRIPTION OF THE DRAWINGS

The accompanying drawings, which are incorporated into and constitute a part of this specification, illustrate several embodiments of the present invention. Together with the description, these drawings serve to illustrate some aspects of the present invention.

FIG. 1A illustrates method steps that may be implemented in some embodiments of the present invention.

FIG. 1B illustrates a high-level diagram of components included in a system that uses AI to generate an interactive user interface.

FIG. 1C illustrates an exemplary method for annotating a design element on the design plan in the collaborative environment of the present invention.

FIG. 1D illustrates an exemplary interface for providing automated annotation suggestions to users during annotation process.

FIG. 1E illustrates an exemplary settings window with various setting options as per some embodiments of the present invention.

FIG. 1F illustrates an exemplary method for relocating a design element from one position to another on a design plan to register a change order in some embodiments of the present invention.

FIG. 1G illustrates an exemplary system for handling, analyzing, and processing change orders in a design plan in accordance with the present invention.

FIG. 1H illustrates an exemplary system for processing factors influencing change orders and generating outputs in accordance with the present invention.

FIG. 1I illustrates an exemplary process for processing change order inputs using a controller, which provides updated design plans along with calculated constraints in some embodiments of the present invention.

FIG. 1J illustrates registering change orders on a design plan, where the controller processes the changes and provides a table of requirements for implementing them in accordance with the present invention.

FIG. 1K illustrates registering a change order, updating the design plan with the change, and generating associated requirements, including materials, cost, timeline, and labor, in accordance with the present invention.

FIGS. 2A, 2B, 2C and 2D illustrate a static representation of a floor plan and an AI analysis of the same to assess boundaries and design elements.

FIG. 2E illustrates marking a change order on a design plan and comparing initial and updated construction constraints, including labor, materials, regulatory updates, site conditions, and costs.

FIG. 2F illustrates a user interface allowing a user to access each updated constraint in detail in accordance with the present invention.

FIGS. 3A-3D show various views of the AI-analyzed boundaries and design elements overlaid on the original floorplan including a table illustrated to contain hierarchical dominance relationships between area types.

FIGS. 4A-4B illustrate various aspects of dominance-based area allocation.

FIGS. 5A-5D illustrate various aspects of region identification and area allocation.

FIGS. 6A-6C illustrate various aspects of boundary segmentation and classification.

FIG. 7 illustrates aspects of correction protocols and an exemplary method for making changes to a design element of the design plan.

FIG. 8 illustrates exemplary processor architecture for use with the present disclosure.

FIG. 9 illustrates exemplary mobile device architecture for use with the present disclosure.

FIGS. 10A-10B illustrate exemplary method steps that may be executed in some embodiments of the present invention.

FIG. 11 illustrates additional method steps that may be executed in some embodiments of the present invention.

FIG. 12 illustrates exemplary design plans of different buildings in a collaborative system where change orders requested by one owner may affect the design plans of other owners in accordance with the present invention.

FIG. 13 illustrates an exemplary design plan of a single building where different owners of various portions of the building may request change orders in collaboration, in accordance with the present invention.

FIGS. 14A, 14B, and 14C illustrate an exemplary process of how different owners collaborate on change orders, including initiating, approving, and generating updated plans with materials, labor, and cost details through a centralized system.

FIG. 15 illustrates an exemplary flowchart for creating, approving, and executing change orders, including real-time data updates, constraint analysis, and layout or plan updates.

FIGS. 16A-16B illustrate an exemplary user interface allowing a user to set fixed constraints, processed by the controller to generate automated suggestions for completing change orders based on the defined constraints, in accordance with the present invention.

FIGS. 17A-17B illustrates an exemplary flowchart of method steps that may be executed in some embodiments of the present invention.

### DETAILED DESCRIPTION

The present invention provides systems, methods and apparatus for managing change orders in a design plan of a building, implemented through a system comprising a controller with an AI engine and a GAN engine. The method begins with the controller receiving an initial design plan representing at least a portion of the building. The design plan may include technical layouts such as architectural blueprints, structural designs, or functional plans for at least some specific areas of the building. These plans may be submitted in various formats, including CAD files, PDF documents, or raster images.

Once the initial design plan is received, the controller processes the input and generates an interactive user interface. The interactive user interface allows users to view, select, and interact with the design elements of the initial design plan in a dynamic and intuitive manner. For example, a user such as an architect or contractor may interact with specific design elements, such as walls, windows, or fixtures, and view their associated dimensions, material details, and positioning. The user interface may provide a visual representation of the design plan with options for zooming, annotating, and selecting specific components for modification.

Using the interactive user interface, the user can initiate a change order input or request by selecting a specific spot on the initial design plan. For example, the user may click on a room boundary and specify a modification, such as extending the room by two meters, relocating a window, or adding a structural feature like a beam or column. The change order input can also include a detailed description, supporting documents, and user-defined constraints such as a fixed budget, timeline, labor, or preferred materials. For example, a user may input a change order requesting the installation of energy-efficient windows within a specified budget and timeline.

The controller then analyzes the change order input to determine its feasibility and impact on the initial design plan and associated sub-plans. This analysis includes evaluating associated initial constraints, such as initial budget, labor, timeline, materials, regulatory requirements, structural integrity, and interdependencies with other design elements. For example, if a user requests a change order to upgrade flooring from standard vinyl to high-grade hardwood, the controller analyzes the impact on the initial design plan and associated constraints. It identifies a budget discrepancy, noting the upgrade increases flooring costs from $2,000 to $5,000, and calculates additional labor costs of $500 due to the specialized installation required. In another example, if the change order involves adding a balcony, the controller may assess whether the load-bearing capacity of the supporting walls is sufficient. The controller also considers compliance with design considerations such as building codes, minimum clearance requirements, and aesthetic guidelines.

To enhance the decision-making process, the controller may simulate the implementation of the change order within the design plan. This simulation allows the system to identify potential conflicts, such as overlapping structural components, insufficient space for plumbing or electrical systems, or non-compliance with fire safety regulations. For example, if the change order involves extending a room, the simulation may reveal that it encroaches on a staircase, prompting the user to adjust the modification.

Based on the analysis, the controller generates a set of updated constraints, including recalculated values for time, cost, labor, and materials required to implement the change order. These updated constraints may be presented on the interactive user interface alongside the original constraints, enabling the user to compare the impact of the change order. For example, if the original design plan allocated $10,000 for windows, and the change order introduces energy-efficient options, the updated constraints may reflect an increased cost of $12,000 while highlighting potential long-term energy savings.

The system may further provide automated suggestions to facilitate the implementation of the change order. These suggestions may include alternative materials, labor allocation strategies, and timeline adjustments. For example, if the user specifies a limited budget, the controller may suggest cost-effective material alternatives, such as prefabricated components, while maintaining the quality and compliance of the design. Similarly, if the timeline is a priority, the controller may recommend expedited construction methods or additional labor resources.

In cases where the change order affects other stakeholders, such as other building owners, contractors, or regulatory authorities, the controller identifies these affected parties and transmits a notification seeking their approval or input for implementing the change order. For example, if the change order involves relocating a shared wall in a multi-unit building, the controller may notify adjacent unit owners and seek their consent. The affected stakeholders can respond through their respective user interfaces, providing approvals, rejections, or conditions for modification. For example, a contractor may approve the change order but request an additional two weeks for implementation due to resource constraints.

Once all approvals are received, the controller updates the design plan and associated sub-plans, such as electrical layouts, plumbing schematics, HVAC configurations, and structural reinforcements. For example, if the change order involves adding a balcony, the controller may generate updated electrical plans showing additional outdoor lighting and plumbing plans for a drainage system. These updates are presented to the user through the interactive user interface for review and final confirmation.

The interactive user interface may further integrate external data sources, such as supplier inventories, weather conditions, and building regulations, to provide real-time insights. For example, the controller may access supplier databases to recommend materials available for immediate delivery, complete with pricing and logistical details. Users can procure these materials directly through the interactive user interface, streamlining the procurement process and facilitating timely implementation of the change order.

Additionally, the system offers features for optimizing construction constraints, such as reallocating surplus budget or utilizing leftover materials. For example, if the change order results in cost savings, the controller may suggest reallocating the saved funds to enhance other aspects of the building, such as upgrading flooring or adding energy-efficient appliances. Similarly, if surplus materials are identified, the controller may recommend repurposing them for other construction tasks, minimizing waste and reducing costs.

The method also supports real-time collaboration between multiple users, allowing them to discuss, request, and approve change orders through shared annotations, notifications, and interactive tools. This feature enhances coordination among stakeholders, so that all parties are aligned on the modifications and their implications.

Finally, the controller may generate a comprehensive report summarizing the change order, including affected components, updated constraints, and projected timelines. This report can be accessed by all relevant stakeholders, providing transparency and accountability throughout the process. By integrating advanced AI and GAN technologies, the invention streamlines the management of change orders, enhances collaboration, and optimizes resource utilization in building design and construction.

In some embodiments, the present invention provides systems, methods and apparatus for an interactive platform that significantly enhances collaborative processes associated with a dynamic user interface based upon a static design plan reference. Within this interactive platform, users can seamlessly select a spatial designation, (such as, for example, a spatial designation associated with a design element) for annotation within an interactive user interface based upon a static design plan document descriptive of at least a portion of a building or construction site.

An AI engine leverages one or more of machine learning, user input, reference documents, applicable standards, applicable codes, external references, databases, digital content accessible via a communications platform (e.g. the Internet), historical data, and current context to suggest automated annotations, optimizing an annotation process by providing users with intelligent, contextually relevant suggestions that align with a project's specifications and goals.

Coordinates may be associated with corresponding annotations, facilitating that a piece of information is accurately linked to a physical counterpart in a relevant building. This integration of detailed spatial awareness with the platform's annotation capabilities facilitates a dynamic, real-time connection between the digital design plan and the actual physical structure, enhancing the accuracy, efficiency, and effectiveness of the collaborative design and construction process.

In some embodiments of the present invention, the platform incorporates social interaction features that enable users to engage with the annotations made by other users through mechanisms such as commenting, liking, disliking, and/or insertion of a symbol (e.g., emoji, signature, authorization, or other recognizable digital representation).

The present invention provides interaction enabling a dialogue between users, and/or an AI Engine, about design elements and annotations. In another aspect, it also contributes to a feedback system where the AI engine can observe and learn from user interactions. As users comment on or react to annotations, the AI engine may analyze responses, utilizing them for machine learning to refine a quality and relevance of future automated annotation suggestions. Moreover, the systems according to the present invention may also allow for an approval workflow, wherein annotations can be approved or disapproved by authorized users or automatically by the AI engine depending upon positive or negative reactions to the annotations.

Machine monitoring of spatially relevant annotations facilitates machine and user input capability that becomes more accurate over time and adheres to a collective knowledge and preferences of a team, thereby enhancing collaborative processes.

In some embodiments, the invention enables remote collaboration between multiple users, allowing each user to interact with the design plan and contribute through annotations. These annotations may include textual comments, graphical symbols, multimedia files, or detailed notes relating to specific design elements, such as rooms, windows, doors, or structural components. For example, one user may provide feedback on the layout of a room by attaching a multimedia file or adding a graphical symbol to highlight required changes, while another user may leave a textual note suggesting modifications to window placements for better natural lighting.

The system's controller is designed to receive these annotations and automatically evaluate their impact on the overall design plan. Before incorporating any changes, the controller may consider factors such as spatial configurations, compliance with design considerations, and any user-defined design preferences. Once the evaluation is complete, the controller can generate an updated design plan that integrates the annotations from multiple users, providing a streamlined, collaborative process where input from all stakeholders is considered and effectively incorporated into the final design.

In some embodiments of the present invention, an AI engine may leverage sophisticated analysis of annotations associated with a design plan to intelligently determine an order of actions associated with a particular design plan, such as, by way of a non-limiting example, an order of installation, service, modification, or other action included in a construction or renovation process associated with a design plan. By evaluating factors such as availability of resources, supply chain, urgency, best practices requirements, project timelines, and skilled labor availability, an AI engine may be used to prioritize tasks in a manner that optimizes workflow efficiency and facilitates that important project milestones are met.

By way of non-limiting illustrative example, if an annotation on a structural aspect (e.g., a support beam) indicates an issue with a safety standard (or other best practice), the AI engine assigns a higher severity level to a task directed to ascertaining prioritization over less important modifications. Similarly, if an electrical installation is annotated as a prerequisite for subsequent tasks within the project, the AI engine schedules this installation early in the action order. Dynamic prioritization may enable project progression in a logical and efficient manner, minimizing delays and optimizing resource allocation.

Embodiments of the present invention provide significant advancements in project definition and project management technology, as it not only automates task scheduling processes, but also adapts in real-time to changes associated with a design plan and spatially relevant annotations. By doing so, it supports a more agile and responsive project execution strategy, directly contributing to the success and quality of architectural, engineering, and construction projects.

In some embodiments of the invention, systems focus on enhancing an annotation process by providing automated suggestions. An AI engine analyzes an annotation database comprising historical textual and multimedia annotations. By recognizing patterns and contexts in which annotations were previously used, the system suggests relevant annotations to users as they interact with specific design elements in the digital design plan. Such predictive assistance may streamline an annotation process, promote consistency across projects, and help users to quickly identify and apply best practices and solutions previously successful in similar scenarios.

In a further embodiment of the invention, a sophisticated dynamic cost estimation functionality is embedded within the system, enabling the real-time assessment of the financial implications stemming from alterations made to the digital design plan. When users initiate changes to design elements or make new annotations, the AI engine evaluates these modifications. It does this by calculating the expected changes in material requirements, updating labor requirements based on the scope and scale of the adjustments, and revising cost estimations to reflect these new calculations accurately.

This embodiment is particularly innovative in how it leverages connectivity with third-party vendor platforms. Through seamless integration, the platform facilitates immediate access to a wide range of quotes for required materials, enables the efficient hiring of labor tailored to the project's revised requirements, and even supports the direct procurement of services and goods. Users benefit from a streamlined interface where design modifications, cost implications, and procurement actions converge in a cohesive workflow.

In some embodiments of the invention, a focus may be placed upon enforcement of best practices, standards, and enumerated requirements within one or more of: design planning activities; design review; construction activities; cost estimation; supply chain activities; contractor (and/or subcontractor) engagements, by leveraging the sophisticated capabilities of the AI engine. An AI system may receive as input one or more annotations and design elements represented as polygons and/or lines, presented within an interactive user interface. In some embodiments, a data source of relevant input or criteria relevant to architecture, engineering, and construction standards may be made available to one or both of a user and an AI Engine to provide input relevant to a spatial designation of a design plan. Input of relevant annotation content and data source content enables an AI Engine to provide notification of one or more of: identification of discrepancies, potential action adverse to a preferred practice, or area of non-compliance with a preferred practice or standard that may exist within a design plan.

In some embodiments, an AI engine may actively engage users by flagging AI noted concerns directly within the user interface. Further, in some embodiments, an automated process may highlight specific elements and/or features included in a design plan and describe a potential concern. For example, actionable modifications or alternative solutions that may place a design into a more desired state may be included in AI and/or user generated spatially relevant annotations. Users may receive tailored alerts and guidance, effectively offering a consultative approach to rectify compliance issues.

In some embodiments, an AI assisted system may preemptively address potential issues of adherence with a desired practice, or design relevant documents, and/or other criteria, thereby significantly reducing the likelihood of encountering costly modifications during or after the construction phase.

Moreover, some embodiments may serve to streamline interactions with review bodies and approval processes. By providing a platform that inherently aligns with regulatory expectations, the system facilitates a smoother, more efficient pathway from project conception through to completion. The preemptive adherence to a preferred design criteria may accelerate an acceptance process, minimizing delays and fostering a more productive relationship between project stakeholders and/or other parties of interest.

In some other embodiments of the present invention, an AI engine is equipped to simulate “What If” scenarios, providing a dynamic tool for planning and decision-making within the architectural and construction domains. This feature enables users to explore various hypothetical modifications to the design plan, design elements, and annotations and assess their potential impacts without committing to actual changes. By inputting different “What If” conditions, such as altering the materials of a design element, repositioning structural components, or changing the dimensions of space, the AI engine projects the consequent effects on the design's overall integrity, cost implications, compliance with best practices, and even the projected timeline for completion.

For example, a user considering the replacement of a building material with a more sustainable alternative can engage the “What If” simulation to understand how this choice may affect insulation properties, overall building sustainability ratings, and cost. The AI engine analyzes the proposed change, leveraging historical data, current standards, and predictive algorithms to furnish detailed insights, including potential energy savings, adjustments in material costs, and any required alterations to construction techniques.

The functionalities and process steps (which may also be referred to as method steps) described herein may be embodied as executable digital software code. The software code may be embodied in ‘modules’ that are executable to accomplish defined objectives. In the context of software and a controller, “modules” refer to distinct, self-contained units of software that perform specific functions within a larger system. These modules are designed to interact with each other and the controller to achieve the overall objectives of the system. Each module typically encapsulates a particular functionality, allowing for modular design, which enhances the system's flexibility, maintainability, and scalability.

As used herein, by way of non-limiting example, modules can be used with software and a controller in one or more of the following ways:

Functional Segmentation: Modules allow the system to be divided into smaller, manageable parts, each responsible for a specific task. For example, in a building design management system, there might be modules for change order processing, spatial analysis, and user interface management.

Interoperability: Modules are designed to communicate with the controller and other modules through well-defined interfaces or APIs. This interoperability facilitates seamless data exchange and coordination among different parts of the system.

Reusability: Modules can be reused across different projects or systems, reducing development time and effort. For instance, a module designed for regulatory compliance checks can be integrated into various design management systems.

Scalability: As the system's requirements grow, additional modules can be developed and integrated without disrupting existing functionalities. This modular approach supports the system's scalability.

Maintainability: By isolating specific functionalities within modules, updates or bug fixes can be applied to individual modules without affecting the entire system. This isolation simplifies maintenance and reduces the risk of introducing new errors.

Customization: Modules can be customized or replaced to meet specific user requirements or to incorporate new technologies, allowing the system to adapt to changing requirements.

Security: Modules can be designed with specific security features, ensuring that sensitive data is protected and that only authorized interactions occur between modules and the controller.

In some embodiments therefore, modules may serve as building blocks of a system including a controller with a processor and a storage and executable software to provide a cohesive and efficient solution. Modules may enable a structured approach to software development, where each module contributes to the system's overall functionality while maintaining independence and flexibility.

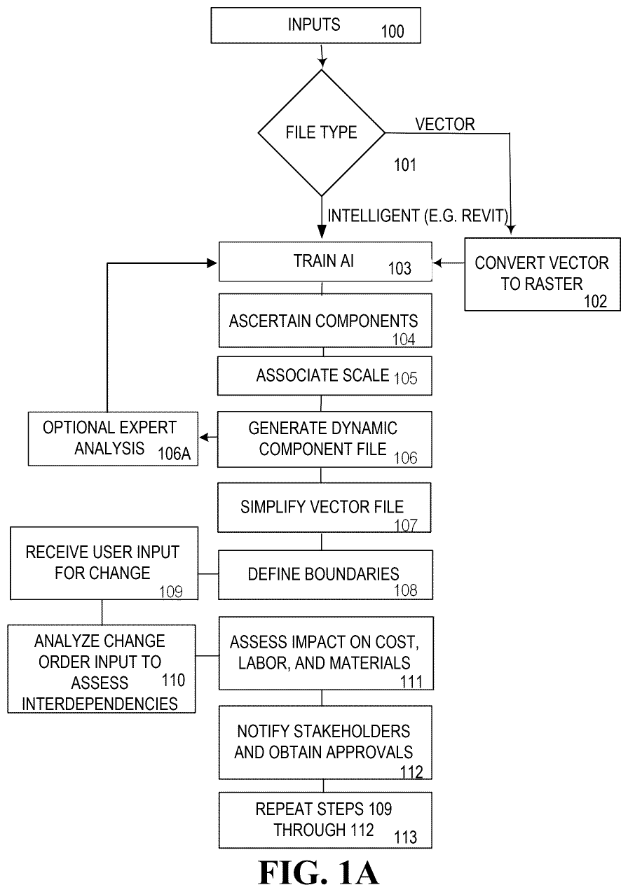

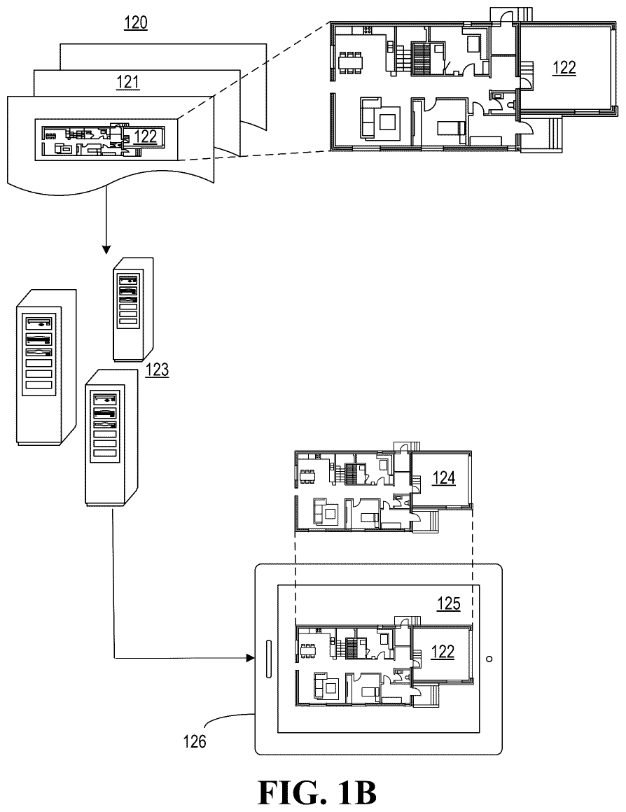

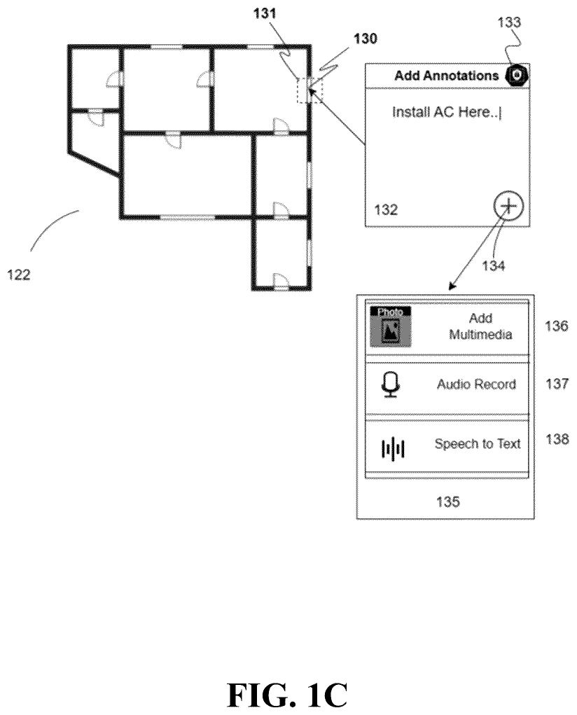

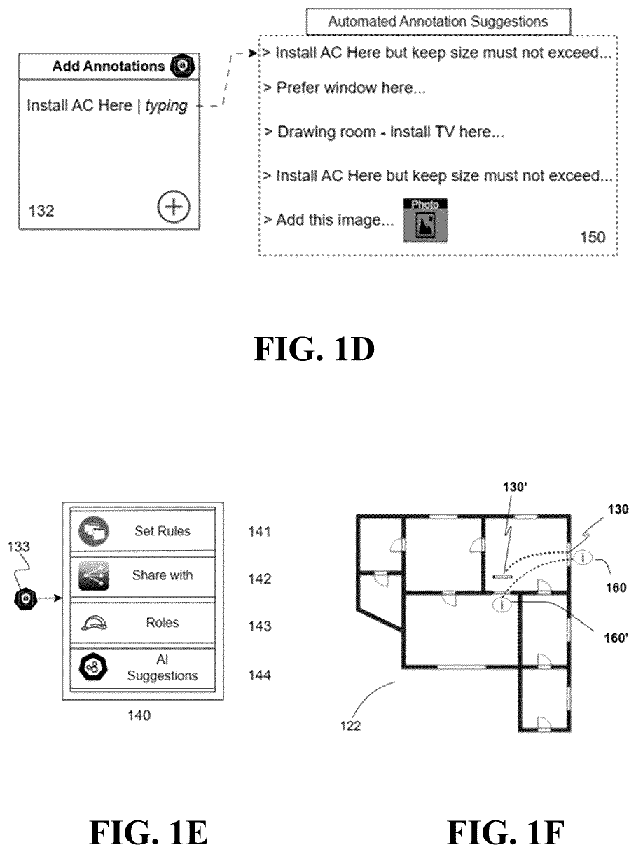

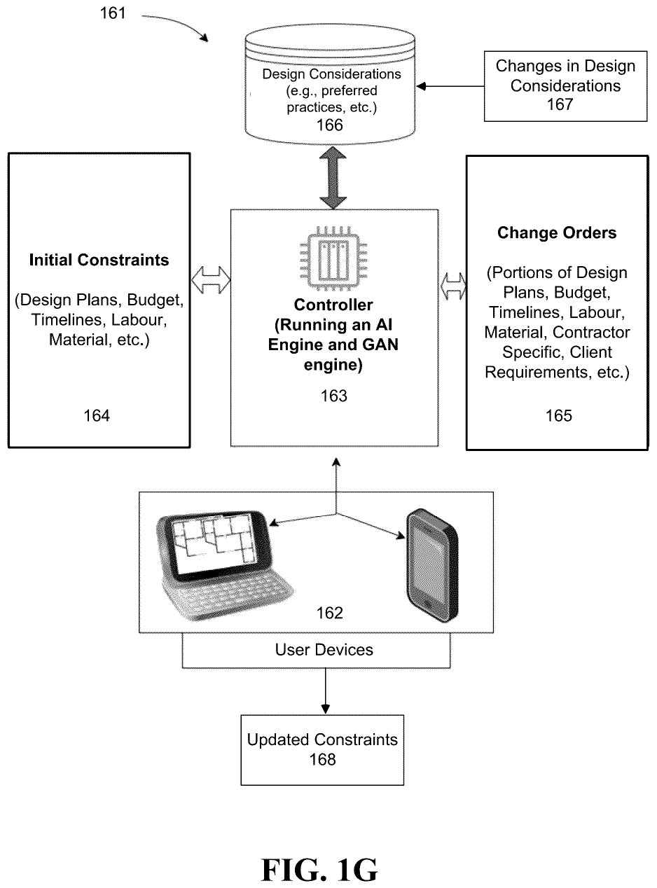

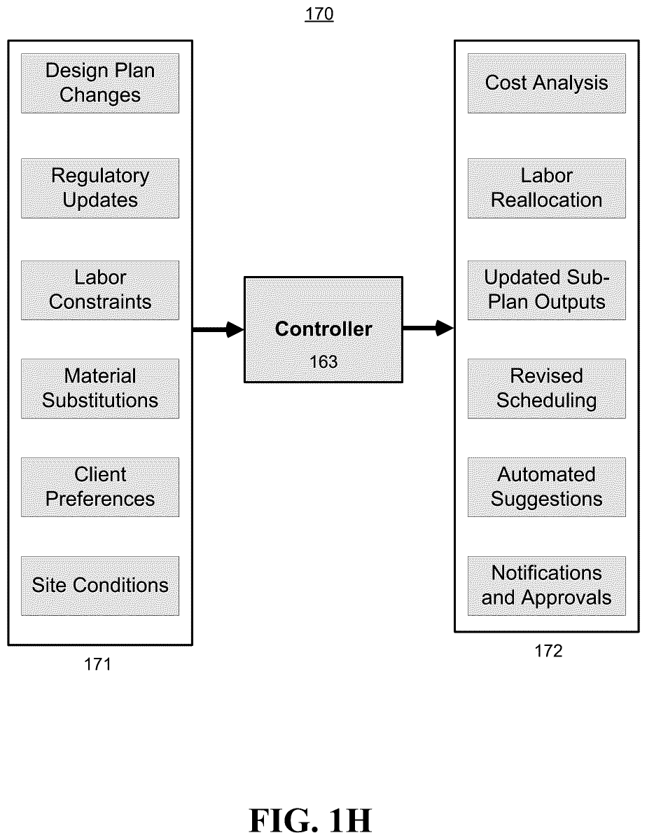

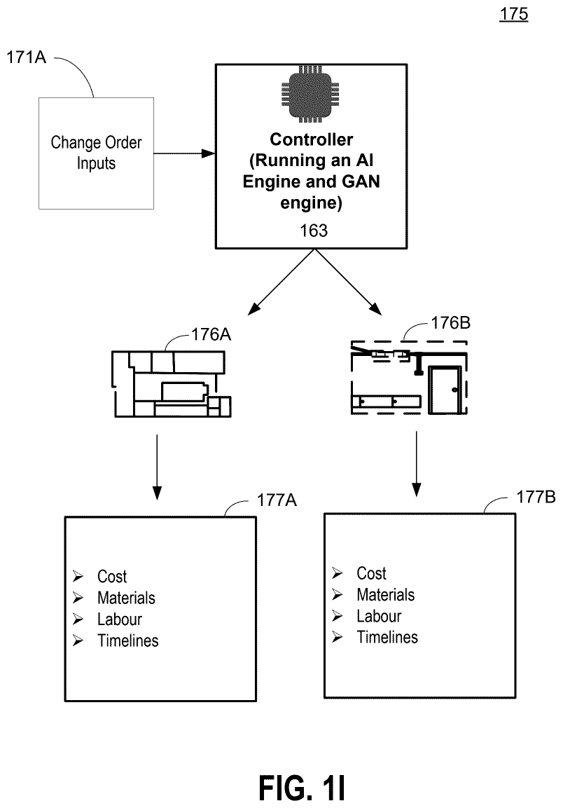

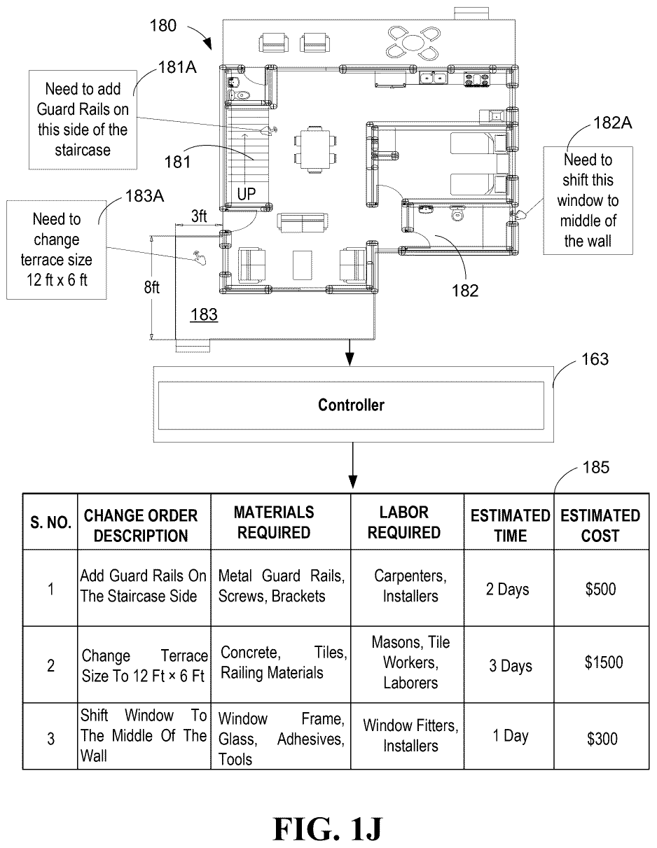

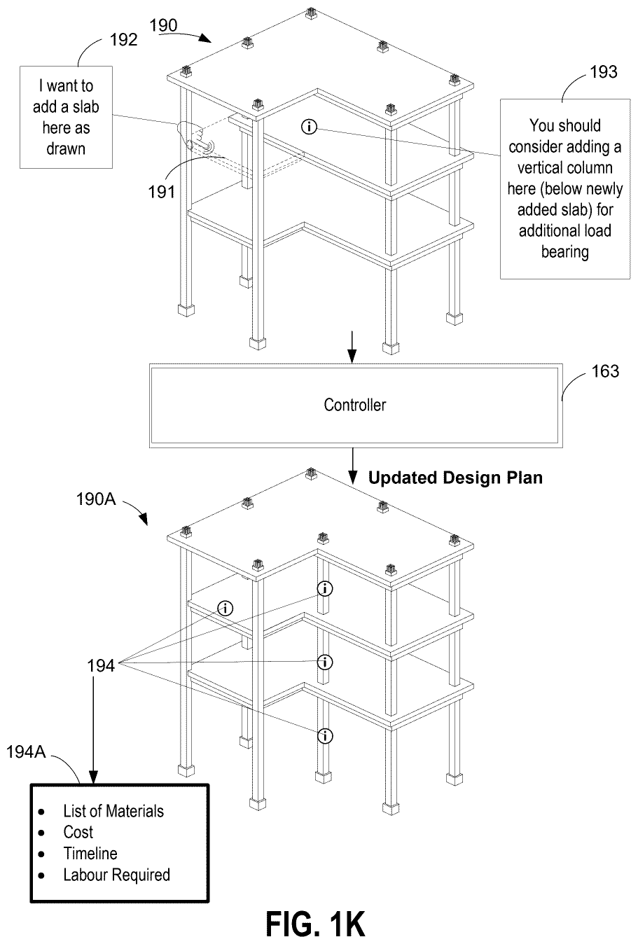

Referring to FIG. 1A, a general flow diagram showing some preferred embodiments of the present invention is illustrated. At step 100, a design plan (which may be a design plan or dynamic architectural design file e.g., a Revit® compatible file) indicating aspects of a building; is input into a controller or other data processing system using a computing device. The design plan may include an item of a known size, such as, by way of a non-limiting example, a scale bar that allows a user to ascertain a scale of the drawing (e.g., 1″=100′ etc.) or an architectural aspect of a known dimension, such as a wall or doorway of a known length (e.g., a doorway known to be three feet wide).

Input of a two-dimensional reference (i.e., design plan) into the controller may occur, for example, via known ways of rendering an image as a vector diagram, such as via a scan of paper-based initial drawings; upload of a vector image file (e.g., encapsulated postscript file (epf file); adobe illustrator file (ai file); or portable document file (pdf file). In other examples, a starting point for estimation may be drawing file in an electronic file containing a model output for an architectural floor plan. In still further examples, other types of images stored in electronic files such as those generated by cameras may be used as inputs for automated processes.

In some embodiments, the design plan may be file extensions that include but are not limited to: DWG, DXF, PDF, TIFF, PNG, JPEG, GIF, or other types of files based upon a set of engineering drawings. Some design plans may already be in a pixel format, such as, by way of a non-limiting example, a two-dimensional reference in a JPEG, GIF or PNG file format. The engineering drawings may be hand drawings, or they may be computer-generated drawings, such as may be created as the output of CAD files associated with software programs such as AutoDesk™, Microstation™, etc. In other examples, such as for older structures, a drawing or other design plan may be stored in paper format or digital version or may not exist or may never have existed. The input may also be in any raster graphics image or vector image format.

The input process may occur with a user creating, scanning into, or accessing such a file containing a raster graphics image or a vector graphics image. The user may access the file on a desktop or standalone computing device or, in some embodiments, via an application running on a smart device. In some embodiments, a user may operate a scanner or a smart device with a charged coupled device to create the file containing the image on the smart device.

In some embodiments, a degree of the processing as described herein may be performed on a controller, which may include a cloud server, a standalone computing device or a smart device. In many examples, the input file may be communicated by the smart device to a controller embodied in a remote server. In some embodiments, the remote server, which is preferably a cloud server, may have significant computing resources that may be applied to AI algorithmic calculations analyzing the image.

In some embodiments, dedicated integrated circuits tailored for deep learning AI calculations (AI Chips) may be utilized within a controller or in concert with a controller. Dedicated AI chips may be located on a controller, such as a server that supports a cloud service or a local setting directly.

In some embodiments, an AI chip tailored to a particular artificial intelligence calculation may be configured into a case that may be connected to a smart device in a wired or wireless manner and may perform a deep learning AI calculation. Such AI chips may be configurable to match a number of hidden levels to be connected, the manner of connection, and physical parameters that correspond to the weighting factors of the connection in the AI engine (sometimes referred to herein as an AI model). In other examples, software-only embodiments of the AI engine may be run on one or more of: local computers, cloud servers, or on smart device processing environments.

At step 101, a controller may determine if a design plan received into the controller includes a vector diagram. If a file type of the received design plan, such as an input architectural floor plan technical drawing, includes at least a portion that is not already in raster graphics image format (for example, that it is in vector format), then the input architectural floor plan technical drawing may be transformed to a pixel or raster graphics image format in step 102. Vector-to-image transforming software may be executed by the controller, or via a specialized processor and associated software.

In some embodiments, the controller may determine the pixel count of a resulting rasterized file. The rasterized file will be rendered suitable for the controller hosting an artificial intelligence engine (“AI engine”) to process, the AI engine may function best with a particular image size or range of image size and may include steps to scale input images to a pixel count range in order to achieve a desired result. Pixel counts may also be assigned to a file to establish the scale of a drawing-for example, 100 pixels equals 10 feet. As an illustrative example, images can be resized to dimensions such as 1024×1024, 512×512, or other dimensions that may be appropriate for the AI engine to function in a better way.

In various examples, the controller may be operative to scale up small images with interleaved average values with superimposed Gaussian noise as an example, or the controller may be operative to scale down large images with pixel removal. A desired result may be detectable by one or both the controller and a user. For example, a desired result may be a most efficient analysis, a highest quality analysis, a fastest analysis, a version suitable for transmission over an available bandwidth for processing, or other metric.

At step 103, training (and/or retraining) of the AI engine is performed. Training may include, for example, manual identification of patterns in a rasterized version of an image included in a design plan that corresponds with architectural aspects, walls, fixtures, piping, duct work, wiring or other features that may be present in the two-dimensional reference. The training may also include one or more of: identification of relative positions and/or frequencies and sizes of identified patterns in a rasterized version of the image included in the design plan.

In some embodiments, and in a non-limiting sense, an AI engine used to analyze the design plan may be based on a deep learning artificial neural network framework. The AI engine image processing may extract different aspects of an image included in the design plan that is under analysis. At a high level, the processing may perform segmentation to define boundaries between important features. In engineering drawings defined boundaries may be based on the presence of architectural features, such as walls, doorways, windows, stairs, and the like.

In some embodiments, a structure of the artificial neural network may include multiple layers, such as input layers and hidden layers with designed interconnections with weighting factors. For learning optimization, the input architectural floor plan technical drawings may be used for artificial intelligence (AI) training to enhance the AI's ability to detect what is inside a boundary. A boundary is an area on a digital image that is defined by a user and tells the software what needs to be analyzed by the AI. Boundaries may also be automatically defined by a controller executing software during certain process steps, such as a user query. A boundary within the context of a design plan may signify the presence of a wall. Using deep artificial neural networks, original architectural floor plans (along with any labeled boundaries) may be used to train AI models to make predictions about what is inside a boundary. In exemplary embodiments, the AI model may be given over ~50,000 similar architectural floor plans to improve boundary-prediction capabilities.

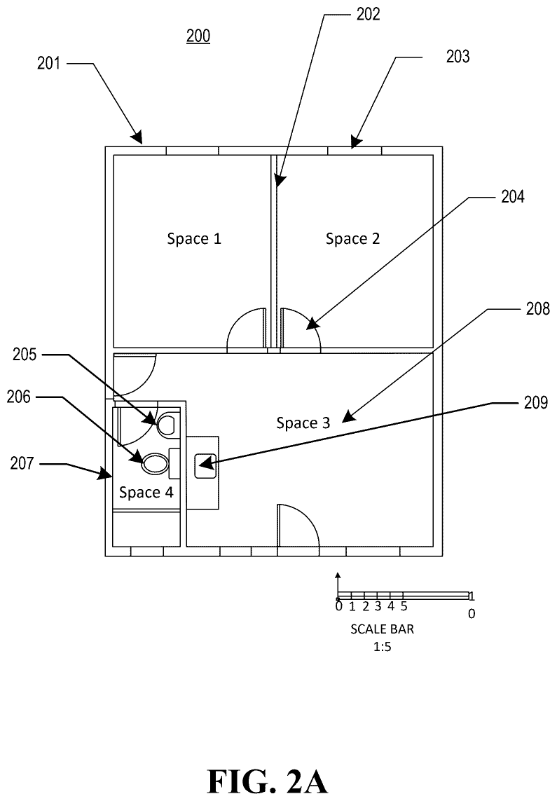

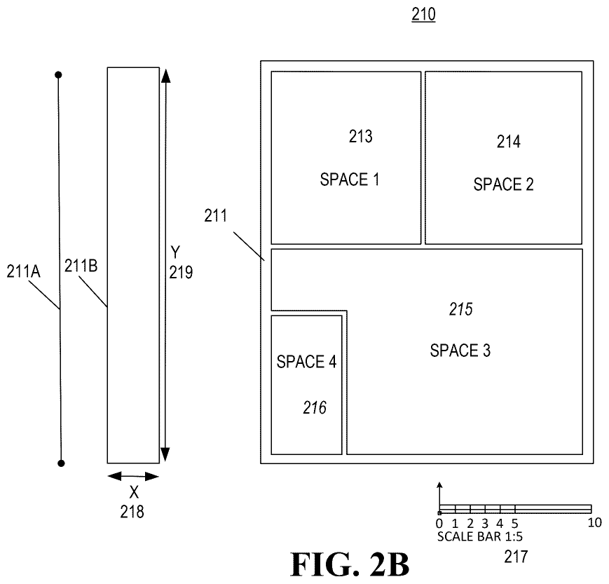

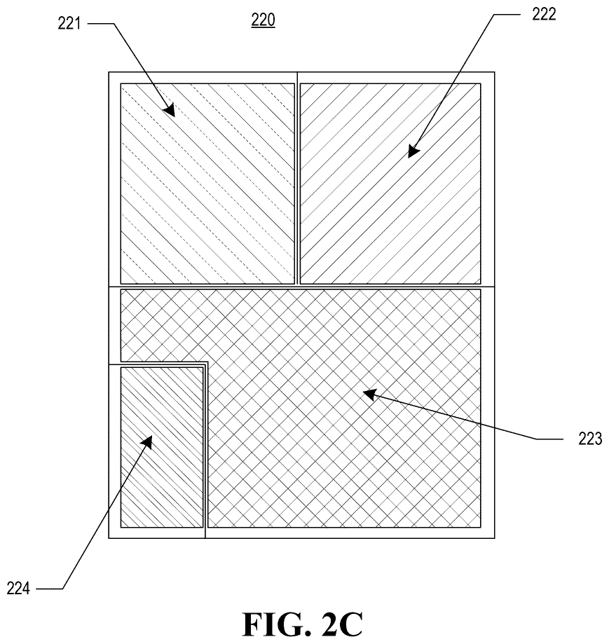

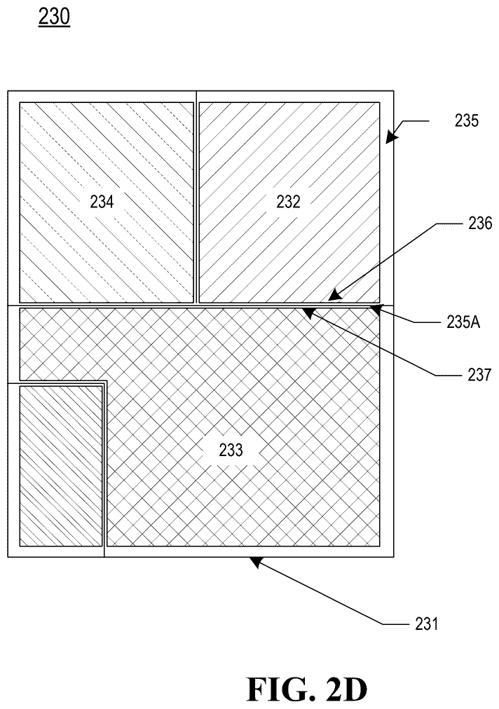

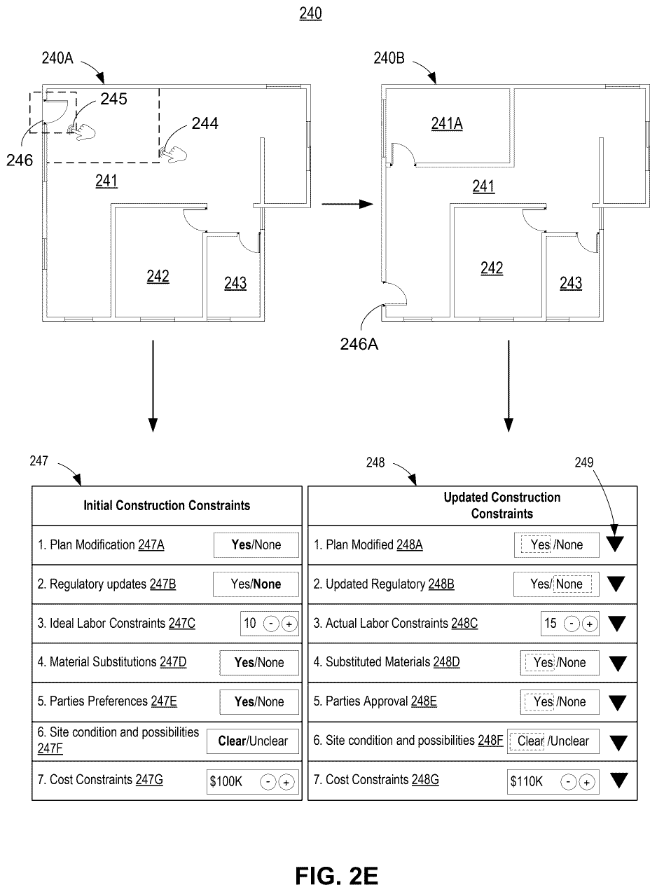

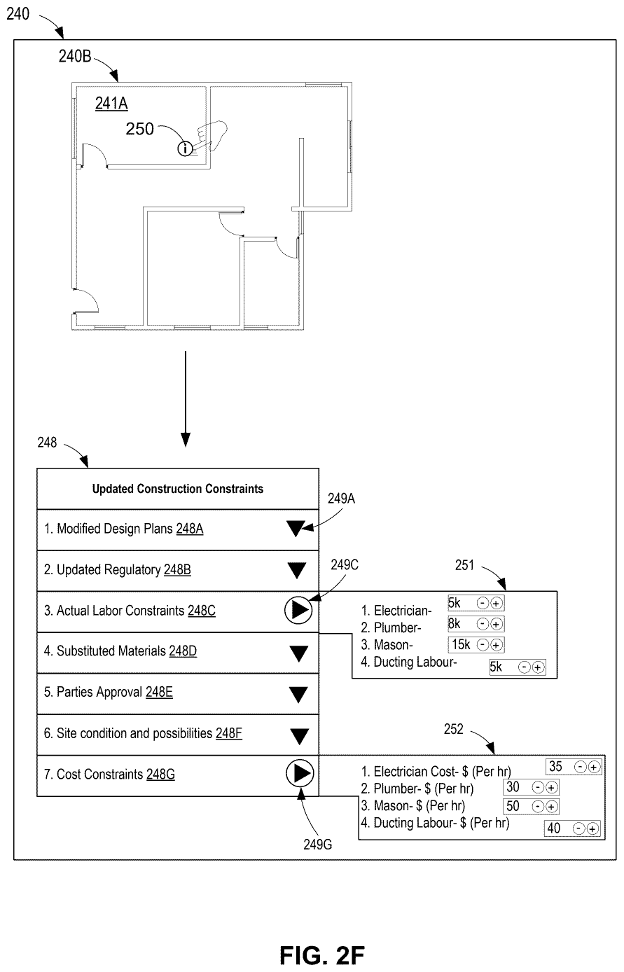

In some embodiments, a training database may utilize a collection of design data that may include one or more of: a combination of a vector graphic two-dimensional references such as floor plans and associated raster graphic version of the two-dimensional references; raster graphic patterns associated with features; and a determination of boundaries may be automatically or manually derived. (An exemplary AI-processed two-dimensional reference that includes a design plan and/or a floorplan 210, with boundaries 211 predicted, is shown in FIG. 2B, based on the floorplan of FIG. 2A).

In still another aspect, in some embodiments, a controller may access data from various types of BIM and Computer Aided Drafting (CAD) design programs and import dimensional and shape aspects of select spaces or portions of the designs as they are related to a design plan.

At step 104, an AI engine may ascertain features included in the design plan, the AI engine may additionally ascertain that a feature is located within a particular set of boundaries or external to the set of boundaries. Features may include, by way of non-limiting example, one or more of: architectural aspects, fixtures, duct work, wiring, piping, or other items included in a two-dimensional reference submitted to be analyzed. The features and boundaries may be determined, for example, via algorithmically processing an input design plan image with a trained AI model. As a non-limiting example, the AI engine may process a raster file that is converted for output as an image file of a floorplan (as illustrated in FIG. 2B, a boundary is represented as a line, a boundary may also be represented as a polygon, which may be a patterned polygon or other user discernable representation, such as a colored line etc.). Features may also be designated on a user interface. A feature may be represented via an artifact, such as, for example, one or more of: a point, a polygon, an icon, or other shapes.

At step 105, a scale (e.g., FIG. 2B item 217) is associated with the two-dimensional reference. In preferred embodiments, the scale is based upon a portion of the two-dimensional reference dedicated for indicating a scale, such as a ruler of a specific length relative to features included in a technical drawing included in the two-dimensional reference. The software then performs a pixel count on the image and applies this scale to the bitmapped image. Alternatively, a user may input a drawing scale or dimension for a particular image, building component, a wall, a boundary, a drawing, or other two-dimensional reference. The drawing scale, may for example, be in inches: feet, centimeters: meters, or any other appropriate scale.

In some embodiments, a scale may be determined by manually measuring a room, a component, or other empirical basis for assessing a scale (including the ruler discussed above). Examples therefore include a scale included as a printed parameter on two-dimensional reference or derived via reference to one or more dimensioned features in the design plan. For example, if it is known that a particular wall is thirty feet in length, a scale may be based upon a length of the wall in a particular rendition of the two-dimensional reference (or design plan) and proportioned according to that length. The known length of the wall can be determined from the markings or text on the design plan or can be specified by a user as an input. A known length or width of any other building component can be determined or entered by the user. Based on such known length or width of one building component, the scale can be proportioned, and dimensions of other building components can be calculated.

At step 106, a controller is operative to generate an interactive user interface with dynamic components (design elements) that may be manipulated by one or both of user interaction and automated processes. Any or all of the components in a user interface may be converted to a version that allows a user to modify an attribute of the components, such as the length, size, beginning point, end point, thickness, or other attribute. In some embodiments, a boundary may be treated as a component or a wall and manipulated in a similar manner.

Other components included in the user interface may include, one or more of: AI engine predicted components, user training aspects, and AI training aspects. In some non-limiting examples of the present invention, a generative adversarial network may include a controller with an AI engine operative to generate a user interface that includes dynamic components. In some embodiments, a generative adversarial network may be trained based on a training database for initial AI feature recognition processes.

An interactive user interface may include one or more of: lines, arcs, or other geometric shapes and/or polygons. In some embodiments, the geometric shapes and/or polygons may comprise boundaries. The components may be dynamic in that they are further definable via user and/or machine manipulation. Components in the interactive user interface may be defined by one or more vertices. In general, a vertex is a data structure that can describe certain attributes, like the position of a point in a two-dimensional or three-dimensional space. It may also include other attributes, such as normal vectors, texture coordinates, colors, or other useful attributes.

At step 106A, in some embodiments, components presented in the interactive user interface may be analyzed by a user and refinements may be made to one or more components (e.g., size, shape and/or position of the component). In some embodiments, user modifications may also be input back to the AI engine to train the AI engine. User modifications provided back to the AI Engine may be referenced to make subsequent AI processes more accurate, efficient, fast, trained and/or enable additional types of AI processes.

At step 107, some embodiments may include a simplification or component refinement process that is performed by the controller. The component refinement process is functional to reduce a number of vertices generated by a transformation process executed via a controller generating the user interface and to further enhance an image included in the user interface. Improvements may include, by way of non-limiting example, one or more of: smooth an edge, define a start, or endpoint, associate a pattern of pixels with a predefined shape corresponding with a known component or otherwise modify a shape formed by a pattern of pixels.

In addition, some embodiments that utilize the recognition step transform features such as windows, doorways, vias and the like to other features and may remove them and/or replace them as elements-such as line segments, vectors, or polygons referenceable to other neighboring features. In a simplification step, one or more steps the AI performs (which may in some embodiments be referred to as an algorithm or a succession of algorithms) may make a determination that wall line segments, and other line segments represent a single element and then proceeds to merge them into a single element (line, vector, or polygon). In some embodiments, straight lines may be specified as a default for simplified elements, but it may also be possible to simplify collections of elements into other types of primitive or complex elements including polylines, polygons, arcs, circles, ellipses, splines, and non-uniform rational basis spline (NURBS) where a single feature object with definitional parameters may supplant a collection of lines and vertices.

The interaction of two elements at a vertex may define one or more new elements. For example, an intersection of two lines at a vertex may be assessed by the AI as an angle that is formed by this combination. As many construction plan drawings are rectilinear in nature, it may be that the simplification step inside a boundary can be considered a reduction in lines and vertices and replacing them with elements and/or polygons.

In another aspect, in some embodiments, one or both of a user and a controller may indicate a component type for a boundary. Component types may include, for example, one or more of: line segments, polygons, multiple line segments, multiple polygons, and combinations of line segments and polygons.

At step 108, a controller (such as, by way of non-limiting example, a cloud server) operative an AI engine and/or a GAN engine may create AI-predicted dynamic boundaries that are arranged to form a representation of the submitted design plan that does not include the boundaries that bound it.

In various embodiments, a boundary may be used to define a unit, such as a residential unit, a commercial office unit, a common area unit, a manufacturing area, a recreational area, a dining area, or other area, delineated according to a permitted use.

Some embodiments include an interface that enables user modifications of boundaries and areas defined by the modified boundaries. For example, a boundary may be selected and “dragged” to a new location. The user interface may enable a user to select a line end, a polygon portion, an apex, or other convenient portion and move the selected portion to a new position and thereby redefine the line and/or polygon. An area that includes a boundary as a border will be redefined based upon the modification to the boundary. As such, an area of a room or unit may be redefined by a user via the user interface. Changing an area of a room and/or unit may in turn be used as a basis for modifying an occupant load, defining an egress path, classifying a space, or other purposes.

For example, a change in a boundary may make an area larger. The larger area may be a basis for an increase in occupancy load. The larger area may also result in a longer path from the furthest point in the defined area to a point of egress (e.g., if a user chooses to use a worst case in determining an egress route). Empowering users with flexibility, the present invention allows for modifications to room boundaries, lines, and polygons, enabling the alteration of shapes and sizes to adhere to best practices with automated revision suggestions to design plans. This dynamic feature not only facilitates compliance with regulatory standards but also caters to user preferences or priorities, allowing them to retain the opulence and aesthetic appeal of their spaces. Whether it is aligning with specific best practice requirements or enhancing the overall user experience by accommodating individual tastes, the present invention offers a harmonious blend of functionality and personalization. Users can effortlessly tailor their rooms to meet both regulatory guidelines and their own vision, striking a balance between compliance and the creation of spaces that truly reflect their unique style and preferences.

At step 109, the controller receives a user input for a change order. The change order input is initiated through the interactive user interface, which allows a user, such as an architect, contractor, or client, to specify desired modifications to the initial design plan. The change order input may include detailed information about the change, such as the location, scope, and type of modification required. For example, a user may request shifting a window to improve lighting or propose resizing a room to accommodate new furniture.

The interactive user interface provides tools such as drag-and-drop features, text entry fields, and annotation capabilities to assist the user in accurately describing the change order. For example, an architect may annotate the floor plan directly on the interface, marking specific areas for modification, while a contractor may input specific dimensions or material substitutions. This flexibility allows users to define change orders in a manner that suits their expertise and project role.

The input received at step 109 is not limited to structural changes. It may also include requests for regulatory compliance updates, material substitutions due to availability issues, or labor adjustments. For example, a user may request replacing hardwood flooring with engineered wood due to cost considerations. The controller records each change order with associated metadata, such as the timestamp, user ID, and rationale for the change. This information may be stored in a centralized database, enabling traceability and future reference.

Additionally, the controller is designed to validate the user input for completeness and accuracy. If a change order lacks necessary details, such as dimensions or material specifications, the system prompts the user to provide additional information. For example, if a user requests adding a staircase but does not specify the type of staircase (e.g., spiral, or straight), the user interface might display a list of predefined options for selection. This validation facilitates that the input is actionable and ready for analysis in subsequent steps.

At step 110, the controller analyzes the received change order input to assess its impact on interrelated design elements. This analysis involves identifying dependencies between the requested change and other components of the design plan. For example, if the change order involves moving a wall, the controller evaluates how this adjustment affects the electrical wiring, plumbing, and HVAC systems embedded within or near the wall.

The controller uses an AI engine and/or a GAN engine to perform this analysis. These engines are trained on large datasets of design plans and their interdependencies, enabling the system to predict cascading effects of a proposed change. For example, if a user requests extending a balcony, the controller identifies associated structural reinforcements, evaluates whether the extension affects adjacent rooms, and determines the impact on the building's load distribution.

Some embodiments of this analysis may involve visualizing the affected interdependencies on the interactive user interface. The system highlights the design elements impacted by the change order, allowing users to understand the scope and complexity of the modification. For example, when a window is shifted to another wall, the user interface may highlight the affected electrical conduits and insulation materials, providing a clear view of the implications.

The controller may also cross-reference the change order with applicable building codes and regulations. If the modification violates any compliance requirements, such as fire safety regulations or structural stability standards, the system flags these issues and provides suggestions for alternative solutions. For example, if moving a staircase reduces the emergency exit width below the required standard, the system may suggest resizing the staircase or adjusting the surrounding layout.

At step 111, the controller calculates the impact of the change order on project constraints, including cost, labor, timeline, and materials. This step involves generating detailed estimates for implementing the proposed modification. For example, if the change order involves resizing a room, the system calculates the additional material required, such as drywall, flooring, and paint, as well as the labor hours needed to complete the task.

The cost analysis includes itemized estimates for each component affected by the change order. For example, if adding a new wall requires additional electrical outlets, the system calculates the cost of the outlets, wiring, and labor required for installation. The labor analysis accounts for the availability of skilled workers, such as electricians or carpenters, and adjusts the project schedule accordingly.

In some embodiments, the system generates multiple scenarios based on different implementation options. For example, if the change order involves upgrading materials, the controller may provide cost estimates for various grades of materials, such as standard, premium, or luxury finishes. This enables stakeholders to make informed decisions based on their budget and project priorities.

The system also accounts for potential delays caused by the change order. For example, if the modification requires waiting for custom materials or reallocating labor from other tasks, the controller updates the project timeline to reflect these adjustments. The recalculated constraints are presented on the interactive user interface, providing stakeholders with a comprehensive view of the change order's implications.

At step 112, the system notifies all relevant stakeholders about the proposed change order and its associated impacts. The notifications may be generated automatically and delivered through the interactive user interface or other communication channels, such as email or project management software. Each notification may include detailed information about the change order, the recalculated constraints, and the interdependencies identified in step 110.

The system provides stakeholders with tools to review and approve the proposed changes. For example, contractors may review the updated cost estimates and labor requirements, while architects may evaluate the revised design plan for compliance and aesthetics. Stakeholders can approve, reject, or request modifications to the change order directly through their respective user interfaces.

To facilitate collaboration, the system allows stakeholders to leave comments or suggestions. For example, a contractor may propose an alternative material to reduce costs, while a client may request additional changes to align with their preferences. These inputs are recorded and used to refine the change order in subsequent iterations.

The approval process is streamlined using real-time updates and notifications. If any stakeholder rejects the change order, the system loops back to step 109, where the user can input revised modifications. This iterative process continues until all stakeholders approve the change order, enabling seamless coordination among all parties involved.

At step 113, the system enters a feedback loop where steps 109 through 112 are repeated as needed. This iterative process allows users to refine and optimize change orders based on stakeholder feedback and updated constraints. For example, if a proposed material substitution is rejected due to budget limitations, the system enables the user to explore alternative materials and resubmit the change order.

The iterative nature facilitates that the design plan evolves dynamically to meet user requirements while maintaining alignment with project constraints. For example, if multiple change orders are submitted simultaneously, the system prioritizes and processes them sequentially, updating the design plan and associated constraints after each iteration.

Sone embodiments may involve generating real-time visualizations of the updated design plan. The interactive user interface displays the cumulative impact of all approved change orders, providing stakeholders with a clear understanding of the project's progress. This visualization helps identify potential conflicts or opportunities for further optimization, enabling proactive decision-making.

In some embodiments of the present invention, the AI engine is responsible for managing and enforcing associated rules pertaining to the movement or alteration (change orders) of design elements that have associated annotations. The system is configured to recognize user roles and privileges, so that only those users with the appropriate permissions can make changes, move, or alter design elements or their associated annotations. If a user without the required rights attempts such actions, the AI engine intervenes, restricting these unauthorized modifications. This enforcement of rules maintains the integrity of the design plan and facilitates compliance with collaborative protocols. It also protects the annotations' continuity and relevance, as any changes to design elements are reflected in real-time, preserving the accuracy and context of the collaborative effort.

In some embodiments of the present invention, the AI engine may include a learning mechanism that constantly evaluates past annotations in relation to similar design elements. This historical analysis allows the AI engine to identify patterns and preferences in the annotation behaviors of users. Consequently, when a specific design element is selected for annotation, the AI engine may proactively suggest potential annotations, drawing from its repository of learned data. These automated annotation suggestions aim to streamline the annotation process by anticipating user needs and promoting consistency across the design plan. This feature not only saves time but also enhances the overall quality of the annotations by leveraging the collective intelligence gathered from previous interactions within the platform.

In some embodiments of the present invention, when a change order requires less time, material, or cost than originally allocated, the system recalculates the associated constraints to optimize the design plan and redistribute resources effectively. The controller, operating with an AI engine and/or GAN engine, dynamically evaluates the impact of the reduced requirements on other design elements and project constraints.

For example, if a user submits a change order to reduce the size of a room, the controller recalculates the amount of materials required, such as drywall, flooring, and paint, resulting in a reduction in overall project costs and labor hours. In this scenario, the recalculated time and cost are reflected in the updated design plan and presented to stakeholders for review and approval. The controller may automatically suggest reallocating the saved budget and labor hours to other tasks or areas of the project, such as enhancing another section of the building or accelerating the timeline for critical tasks.

In another embodiment, if the change order involves eliminating or downsizing a non-critical structural element, such as removing a decorative partition wall, the system recalculates the structural load and redistributes it across the remaining elements. The removal of the wall reduces material costs, such as studs, drywall, and paint, as well as labor associated with installation and finishing. The controller analyzes whether this adjustment impacts other interconnected systems, such as HVAC duct placements or electrical wiring, and updates the design plan accordingly.

In scenarios where less material is required due to a change in design, such as opting for minimalistic interiors or replacing bulkier materials with lightweight alternatives, the controller calculates the surplus and identifies opportunities to repurpose the excess materials elsewhere in the project. For example, if fewer tiles are needed for a particular area, the remaining tiles can be reassigned to a backup inventory for future repairs or to extend tiling in a high-traffic area. This approach minimizes material wastage and enhances overall project efficiency.

If a change order results in a shorter timeline, such as substituting a prefabricated component for a custom-built structure, the system recalculates the labor schedule to reflect the reduced construction time. For example, if a user opts to use modular staircases instead of traditional on-site construction, the controller adjusts the labor hours and schedules the workforce for other pending tasks. This reallocation prevents resource idleness and maintains the overall project timeline while accommodating the change order.

In some embodiments, the recalculation may also impact third-party stakeholders, such as subcontractors or suppliers. For example, if the change order reduces the quantity of a material initially ordered, the system automatically notifies the supplier to adjust the delivery schedule or cancel the excess order. This feature helps avoid unnecessary procurement costs and logistical complications. Similarly, if the labor requirements are reduced, subcontractors are notified with updated schedules and revised payments, providing seamless coordination.

The system also considers scenarios where cost savings from one change order may be applied to enhance other project aspects. For example, if resizing a balcony reduces material and labor costs, the controller may suggest reallocating the saved budget to upgrade the balcony railings with a more durable material or to add decorative lighting. These automated suggestions are displayed on the user interface, enabling stakeholders to explore value-adding modifications that align with the project's goals.

In another embodiment, the recalculated constraints due to reduced time or material requirements are logged into a centralized database for future reference. This historical data helps stakeholders make informed decisions for similar projects by providing insights into cost-effective changes and their impacts. For example, if a specific material substitution led to significant savings in a previous project, the system may recommend the same substitution for similar scenarios in the current project.

Furthermore, the system is capable of handling scenarios where multiple change orders interact to produce cumulative reductions in constraints. For example, if one change order reduces the size of a room and another removes a partition wall, the controller calculates the combined effect on structural integrity, HVAC efficiency, and electrical layouts. The recalculated constraints are then presented as a holistic view, allowing stakeholders to understand the overall impact on the project.

In some embodiments, the system provides proactive recommendations to maximize the benefits of reduced constraints. For example, if a change order reduces labor hours significantly, the controller may suggest redistributing the saved time to accelerate other high-priority tasks or to conduct additional quality checks. Similarly, if material costs are lowered, the system may recommend upgrading other elements within the same budget, such as using higher-quality finishes or installing energy-efficient fixtures.

Referring now to FIG. 1B, a high-level diagram illustrates components included in a system 120 that uses AI to generate an interactive and collaborative user interface 125 and programmable apparatus (controller) 123 operative to execute method steps useful in one or both of: adding annotations to design elements within a static representation of a design plan, and managing alterations to these design elements while automatically adjusting the associated annotations and rules in real-time. This process may involve identifying design elements that may benefit from additional information or clarification, prompting users to add relevant annotations. Furthermore, when design elements are moved or altered, the AI engine facilitates that all related annotations are dynamically updated, altered or kept intact to reflect these changes, maintaining the accuracy, association, and relevance of the annotations. Simultaneously, the system may enforce automated, predefined, or user-defined rules regarding who can make alterations to those design elements and/or associated annotations, based on user roles and permissions, thereby preserving the integrity of the design plan, and facilitating a collaborative yet controlled design environment.

According to some embodiments of the present invention, a two-dimensional reference 121, such as a design plan, floorplan, blueprint, or other document includes a pictorial representation 122 of at least a portion of a building. The pictorial representation 122 may include, for example, a portable document format (PDF) document, jpeg, PNG, or other important non-dynamic file format, or a hardcopy document. The pictorial representation 122 includes an image descriptive of architectural aspects of the building, such as, by way of non-limiting example, one or more of: walls, doors, doorways, hallways, rooms, residential units, office units, bathrooms, stairs, stairwells, windows, fixtures, real estate accouterments, and the like.

The two-dimensional reference 121 may be electronically provided to a controller 123 running an AI engine and a GAN engine. The controller 123 may include, for example, one or more of: a cloud server, an onsite server, a network server, or other computing device, capable of running executable software and thereby activating the AI engine. Presentation of the two-dimensional reference may include, for example, scanning a hardcopy version of the two-dimensional document into electronic format and transmitting the electronic format to the controller 123 running the AI engine.

According to the present invention, the AI engine may use raw data, manipulated data, interpreted data, new data and data types generated from existing data. Data may include one or more of: text, image, numerical, pixel patterns, polygons, vectors, molecular, neural, digital, and analog data modalities.

Data sources may include, one or more of: a user portal; Internet accessible resources; shipping data, fuel use tracking; manufacturer data; product data sheet; geolocation device, or other receptacle or generator of data related to material used in a building or other construction project.

AI engine processing may include one more of: converting image data to pixel patterns and/or polygon patterns, manipulating pixel patterns and/or polygon patterns, analyzing pixel patterns and/or polygon patterns, optical character recognition, alphanumeric analysis, symbol recognition and the like. Proposed action strategies, protocols and opportunities may be associated with an ascertained state.

The present invention provides for the deployment of computational frameworks combining disparate aspects of technology to perform tasks that are beyond the ability of traditional design and build systems or human intelligence. These systems aggregate large volumes of disparate data that may or may not be intuitively linked to building design, carbon footprint, eco-friendliness, compliance codes, supply chain availability, anticipated ambient climate conditions, measured ambient climate conditions, building activities, or other data source, and utilize multiple modalities data manipulation, algorithms, and statistical models to generate proposed action strategies for a patient (or group of similarly situated patients). Modalities of data manipulation may include, but are not limited to:

Machine Learning (ML): A subset of AI where systems learn from data. Instead of being explicitly programmed, they adjust their operations to optimize for a certain outcome based on the input they receive.

Deep Learning: A subfield of ML using neural networks with many layers (hence “deep”) to analyze various factors of data, such as, for example, convolutional neural networks (CNNs) used in image recognition. For example, convolutional neural networks may receive as input image data from scans of various types and generate pixel patterns representative of the scans. The pixel patterns may be compared to a library of other pixel patterns and/or manipulated to emulate progression of a disease state and/or a treatment protocol over time.

Natural Language Processing (NLP): Allows systems to understand, interpret, and generate human language. NLP may provide interpretations of voice data. Voice data may be made accessible, for example, via recording made during design plan review and assessment and/or during supply chain activities.

Robotics: Robots may operate using AI principles, enabling the robots to perform tasks in accurate, specific, and consistent ways. Robots may also be utilized during data collection, such as during building scans (e.g., 3D image acquisition scans), as built measurement acquisition, infrared heat image acquisition and the like.

Knowledge Representation: The methods and apparatus taught herein may receive data in a native or enhanced state and manipulate and transform the received data into a machine learning understandable form.

Reasoning: The methods and apparatus taught herein may solve deploy logical deduction via expert systems and the like to facilitate decision-making.

Perception: The methods and apparatus taught herein may use algorithms and complex relational processes that allow machines to interpret disparate data sets, including image data, sound data, and alphanumeric data.

Apparatus and methods may be arranged to form one or more of: Neural Networks; Genetic Algorithms; Expert Systems; and Reinforcement Learning.

In some embodiments, GPUs may be used to accomplish large-scale machine-learning models using parallel processing capabilities. Hardware accelerators may be utilized for deep learning tasks. In some embodiments, tensor processing units and/or neuromorphic computing mechanisms may be used to analyze data sets. Cloud platforms may be used with AI processes, such as deep learning that require significant computational resources.

Electronic and/or electromechanical apparatus may provide data to be processed using the methods and apparatus presented herein. Apparatus may include, by way of a non-limiting example, one or more of: three-dimensional (3D) image scans, heat imaging acquisition, design plan scanners, building monitoring electronic sensors, drone-based electronic scans, satellite-based data acquisition or other means of acquiring data that may be transformed into digital and/or analog data sets.

Some AI Engine generated treatment strategies may include suggested courses of action that may be weighted based upon one or more of: projected effectiveness; timing, geographic location, and a material's ability to be transported; cost; and project criticality, including timeline relative to other actions and/or tasks that must be completed, such as for example, a sequence of construction steps, inspections, and financing requirements.

The controller is operative to generate a collaborative user interface 125 on a user computing device 126. The user computing device may include a smart device, workstation, tablet, laptop or other user equipment with a processor, storage, and display.

The user interface 125 includes a reproduction of the pictorial representation 122 and an overlay 124 with one or more user-manipulatable components, such as, by way of non-limiting examples: boundaries, line segments, polygons, images, icons, points, and the like. The line segments may have calculated lengths that may be mathematically manipulated and/or summarized. Aspects such as polygons, line segments, shapes, icons, and points may be counted, added, subtracted, extrapolated, and have other functions performed on them.

In addition, renditions of the user interface 125 may be created and saved, and/or communicated to other users, or controllers, compared to subsequent interface renditions, archived, and/or submitted to additional AI analysis.

In some embodiments, a first user interface 125 rendition may be modified by a user to create a second user interface 125 and submitted to AI analysis to perform tasks, including assisting users in adding better annotations to a selected design element. This assistance is based on the AI's analysis of the selected design element and a historical review of similar annotations associated with such design elements. The AI engine continuously learns from the ways users add annotations to different types of design elements, enabling it to suggest the most relevant and useful annotations for any given element. This learning process allows the AI engine to provide tailored suggestions that improve over time, reflecting the collective experience and insights of the user community on the collaborative platform of the present invention. By leveraging past annotation patterns, the AI facilitates a more intuitive and efficient annotation process, enhancing the collaborative design effort.

In the context of the present invention, design elements may also refer to the various components that contribute to the overall layout, functionality, and aesthetic appeal of a building or space. These elements include, but are not limited to, rooms, walls, doors, windows, staircases, partitions, fixtures, furniture, and finishes. Rooms may be designated for specific functions, such as living rooms, bedrooms, kitchens, or bathrooms, with their size and shape tailored to the intended use. Walls define the boundaries of spaces and may serve structural, aesthetic, or privacy functions, while partitions provide flexible divisions within open areas. Doors and windows are important for access, ventilation, natural light, and aesthetics, with their placement affecting the flow and usability of a space. Fixtures, such as sinks, toilets, lighting, and built-in cabinetry, are important for the functionality of spaces like bathrooms and kitchens. Furniture placement, including beds, desks, sofas, and dining tables, defines how a space will be used, enhancing comfort and practicality. Additionally, design elements may include aesthetic features such as color schemes, textures, flooring materials, and decorative finishes, which contribute to the visual and tactile experience within a space. These elements are also configured to comply with spatial and functional requirements, user preferences, and environmental factors such as lighting, acoustics, and air circulation, all of which are considered in the design plan generated by the system.

Referring now to FIG. 1C, the illustration showcases an exemplary aspect of the present invention's collaborative environment, demonstrating how a user may annotate a design element on a design plan. In this exemplary embodiment, the user interface 125 displays a static pictorial representation 122 of a design plan, containing various dynamic design elements such as lines, polygons, rooms, walls, and boundaries. A user may initiate the annotation process by selecting 131 a design element 130 on the design plan 122, which can be done by marking on or around the desired design element 130 or by simply double-clicking on the design element 130.

Upon selection, a pop-up window 132 appears, providing a space where the user can type in text annotations that will be linked with the chosen design element 130. Alongside the text entry field, the pop-up window 132 may also include an additional options button 134. This button 134, when selected, unveils a suite of annotation tools 135, offering a range of methods to enrich the annotations.

For example, the user can choose to attach multimedia content 136, like photos or video clips, which may serve as a visual supplement to the textual annotations for the selected design element 130. If the user wishes to add an audio note, they can do so using the audio record function 137, capturing their verbal instructions or comments directly via a microphone. Moreover, the user also has the convenience of using a speech-to-text feature 138, where spoken words are transcribed into written text annotations. This functionality simplifies the process of adding detailed descriptions or instructions, as the user's voice is automatically converted to text and associated with the selected design element 130 as an annotation.

In some embodiments of the present invention, the interactive user interface may be engineered to offer an intuitive mechanism for annotating within a shared design plan. When a user selects a design element, such as a polygon, a line, a room or a wall, the system may respond by presenting a context-sensitive annotation interface. This interface is contextually programmed to suggest annotation tools and options relevant to the type of design element selected. For example, upon selecting an area where an air conditioning unit is to be installed, the interface may prioritize or suggest multimedia annotations that provide visual cues or installation guidelines.

Referring now to FIG. 1D, the diagram illustrates an exemplary feature of the present invention's interface, specifically designed to aid users in the annotation process. The figure displays a user actively engaging with an annotation pop-up window 132 for a selected design element within the collaborative platform. As the user begins to type, for example, “Install AC Here,” the system's AI engine intervenes with automated annotation suggestions as shown in an automated annotation suggestions window 150.

These suggestions, shown in the automated annotation suggestions window 150, are generated based on a variety of factors, including the current context of the design element, the user's typing activity, and historical data collected from past user interactions with similar design elements. The exemplary annotation suggestions may include but are not limited to: “Install AC Here but size must not exceed . . . ” , “Prefer window here . . . ” , or other recommendations like “Drawing room—install TV here . . . ”. Each suggestion aims to prompt the user with common annotations or considerations that align with the selected design element's purpose and location.

Additionally, the interface may also facilitate inclusion of multimedia annotations, as evidenced by the “Add this image . . . ” option accompanied by a photo icon for a recommended photo extracted from an annotation database to be associated with the annotation. This interactive feature suggests that users can enrich their annotations with visual aids directly related to the selected design element, which may include images or diagrams relevant to the installation or positioning instructions (i.e., annotations) being entered.

This automated annotation suggestions feature showcases the system's dynamic response to user input, effectively marrying the AI's predictive capabilities with the user's manual annotations. It enhances user experience by minimizing repetitive typing, guiding users through a library of common annotations, and providing quick-access options for multimedia attachments. This intelligent assistance is indicative of the platform's design to expedite the annotation process, reduce potential errors, and facilitate consistency in documentation throughout the collaborative design environment.

In some embodiments of the present invention, the system's AI engine utilizes an extensive annotation database to provide automated annotation suggestions that may also include a multimedia library. When a user initiates an annotation-adding process for a selected design element, the AI engine queries this library to retrieve and suggest one or more images (or maybe video clips) that are relevant to the design element in question. This library comprises a collection of images and video clips previously used in annotations, which have been tagged and indexed according to the design elements they correspond to.

Furthermore, the AI is capable of generating automated images and video clips based on its historical analysis of similar past annotations. It uses learned patterns and user behavior to predict and present the most pertinent visual aids that could enhance the current annotation. This predictive ability is grounded in the AI's continuous learning process, where it assimilates information from each annotation interaction, gradually refining the relevance and precision of its image suggestions.

Such an embodiment streamlines the annotation process by providing users with quick access to a curated set of images and video clips, reducing the need for manual searches and facilitating a high level of consistency and detail in the annotations associated with specific design elements. Whether the user is specifying installation details, highlighting design features, or indicating modifications, the AI engine's integration with a multimedia library enriches the collaborative experience and aids in the conveyance of clear, concise, and visually supported information.

By way of non-limiting examples, according to the present invention, a design plan may be received as a static image two-dimensional reference. The design plan may be described using lines and arcs and represents architectural layouts in a simplified geometrical way. In such a representation, architectural elements, such as, by way of non-limiting examples: walls, doors, windows, and architectural details, may be shown using straight lines (for linear elements) and arcs (for curved elements). A floorplan interpreted in terms of lines and arcs and/or patterns of pixels may include one or more of:

Exterior Walls: typically represented by thick lines. The thickness of a line may indicate the wall's thickness.

Interior Walls: which may be shown as slightly thinner lines compared to exterior walls, representing partitions or dividers within a space or other interior area.

Hinged Doors: a straight line representing a door's location and an arc showing the door's swing direction and extent.

Sliding Doors: two parallel lines (representing door panels) may include an arrow or dashed line indicating a sliding direction.

Double Doors: two straight lines representing door panels with arcs indicating each door's swing direction.

Which may, for example, be represented as thin lines or breaks in walls, sometimes with a zigzag line to indicate a window's presence or with a double line, indicating a double-pane window.

Straight Stairs: a series of parallel lines showing steps. Often, an arrow may be used to indicate the upward direction.

Spiral Stairs: may be represented using concentric arcs or circles, showing the curvature of the stairwell.

Cabinets, Countertops, Islands: straight lines and arcs may represent a shape and placement of cabinets, countertops, and islands.

Sinks, bathtubs: may typically be represented using a combination of lines and arcs to depict their shapes.

Rounded Corners: instead of sharp, angular intersections between walls, arcs are used to show the curve.

Circular Rooms or Features: may be represented using full circles or arcs.

Electrical: may be shown with dotted lines or specific symbols indicating outlets, switches, and fixtures.

Plumbing: may be represented via dotted or dashed lines to represent hidden plumbing within walls or under floors.

When interpreting or representing a floorplan using lines and arcs, conventions used in architectural drawings may be referenced. In some embodiments, a legend or key that describes what each line, arc, or symbol means, may facilitate clarity in understanding the design.

FIG. 1E shows a settings window 140 that emerges when a user engages with the settings option 133 on the annotations pop-up window 132. This settings window 140 serves as a control panel for managing the collaborative and interactive features of the platform tailored to user annotations and design elements.

The “Set Rules” function 141 enables users to establish comprehensive guidelines for managing interactions with the design plan. Users can define protocols for editing, altering, deleting, or relocating both design elements and their associated annotations within the collaborative platform. Serving as a robust governance mechanism, this function facilitates that any modifications to the design plan or its components are consistent with predefined conditions. These conditions may be customized to meet the unique demands of a specific project, cater to individual user preferences, align with organizational policies, or comply with applicable best practices and regulations. Furthermore, the “Set Rules” 141 feature is designed to be flexible, allowing for an automated or manual adjustment of rules as the project evolves or as new information becomes available to the AI engine, facilitating ongoing relevance and adherence to the latest standards and practices.

In some embodiments of the present invention, the settings window may be a nexus of innovative controls that adapt to the intricate dynamics of the collaborative design environment. The “Set Rules” feature 141 may be engineered with an algorithm that can predict and propose rule sets based on the project type, historical data, and individual user performance, thus preempting a requirement for manual input, and offering a starting point for rule customization. The “Set Rules” option 141 may allow users to construct a detailed matrix of permissions, specifying who can make edits, how elements can be adjusted, and under what circumstances annotations can be moved or deleted. This rule-setting may go beyond general restrictions, offering granular control, such as time-bound editing rights or element-specific permissions that facilitate changes are made responsibly and in accordance with the project's lifecycle or phase-specific requirements.

With the “Share with” option 142, users can distribute the annotations and design elements to selected team members or stakeholders. Beyond standard methods like email, the system may incorporate features such as direct in-platform tagging, integration with project management tools for task assignments, or even using unique identifiers like QR codes that, when scanned, grant access to specific annotations or design elements. In some embodiments of the present invention, the “Share with” function 142 may employ machine learning algorithms to suggest potential team members for collaboration based on their past contributions, expertise, and current availability, going beyond manual tagging and email sharing. This feature may integrate with organizational calendars and resource planning tools to automatically suggest the best times and team members for collaborative sessions within the platform.

The “Share with” feature 142 may extend collaboration by integrating with advanced user identification systems, enabling sharing through biometric recognitions, such as fingerprint or retina scans, for high-security projects. It may also incorporate smart notifications that alert users when a relevant component is shared with them, streamlining the review and feedback process.

The “Roles” setting 143 is designed to define and assign specific permissions to different users or team members. This feature not only controls who can change or approve annotations but also can extend to defining hierarchies of approval, enabling tiered levels of access where senior designers or project managers may have override capabilities or exclusive editing rights. In some embodiments of the present invention, for “Roles” setting 143, the system may dynamically suggest role changes for users by analyzing their interaction patterns with the platform. For example, if a user frequently adds substantial contributions to a particular design element, the system may suggest elevating their role for that element or similar elements, streamlining the workflow and empowering effective contributors.

Lastly, the “AI Suggestions” option 144 may provide users with the ability to influence the AI engine's learning path, particularly concerning the relevance of automated annotation suggestions. Users can give feedback on the AI's suggestions to enhance its future performance. For example, a senior architect may train the AI to recognize and suggest energy efficiency tips for certain design elements, or an engineer may focus the AI's learning on structural integrity notes. Additionally, depending on their authority, users may influence the AI's learning on a personal level for individualized suggestions or on a collective level to improve the engine's utility for the entire team.

In some embodiments of the present invention, the “AI Suggestions” option 144 may include a feedback loop where the AI engine not only learns from the annotations made but also from the user's response to its suggestions, including ignored, accepted, or modified inputs. This allows the AI engine to refine its suggestion accuracy, not just in the context of the current project but across similar future projects. Additionally, the AI engine may offer versioning control suggestions, advising on the ideal moments to create new versions of the design plan, design element and annotations based on the volume and significance of recent annotations and changes.

Referring now to FIG. 1F, an exemplary process is illustrated wherein a user engages with the collaborative platform to relocate a design element 130 which carries an associated annotation 160. Upon moving the design element 130 to a new position (for registering a change order), now indicated as 130′, the system's AI engine automatically relocates the associated annotation to 160′ associated with the moved design element 130′, maintaining the contextual link between the annotation and the design element.

In some embodiments, the AI engine is equipped to not only move the annotation but also to assess and implement slight adjustments to the annotation's content or presentation. These modifications may be based on factors such as the nature of the movement, the final placement of the design element, or the spatial relationship to other design elements and annotations. For example, if a window, originally on the north-facing wall, is moved to a south-facing wall, the annotation may be updated to reflect the change in sunlight exposure.

Additionally, the AI engine may provide visual cues to indicate that an element has been moved, such as highlighting the original and new locations or creating a trail from the original to the new position. In some other embodiments, the AI engine may suggest updates to related annotations based on the element's new location, such as recommending changes in material or dimensions that are more suited to the new position within the structure or building.

Furthermore, the system may track the movement history, allowing users to view and revert to previous positions if needed. This feature supports iterative design processes where relocation decisions are explored and evaluated in real time. It may also aid in maintaining a comprehensive audit trail that can be invaluable during the review stages or in post-project analyses.

Referring now to FIG. 1G, an exemplary system 161 is illustrated for handling, analyzing, and processing change orders in a design plan in accordance with the present invention. The system 161 may be a collaborative centralized system as discussed in various embodiments of the present invention. The system 161 is operable through user devices 162, which are configured to perform various processes associated with managing change orders. The user devices 162 may include, but are not limited to, personal computers, tablets, smartphones, or any computing device capable of presenting an interactive user interface and supporting the functionalities described herein. These user devices 162 are equipped with a display screen to present visual representations of design plans and associated constraints, a digital storage medium comprising executable software code, and a controller 163. The controller 163 operates one or both of an AI engine and a GAN engine to facilitate the processing of data and analysis required to manage change orders effectively.

The controller 163 embedded within the user devices 162 is configured to perform a series of actions. These actions include receiving an initial design plan of at least a portion of a building. The initial design plan may encompass structural layouts, electrical schematics, plumbing configurations, and HVAC system arrangements. Initial constraints 164, associated with the initial design plan, may include parameters such as initial budget, timelines, labor allocations, and material requirements. For example, the initial constraints 164 may specify a project budget of $500,000, a timeline of six months, a labor force comprising skilled workers such as electricians and carpenters, and material requirements like concrete, steel, and glass.

During the construction phase of the building, deviations from the initial design plan or initial constraints 164 may arise due to various factors. These factors may include unforeseen site conditions, updated building regulations, client-requested modifications, or logistical challenges such as delays in material delivery. For example, a contractor may encounter an unanticipated utility line at the construction site, necessitating a modification to the foundation layout. In such cases, the user, which may include contractors, architects, or clients, can input details of the required change orders 165 into the interactive user interface provided by the user devices 162.

The change orders 165 specify modifications to one or more design elements of the initial design plan. For example, a change order 165 may involve increasing the height of a building by two additional floors, substituting steel with a composite material to reduce costs, or altering the placement of electrical outlets in a room to suit updated client preferences. The controller 163 processes these change orders 165 by analyzing their impact on the associated constraints and interrelated design elements of the initial design plan.

To facilitate this analysis, the controller 163 may be wired or wirelessly connected to a design consideration database. The design considerations 166 stored within this database may include preferred building practices, compliance requirements, and historical project data. For example, the design considerations 166 may include guidelines for seismic safety in earthquake-prone regions or recommendations for energy-efficient building materials.

The design consideration database (166) may be dynamic, and update periodically (or continuously without artificial delay) based on changes in design considerations 167. Changes in design considerations 167 may occur due to regulatory updates, advancements in construction technology, or evolving client requirements. For example, new environmental regulations introduced during the construction phase may mandate the use of eco-friendly materials, thereby altering the design considerations 166.

In some embodiments, the design considerations 166 may also form part of the change orders 165. For example, a change order may include a client request to incorporate solar panels into the building design, which aligns with updated design considerations for renewable energy integration.

The controller 163 processes the change orders 165 and the design considerations 166 to determine updated constraints 168. The updated constraints 168 may include recalculated values for parameters such as time, cost, labor, and materials required to implement the change orders 165 (or change orders based on changes in design considerations 167). For example, adding two additional floors to a building may extend the project timeline by three months, increase the budget by $200,000, require additional labor such as crane operators and welders, and necessitate extra materials like steel beams and concrete.

These updated constraints 168 are displayed in the interactive user interface of the user devices 162, providing users with a comprehensive overview of the impact of the change orders. For example, a contractor viewing the updated constraints 168 may see a breakdown of additional costs, revised timelines, and a list of required materials, enabling informed decision-making.

The interactive user interface of the user devices 162 may also allow users to simulate various scenarios by modifying the change orders 165 or adjusting the design considerations 166. For example, a user may experiment with different material substitutions to evaluate their impact on the budget and timeline. Such simulations help users explore cost-effective and efficient solutions before implementing the change orders.

In one embodiment, the controller 163 may utilize its AI engine to predict potential conflicts arising from the change orders 165. For example, altering the location of a structural column may interfere with existing plumbing or electrical layouts. The controller 163 identifies these conflicts and suggests alternative solutions, such as rerouting the plumbing or reinforcing the structural integrity of the column.

The GAN engine within the controller 163 generates realistic visualizations of the updated design plan, incorporating the change orders 165. These visualizations are displayed on the user devices 162, providing users with a clear understanding of how the modifications will affect the overall design. For example, a client requesting an open-concept living space can view a 3D rendering of the updated floor plan, complete with furniture arrangements and lighting configurations.

The design consideration database (166) connected to the controller 163 may also store data from previous projects, enabling the system 161 to recommend best practices based on historical success. For example, if a previous project in a similar climate used a specific type of insulation material to enhance energy efficiency, the system 161 may recommend the same material for the current project.

In another embodiment, the system 161 facilitates collaboration among multiple stakeholders by providing shared access to the interactive user interface or the design plans. For example, an architect, contractor, and client can simultaneously review the updated constraints 168 and discuss potential adjustments to the design plan in real time. This collaborative approach streamlines communication and minimizes delays.

The system 161 also tracks the approval status of the change orders 165. For example, if a change order requires approval from a regulatory authority, the controller 163 updates the status in the interactive user interface and notifies the user devices 162 upon receiving the required clearance. This feature facilitates compliance with all regulatory requirements during the construction process.

Referring now to FIG. 1H, an exemplary system 170 for processing factors influencing change orders and generating corresponding outputs is depicted in accordance with the present invention. The system 170 includes a controller 163 that is configured to receive a set of change order constraints 171 and, based on these inputs, generate updated outputs or constraints 172. The described functionalities allow for dynamic analysis and processing of change orders to streamline design planning and construction activities. Each of the constraints 171 and outputs 172 shown in FIG. 1H is discussed in detail below.

The inputs to the controller 163, collectively referred to as change order constraints 171, encompass various factors that can influence the implementation of change orders. These may include design plan changes, regulatory updates, labor constraints, material substitutions, client preferences, and site conditions. Each of these factors plays a significant role in shaping the design and construction process and is discussed in detail.

Design plan changes, as shown in 171, refer to modifications to the initial or current design plan of a project. Such changes may arise due to unforeseen site conditions, evolving client requirements, or coordination issues among contractors. For example, a project involving the construction of a multi-story building may require altering the structural design to accommodate additional utility lines. The controller 163 receives these design modifications and analyzes their impact on existing project constraints.

Regulatory updates, also part of 171, refer to changes in applicable codes, standards, or legal requirements that must be adhered to during construction. For example, updated fire safety regulations may necessitate the installation of additional fire suppression systems in the design. The controller 163 processes these updates and evaluates how they affect the design plan, labor allocation, and material requirements.

Labor constraints, depicted in 171, encompass limitations related to the availability, expertise, and productivity of the workforce. These constraints may arise from seasonal labor shortages, unionized labor rules, or the specialized skills required for certain tasks. For example, a project may face delays if skilled welders are unavailable to complete important steelwork. The controller 163 assesses such constraints and identifies potential reallocation strategies to mitigate their impact.

Material substitutions, included in 171, involve replacing originally specified materials with alternatives due to factors such as supply chain disruptions or cost considerations. For example, if a particular type of insulation material is unavailable, the controller 163 evaluates alternative materials that meet the required specifications. This evaluation considers factors such as compatibility, cost, and regulatory compliance.

Client preferences, as shown in 171, refer to specific requirements or modifications requested by the project stakeholders. For example, a client may request changes to the layout of a residential building to incorporate additional rooms or amenities. The controller 163 processes these preferences and assesses their implications on cost, schedule, and resources.

Site conditions, another factor within 171, pertain to the physical and environmental characteristics of the construction site. Examples include soil conditions, weather patterns, and site accessibility. If adverse conditions such as heavy rainfall or unstable soil are encountered, the controller 163 analyzes their impact and suggests adjustments to the project plan or construction constraints.

The controller 163 processes the aforementioned constraints 171 to generate a set of outputs or updated construction constraints 172. These outputs may include cost analysis, labor reallocation, updated sub-plan outputs, revised scheduling, automated suggestions, and notifications and approvals. Each of these outputs 172 is elaborated below.

Cost analysis, represented in 172, involves calculating the financial implications of implementing change orders arisen due to change order constraints 171. This includes assessing the direct costs of materials and labor as well as indirect costs such as delays or penalties. For example, if a design change requires the use of premium-grade materials, the controller 163 calculates the incremental cost and compares it to the project's budget.

Labor reallocation, also depicted in 172, involves redistributing the workforce to accommodate changes in the project scope or schedule. For example, if additional labor is required to expedite a task due to an unforeseen delay, the controller 163 identifies and reallocates available personnel accordingly. This process minimizes downtime and maintains overall project efficiency.

Updated sub-plan outputs, included in 172, refer to modified versions of specific project components or sub-plans affected by the change order. For example, a change in the architectural design may necessitate updates to the structural and electrical plans. The controller 163 integrates these updates to facilitate consistency across all sub-plans.

Revised scheduling, as shown in 172, involves adjusting the project timeline to reflect the impact of change orders. This may include recalculating task durations, dependencies, and milestones. For example, if adverse weather delays site preparation activities, the controller 163 revises the schedule to accommodate the delay and informs relevant stakeholders.

Automated suggestions, another output within 172, involve recommendations generated by the controller 163 to optimize the implementation of change orders. For example, the controller 163 may suggest alternative materials, construction methods, or resource allocations to minimize cost or time impacts. These suggestions are presented to the user via an interactive interface for review and approval.

Notifications and approvals, represented in 172, involve communicating the details of change orders and their implications to relevant stakeholders. This includes generating approval requests for regulatory compliance, budget adjustments, schedule changes, or material substitutions. For example, if a design modification exceeds the allocated budget, the controller 163 sends an approval request to the project manager or client.

In one embodiment, the controller 163 leverages an AI engine to analyze historical data and predict the potential impact of change orders. For example, if a similar design modification was implemented in a previous project, the controller 163 references the historical data to provide insights into potential cost and schedule impacts.

In another embodiment, the controller 163 utilizes a generative adversarial network (GAN) engine to simulate different scenarios and identify the most feasible solution. For example, the GAN engine generates multiple design alternatives based on the change order and evaluates each alternative's impact on the project constraints.

The system 170 facilitates real-time collaboration among stakeholders by integrating the controller 163 with a centralized database (Not Shown). This database stores all project-related data, including initial constraints, change orders, and updated constraints. Stakeholders can access this database through user devices to review and approve change orders.

The interactive interface provided by the user devices enables users to input constraints, review automated suggestions, and approve or reject change orders. For example, a project manager may use the user interface to evaluate the cost analysis and approve a budget increase for a design modification.

In yet another embodiment, the system 170 incorporates a feedback mechanism that allows stakeholders to provide inputs and annotations on the generated outputs. For example, a contractor may suggest modifications to the labor reallocation plan to align with on-site realities. The controller 163 processes this feedback and updates the outputs accordingly.

The system 170 enhances project efficiency by automating complex analyses and reducing manual effort. For example, the controller 163 automatically evaluates the interdependencies among design elements and identifies potential conflicts arising from change orders. This proactive approach minimizes rework and delays.

Referring now to FIG. 1I, the figure illustrates an exemplary process 175 for managing and processing change order inputs 171A in accordance with some embodiments of the present invention. The process employs a controller 163, which operates an AI engine and/or a GAN engine, to analyze change order inputs 171A and generate corresponding updates to design plans 176A-176B along with calculated constraints 177A-177B.

At the outset, the controller 163 receives change order inputs 171A. These inputs may include, but are not limited to, modifications to existing design elements, alterations in material specifications, timeline adjustments, or additional construction features requested by clients, contractors, or other stakeholders. For example, a change order input 171A may specify the addition of a new balcony to an existing structure, requiring the system to assess its impact on the current design plan.

Upon receiving the change order inputs 171A, the controller 163 analyzes these inputs to determine the affected portions or elements of the initial or current design plan. This analysis is important for identifying dependencies between design components. For example, the addition of a balcony as specified in the change order input 171A may influence structural integrity, load distribution, and material requirements for adjacent areas. The controller 163 processes these dependencies to generate updated design plans 176A and 176B.

The updated design plans 176A-176B represent updated design plans, sub-design plans or localized modifications to specific portions of the building's overall design. Each updated design plan may be tailored to reflect the requested changes while maintaining compliance with applicable building regulations, safety standards, and aesthetic considerations. For example, if the requested change order 171A involves increasing the size of a window in one part of the building, the updated design plan 176A will specify the dimensions, placement, and structural adjustments needed to accommodate the change.

Simultaneously, the controller 163 generates updated constraints 177A-177B for each affected sub-design plan 176A-176B. These constraints may include recalculated values for cost, materials, labor, and timelines required to implement the requested and affected changes. For example, updated constraint 177A associated with an updated design plan 176A may detail the additional labor hours required to install a larger window, the types and quantities of materials needed, and the additional cost implications.

In one embodiment, the updated constraints 177A-177B are presented in a structured format that enables stakeholders to assess the feasibility of the proposed changes. For example, the cost constraint within updated constraint 177A may specify an additional expenditure of $1,000 for materials and $500 for labor, while the timeline constraint indicates a delay of three days to complete the changes. Such detailed insights empower decision-makers to approve or reject the change order inputs 171A based on budgetary or scheduling considerations.

The process illustrated in FIG. 1I also accommodates scenarios where multiple change orders 171A are submitted concurrently. In such cases, the controller 163 prioritizes and processes these inputs sequentially or in parallel, depending on the interdependencies between the changes. For example, if one change order involves altering the foundation layout while another involves adding a balcony, the controller 163 evaluates the structural impacts of both changes together to produce coherent and integrated updated design plans 176A-176B and constraints 177A-177B.

Moreover, the system's flexibility allows for iterative updates. If stakeholders propose further modifications to the updated design plans 176A-176B after reviewing the associated constraints 177A-177B, the controller 163 can reprocess the inputs and generate revised outputs. This iterative capability may particularly be useful in complex construction projects where requirements evolve dynamically.

In another embodiment, the controller 163 leverages its AI and GAN capabilities to provide automated suggestions for optimizing the implementation of change orders 171A. For example, if the cost constraint (e.g., in 177B) for a specific change order exceeds the client's budget, the controller 163 may suggest alternative materials or construction methods to reduce costs while meeting design objectives. These suggestions are incorporated into the updated design plans 176A-176B and presented to the user for consideration.

The process also incorporates validation checks to facilitate compliance with regulatory and safety standards. For example, before finalizing the updated design plans 176A-176B, the controller 163 may cross-reference the proposed changes against preferred building practices stored in its database. If any discrepancies are identified, the system 175 flags these issues and recommends adjustments to align the design with regulatory requirements.

The outputs generated by the controller 163, including the updated design plans 176A-176B and constraints 177A-177B, are accessible to stakeholders via a user-friendly interface. This interface may be displayed on user devices such as laptops, tablets, or smartphones, enabling real-time collaboration and decision-making. For example, a contractor on-site can review the updated design plan 176A on a tablet, confirm the feasibility of the changes, and communicate feedback to the controller 163 for further processing.

The modularity of the process illustrated in FIG. 1I allows it to adapt to projects of varying scales and complexities. For small-scale projects, the controller 163 may process change orders 171A affecting only a single design element, such as a room's layout. For large-scale construction projects, the controller 163 can simultaneously manage multiple interconnected change orders, updating design plans 176A-176B and constraints 177A-177B for entire building sections or floors.

Referring now to FIG. 1J, it illustrates an exemplary process for registering and processing change orders (181A, 182A, 183A) on a design plan 180, wherein a controller 163 processes the change orders (181A, 182A, 183A) and generates a table 185 comprising the requirements or updated constraints for implementing the registered changes (181A, 182A, 183A). The design plan 180 may represent at least a portion of a building and comprises various structural and functional spaces, such as a staircase 181, a washroom 182, and a terrace 183. These spaces may be visually represented to allow users to view, select, and interact with specific design elements when changes are required during construction.

In some embodiments, the design plan 180 serves as the interactive user interface where users can register changes. For example, a client or contractor may wish to implement one or more change orders, such as adding a rail guard (181A) to the staircase 181, shifting a window (182A) in the washroom 182 to the middle of the wall, or increasing the size (183A) of the terrace 183. The user may register these changes directly on the digital representation of the design plan 180 by selecting the relevant design elements and specifying the modifications to be made. For example, adding rail guards (181A) may involve selecting or highlighting the staircase 181 and inputting details regarding the required change order, materials, and dimensions.

Once the change orders (181A, 182A, 183A) are registered or received, the controller 163 processes these inputs to assess their feasibility. The controller 163 may analyze various factors, including spatial availability, structural integrity, and compliance with predefined design considerations (e.g., 166 shown in FIG. 1G) stored in a database. Design considerations 166 may include preferred building practices, client preferences, contractor constraints, and other relevant regulations. For example, the controller 163 may determine whether the addition of rail guards (181A) adheres to safety standards and whether the materials required are compatible with the existing structure of the staircase 181.

For the change order related to the washroom window (182A), the controller 163 may assess whether shifting the window to the middle of the wall aligns with ventilation and lighting requirements, as stipulated in the design considerations 166. The controller 163 may also verify whether the structural modifications required for shifting the window (182A) can be performed without compromising the integrity of the wall or adjacent design elements. Similarly, for the terrace size increase (183A), the controller 163 may evaluate whether the expansion is structurally viable and whether the available materials and labor resources can accommodate the change order.

During the analysis phase, the controller 163 may identify any violations or discrepancies between the proposed change orders (181A, 182A, 183A) and the design considerations 166. For example, if the expansion of the terrace 183 (183A) violates zoning laws or exceeds the permissible load-bearing capacity of the foundation, the controller 163 may generate alerts or notifications to inform the user. These alerts may include recommendations for alternative solutions or adjustments to the proposed change orders.

If the controller 163 determines that the registered change orders (181A, 182A, 183A) are feasible and compliant with the design considerations 166, it may generate a table 185 comprising the requirements for implementing these changes. The table 185 may include detailed information such as the estimated cost, labor required, materials needed, and timelines for completion. For example, for the addition of rail guards (181A), the table 185 may specify the quantity of metal guard rails, screws, and brackets required, along with the estimated cost of $500 and a labor requirement of carpenters and installers over a two-day period.

For the washroom window modification (182A), the table 185 may list items such as the window frame, glass, adhesives, and tools needed for the change, along with the estimated labor hours for window fitters and installers. The estimated cost for this modification may be $300, with a timeline of one day. Similarly, for the terrace expansion (183A), the table 185 may specify materials such as concrete, tiles, and railing components, along with the labor requirements for masons, tile workers, and laborers. The cost for this change order may be $1500, with a projected timeline of three days.

In addition to providing cost and resource estimates, the table 185 may include additional information such as vendor recommendations, material specifications, and potential scheduling conflicts. For example, if the terrace expansion (183A) involves specialized tiles that are not readily available, the controller 163 may suggest alternative suppliers or materials that meet the design considerations 166. Similarly, the controller 163 may provide suggestions for optimizing labor allocation to minimize project delays.

The controller 163 may also facilitate collaboration among multiple stakeholders by providing a centralized platform for reviewing and approving the registered change orders (181A, 182A, 183A). For example, once the table 185 is generated, it may be shared with contractors, architects, and clients for review and feedback. The interactive user interface displaying the design plan 180 allows stakeholders to visualize the impact of the proposed changes and make informed decisions before proceeding with implementation.

In some embodiments, the controller 163 may use advanced algorithms, such as artificial intelligence (AI) and machine learning, to predict potential challenges or conflicts associated with the required change orders (181A, 182A, 183A). For example, the controller 163 may analyze historical data from similar projects to identify patterns or trends that may affect the implementation of the changes. These insights may help users preemptively address issues such as material shortages or labor bottlenecks.

Furthermore, the table 185 may be dynamically updated as new information becomes available or as changes are made to the registered change orders (181A, 182A, 183A). For example, if the client decides to use a different type of material for the rail guards (181A), the controller 163 may recalculate the estimated cost, labor, and timeline and update the table 185 accordingly. This dynamic updating capability facilitates that all stakeholders have access to the most accurate and up-to-date information throughout the project lifecycle.

Referring now to FIG. 1K, the figure illustrates an exemplary process for registering a change order, updating the design plan with the specified changes, and generating associated requirements, such as materials, cost, timeline, and labor, in accordance with the present invention. The process begins with an initial design plan 190, which may be a structural design plan or any other design plan representing a part of a building under construction. The structural design plan 190, for example, depicts a multi-story framework comprising load-bearing columns and slabs that form the core structure of the building. Examples of other design plans that may be processed include architectural layouts, electrical wiring schematics, or plumbing configurations.

In some embodiments, during the construction phase, a client or a contractor identifies a requirement to modify the design plan 190, such as the addition of a slab 191. This modification, referred to as a change order, may arise due to evolving project requirements, changes in client preferences, or compliance with revised regulatory standards. The user, such as the client or contractor, may interact with an interactive user interface to select the specific location on the initial design plan 190 where the modification is required. For example, the interface may allow the user to mark the desired position for the slab 191 and annotate the change order with additional requirements or specifications 192, such as the dimensions, material type, or intended usage of the slab 191.

Upon receiving the change order input 192, the controller 163, embedded within the user devices or connected to the system through a network, processes the input to assess its feasibility and compliance with applicable structural constraints and design considerations. The controller 163 may operate using an AI engine or a GAN engine, or a combination thereof, to analyze the structural impact of the proposed change. For example, the controller 163 may calculate the additional load exerted by the slab 191 on the existing columns and determine whether the current structural design can accommodate this load without exceeding safety thresholds.

If the analysis by the controller 163 identifies potential issues, such as the additional load exceeding permissible limits, the controller 163 may generate automated suggestions 193 to address these issues. For example, as depicted in FIG. 1K, the controller 163 may suggest adding a vertical column beneath the newly added slab 191 to distribute the load effectively and maintain structural integrity. This automated suggestion 193 may be presented to the user through the interactive interface, along with detailed technical justifications and visual representations.

In response to the automated suggestion 193, the client or contractor may choose to accept or modify the recommendation. If the suggestion is accepted, the controller 163 processes the accepted change and generates an updated design plan 190A that incorporates the new slab 191 along with the suggested additional columns. The updated design plan 190A, as shown in FIG. 1K, visually represents the modifications and may include annotations or markers, such as change indicators 194, to highlight the changes made to the original design plan 190. These change indicators 194 may provide an intuitive way for users to identify and access details of the modifications.

For each modification represented in the updated design plan 190A, the controller 163 generates associated requirements or constraints 194A (updated constraints), which may include updated material specifications, cost estimates, labor requirements, and timelines. For example, the controller 163 may calculate the quantity of concrete and reinforcement steel needed for the additional columns, estimate the labor hours required for construction, and provide an updated project timeline accounting for the added work. These requirements may be compiled into a detailed report or table, which is accessible to the client or contractor via the interactive interface.

The system may further support dynamic updates and iterative modifications. For example, if the client decides to make further changes, such as resizing the slab 191 or altering its material, the controller 163 recalculates the associated requirements and updates the design plan 190A accordingly. This iterative process facilitates that all stakeholders, including architects, engineers, and construction workers, have access to the latest design and requirements, thereby streamlining project execution.

In some embodiments, the controller 163 may also validate the proposed changes against regulatory standards and design codes stored in a design considerations database (e.g., 166). For example, the addition of the slab 191 and the associated columns may need to comply with preferred building practices related to load distribution, seismic resistance, or fire safety. If any violations are detected, the controller 163 generates alerts and provides alternative suggestions to rectify the issues.

Additionally, the controller 163 may integrate data from external sources, such as material suppliers or labor databases, to provide real-time cost estimates and availability of resources. For example, the system may check the availability of specific materials, such as high-strength concrete or steel reinforcements, and provide alternative options if the preferred materials are not readily available.

The comprehensive process depicted in FIG. 1K exemplifies the capabilities of the invention to handle complex change orders efficiently and accurately. By leveraging advanced AI and GAN technologies, the system provides a robust framework for dynamic design updates, automated suggestions, and detailed requirement generation. This approach not only enhances the flexibility and adaptability of construction projects but also promotes collaboration among stakeholders, minimizes errors, and optimizes resource utilization.

The invention further supports scalability and customization. For example, in large-scale projects involving multiple stakeholders, the system may allow different users to submit change orders simultaneously, with the controller 163 prioritizing and processing each order based on predefined criteria, such as project deadlines or budget constraints. The system may also support customization to cater to specific industry requirements, such as the integration of green building standards or advanced safety protocols.

In some embodiments, the controller 163 may additionally generate associated sub-plans that are impacted by the implementation of a change order, such as adding the slab 191. For example, when the structural design plan 190 is updated to include the new slab 191, the controller 163, operating an AI engine and/or a GAN engine, may analyze the interconnected design elements and determine whether other sub-plans, such as electrical, plumbing, or HVAC design plans, require modifications.

For example, the addition of the slab 191 may necessitate the repositioning of existing electrical wiring or the addition of new conduits to support lighting or power outlets in the newly constructed area. In such cases, the controller 163 may identify these requirements and automatically generate an updated electrical design plan as part of the associated sub-plans. This updated electrical design plan may specify the placement of new wiring, fixtures, and associated electrical components, along with a list of requirements for materials, labor, cost, and timelines.

Similarly, the controller 163 may analyze the impact of the added slab 191 on the plumbing system. For example, if the new slab overlays or intersects with existing plumbing lines, the controller 163 may determine that modifications are required to reroute or reinforce the plumbing system to accommodate the structural changes. The updated plumbing design plan generated by the controller 163 may outline these changes and include detailed requirements such as pipe materials, fittings, labor resources, and associated costs.

Furthermore, the HVAC system may also be affected by the addition of the slab 191, particularly if the new structure alters airflow patterns or creates new zones that require climate control. The controller 163 may update the HVAC design plan to account for these changes, specifying new ductwork, air vents, or temperature control systems, along with their respective requirements. For example, the updated HVAC plan may include new specifications for duct material, fan sizes, and installation labor, all of which are recalculated as updated constraints.

Each associated sub-plan generated by the controller 163 may be accompanied by a comprehensive list of requirements, which can include material specifications, labor allocation, timelines for completion, and estimated costs. These requirements may be displayed on the interactive user interface of the user devices 162, allowing contractors or clients to review and approve the proposed changes. Additionally, the controller 163 may provide automated suggestions to optimize the implementation process, such as recommending cost-effective materials or efficient scheduling for overlapping labor tasks.

In embodiments where multiple sub-plans are affected, the controller 163 may also prioritize the sequence of updates based on dependencies between the sub-plans. For example, the updated plumbing design plan may need to be executed before the electrical or HVAC modifications to prevent conflicts during construction. The controller 163 may generate a coordinated execution schedule to streamline the process and minimize disruptions.

By generating and updating associated sub-plans, the controller 163 enhances the adaptability and comprehensiveness of the system 161, facilitating that all aspects of the building design remain cohesive and compliant with the desired changes. This approach reduces the likelihood of oversight and facilitates seamless integration of changes across multiple design domains, thereby improving the efficiency and accuracy of the overall construction process.

Referring now to FIG. 2A, a given two-dimensional reference 200 may have a number of elements that an observer and/or an AI engine may classify as features 201-209 such as, for example, one or more of: exterior walls 201; interior walls 202; doorways 204; windows 203; plumbing components, such as sinks 205, toilets 206, showers 207, water closets or other water or gas related items; kitchen counters 209 and the like. The two-dimensional references 200 may also include narrative or text 208 of various kinds throughout the two-dimensional references.

Identification and characterization of various features 201-209 and/or text may be included in the input two-dimensional references. Generation of values for variables included in generating a bid may be facilitated by splitting features into groups called ‘disparate features’ 201-209 and boundary definitions and generation of a numerical value associated with the features, wherein numerical values may include one or more of: a quantity of a particular type of feature; size parameters associated with features, such as the square area of a wall or floor; complexity of features (e.g. a number of angles or curves included in a perimeter of an area; a type of hardware that may be used to construct a portion of a building, a quantity of a type of hardware that may be used to construct a portion of the building; or other variable value.

In some embodiments, a recognition step may function to replace or ignore a feature. For example, for a task goal of the result shown in FIG. 2B, features such as windows 203, and doorways, 204, may be recognized and replaced with other features consistent with exterior walls 201 or interior walls 202 (as shown in FIG. 2A). Other features may be removed, such as the text 208, the plumbing features and other internal appliances and furniture which may be shown on drawings used as input to the processing. Again, such feature recognition may be useful to accomplish other goals, but for a goal of boundary 211 definition that delineates a floorplan 210 as illustrated in FIG. 2B a pictorial representation may be purposefully devoid of such features, as illustrated.

Referring now to FIG. 2B, a boundary 211 is illustrated around a grouping of defined spaces 213-216. Spaces are areas within a boundary (which may include but are not limited to rooms, hallways, stairwells, etc.).

FIG. 2B illustrates an AI predicted boundary 211 based upon an analysis of the floorplan 210 illustrated in FIG. 2A. A transition from FIG. 2A to FIG. 2B illustrates how an AI engine successfully distinguishes between wall features and other features such as a shower 207, kitchen counter 209, toilet 206, bathroom sink 205, etc., shown in FIG. 2A.

In another aspect, in some embodiments, a boundary may include a polygon 211B. A polygon may be any shape that is consistent with a design submitted for AI analysis. For example, a rectangular polygon 211B may be based upon a wall segment 211A and have a width X 218 and a length Y 219. Boundaries that include polygons are useful, for example, in creating a three-dimensional representation of a design plan.

According to the present invention, a boundary may be represented on a user interface as one or both of: one or more line segments, and one or more polygons. In addition, a feature may be represented as a single point, a polygon, an icon, or a set of polygons. In some embodiments, a point may be placed in a centroid position for the feature and the centroid points may be counted, summarized, subtracted, averaged, or otherwise included in mathematical processes.

In some embodiments, an analytical use for a boundary may influence how a boundary is represented. For example, determination of a length of a wall section, or size of a feature may be supported via a boundary that includes a line segment. A count of feature type may be supported with a boundary that includes a single point or predefined polygon or set of polygons. Extrapolation of a two-dimensional reference into a three-dimensional representation may be supported with a boundary that includes polygons.

In one embodiment of the present invention, the AI engine is adept at analyzing a static representation of a floor plan to identify and generate a selectable array of editable components, such as walls, doors, and fixtures. These dynamic elements are then presented in an interactive user interface, where users can effortlessly select specific design elements to add annotations or to modify those elements directly. For example, a user can choose a window on the digital floor plan and opt to change its dimensions or select a wall to annotate with instructions for material specifications. The AI's analytical prowess facilitates that these selections and subsequent modifications are intelligently integrated within the overall design framework, enabling a fluid and intuitive design alteration experience that supports real-time collaboration and planning accuracy.

A scale 217 may be used to indicate a size of features included in a technical drawing included in the two-dimensional reference. As indicated above, executable software may be operative with a controller to count pixels on an image and apply a scale to a bitmapped image. Alternatively, a user may input a drawing scale for a particular image, drawing or other two-dimensional reference. Typical units referenced in a scale include inches: feet, centimeters: meters, or any other appropriate unit.

In some embodiments, a scale 217 may be determined by manually measuring a room, a component, or other empirical basis for assessing a relative size. Examples therefore include a scale included as a printed parameter on two-dimensional reference or obtained from dimensioned features in the drawing. For example, if it is known that a particular wall is thirty feet in length, a scale may be based upon a length of the wall in a particular rendition of the two-dimensional reference and proportioned according to that length.

Referring now to FIG. 2C, a user interface 220 is illustrated with multiple regions 221-224. The multiple regions 221-224 may be presented via different hatch representations or other distinguishing pattern (in some embodiments regions may also be represented as various colors etc.). During training of AI engines, and in some embodiments, when a submitted design drawing includes highly customized or unique features, a user may wish to adjust an automated identification of boundaries and automated filling of space within the boundaries.

During training of processes executed by a controller, such as those included in an AI engine made operative by the controller, and in some embodiments, when a submitted design drawing includes highly customized or unique features, an automated identification of boundaries and automated filling of space within the boundaries may be included in the interactive user interface may not be according to a particular need of a user. Therefore, in some embodiments of the present invention, an interactive user interface may be generated that presents a user with a display of one or more boundaries and pattern or color filled areas arranged as a reproduction of a two-dimensional reference input into the AI engine.

In some embodiments, the controller may generate a user interface 220 that includes indications of assigned vertices and boundaries, and one or more filled areas or regions with user changeable editing features to allow the user to modify the vertices and boundaries. For example, the user interface may enable a user to transition an element such as a vertex to a different location, change an arc of a curve, move a boundary, or change an aspect of polylines, polygons, arcs, circles, ellipses, splines, NURBS or predefined subsets of the interface. The user can thereby “correct” an assignment error made by the AI engine, or simply rearrange aspects included in the interface for a particular purpose or liking.

In some embodiments, modifications and/or corrections of this type can be documented and included in training datasets of the AI model, also in processes described in later portions of the specification.

Discrete regions may be regions associated with an estimation function. A region that is contained within a defined wall feature may be treated in different ways such as ignoring all areas within a boundary, to counting all areas within a boundary (even though regions do not include boundaries). If the AI engine counts the area, it may also make an automated decision on how to allocate the region to an adjacent region or regions that the region defines.

Referring to FIG. 2D, an exemplary user interface 230 illustrates a user interface floorplan model 231 with boundaries 236-237 between adjacent regions 233-234 with interior boundaries 236-237 that may be included in an appropriate region of a dynamic component. The AI may incorporate a hierarchy where some types of regions may be dominant over others, as described in more detail in later sections. Regions with similar dominance ranks may share space, or regions with higher dominance ranks may be automatically assigned to a boundary. In general, a dominance ranking schema will result in an area being allocated to the space with the higher dominance rank. In some embodiments, a dominance rank will allocate an area that may be used in determining an occupancy load. Moreover, in those embodiments that analyze a dynamic file (such as, for example, a Revit® compatible file) a dominance rank may be included, or added to, one or more dynamic features and be modified as the dynamic feature is modified. In some embodiments, the incorporation of a dominance rank may be instrumental in delivering automated suggestions for the revision of design plans. The dominance rank may serve as a strategic guide, steering the focus towards regions (or design elements) of higher dominance rank. For example, regions with a higher dominance rank are recommended to remain as unchanged as possible in the suggested revisions besides making sure that the revised designs of the regions comply with the best practices. The annotation process related to the selected design elements or dynamic components may also be presented based on the dominance rank of regions, dynamic components representing the regions, and the selected design elements on the design plans. This approach scrutinizes the annotations added to the regions or design elements with a higher dominance rank on the overall design, facilitating that modifications align with both regulatory requirements and the foundational elements that contribute significantly to the design's integrity.

In some embodiments, an area 235A between interior boundaries 236-237 and an exterior boundary 235 may be fully assigned to an adjacent region 232-234. An area 235A between interior boundaries 236-237 may be divided between adjacent regions 232-234 to the interior boundaries 236-237. In some embodiments, an area 235A between boundaries 236-237 may be allocated equally, or it may be allocated based upon a dominance scheme where one type of area is parametrically assessed as dominant based upon parameters such as its area, its perimeter, its exterior perimeter, its interior perimeter, and the like. Parameters may also be based upon items that are automatically counted using AI analysis of pixel patterns that identify a pattern as an item, such as, by way of non-limiting example, one or more of: doors or other paths of egress; plumbing fixtures; fixed obstacles; stairs; inclines; and declines.

In some examples, a boundary 235-237 and associated area 235A may be allocated to a region 232-234 according to an allocation schema, such as, for example, an area dominance hierarchy, to prioritize a kitchen over a bathroom, or a larger space over a smaller space. In some embodiments, user selectable parameters (e.g., a bathroom having parameters such as two showers and two sinks may be more dominant over a kitchen having parameters of a single sink with no dishwasher). These parameters may be used to determine boundary and/or area dominance. A resulting computed floorplan model may include a designation of an area associated with a region as illustrated in FIG. 2D. In various embodiments, different calculated features are included in a user interface floorplan model 231 such as features representing aspects of a wall, such as, for example, center lines, the extent of the walls, zones where doors open and the like, and these features may be displayed in selected circumstances.

Some embodiments may also include AI analysis of a dynamic file, such as a Revit or Revit compatible file and/or a raster file with patterns of dots, the AI may generate a likelihood that a region or area represented by one or both of a polygon or pattern of dots, includes a common path or dead end or an area definable for determining an occupancy load, egress capacity, travel distance and/or other factor that may influence annotation process as discussed above for FIG. 1A.

Once boundaries have been defined a variety of calculations may be made by the system. A controller may be operative to perform method steps resulting in calculation of a variable representative of a floorplan area, which in some embodiments may be performed by integrating areas between different line features that define the regions.

Alternatively, or in addition to method steps operative to calculate a value for a variable representative of an area, a controller may be operative to generate a value for element lengths, which values may also be calculated. For example, if ceiling heights are measured, presented in drawings, or otherwise determined, then volume for the room and surface area calculations for the walls may be made. There may be numerous dimensional calculations that may be made based on the different types of model output and the user-inputted calibration factors and other parameters entered by the user.

In some embodiments, a controller may be provided with two-dimensional references that include a series of architectural drawings with disparate drawings representing different elevations within a structure. A three-dimensional model may be effectively built based upon a sequenced stacking of the disparate drawings representing different levels of elevations. In other examples, the series of drawings may include cross-sectional representation as well as elevation representation. A cross-section drawing, for example, may be used to infer a common three-dimensional nature that can be attributed to the features, boundaries and areas that are extracted by the processes discussed herein. Elevation drawings may also present a structure in a three-dimensional perspective. Feature recognition processes may also be used to create three-dimensional model aspects.

Referring now to FIG. 2E, an exemplary process 240 is illustrated for marking a change order on a design plan and comparing the initial and updated construction constraints. These constraints may include factors such as labor, materials, timeline, regulatory updates, site conditions, and costs. FIG. 2E depicts an interactive user interface 240 comprising an initial design plan 240A and an updated design plan 240B, showcasing the modifications introduced by a change order.

The initial design plan 240A represents a spatial arrangement comprising a larger space 241, a bedroom 242, a washroom 243, and a main entry door 246. A user, such as a client or contractor, may wish to modify the initial design plan 240A during the construction process by marking specific changes. For example, the user may decide to add a new room within the larger space 241, which is indicated by the user marking area 244. Additionally, the user may opt to relocate the main entry door 246 by marking position 245 for removal and subsequently placing it in a new location (drag and drop) on the initial design plan 240A. These markings (244, 245) on the design plan 240A reflect the intended modifications and serve as inputs for further processing by the system.

The controller (e.g., 163) may analyze the user's markings on the initial design plan 240A and determine the feasibility and implications of the requested modifications. For example, adding a new room 241A within the larger space 241 requires an assessment of spatial allocation, structural stability, and compliance with preferred building practices. The controller may leverage embedded artificial intelligence (AI) or generative adversarial network (GAN) engines to process these inputs and generate a corresponding updated design plan 240B. In the updated design plan 240B, the new room 241A is added, and the main door 246A is relocated to a different position as specified by the user.

In one embodiment, the user may interact with the design plan 240A through various methods. For example, the user may employ a point-and-click mechanism to mark areas 244 and 245 for modification. Alternatively, a drag-and-drop functionality may enable the user to visually rearrange elements on the design plan 240A. Such interactive features enhance user convenience and precision in defining change orders. The system's user interface may also provide auxiliary tools, such as measurement indicators, to assist the user in marking accurate dimensions for the new room 241A or the relocated main door 246A.

The controller 163 processes the user's inputs and evaluates how the proposed changes affect associated construction constraints. For example, creating the new room 241A may necessitate additional labor for constructing walls, installing doors, and implementing electrical and plumbing systems. Similarly, relocating the main door 246A may involve recalculating material requirements for door frames, hinges, and related hardware. The controller may also assess regulatory compliance to determine whether the new spatial configuration aligns with applicable building practices and safety standards.

In some embodiments, the system may provide automated feedback to the user regarding the proposed modifications. For example, if the addition of the new room 241A reduces the available ventilation in the larger space 241, the controller may suggest incorporating additional windows or ventilation ducts. Similarly, if relocating the main door 246A affects the structural integrity of adjacent walls, the controller may recommend reinforcing those walls or redistributing load-bearing elements.

The updated design plan 240B, generated by the controller, serves as a refined version of the initial design plan 240A, incorporating the requested changes. The new room 241A is depicted within the larger space 241, and the relocated main door 246A is shown in its new position. These updates are visually distinguished from the original design elements, enabling users to clearly identify the modifications. The system may utilize color codes, annotations, or graphical indicators to highlight the changes, providing an intuitive representation of the updated design plan.

In addition to visual updates, the system may generate a detailed comparison of the initial and updated construction constraints. For example, the system may produce a tabular report outlining the changes in labor requirements, material quantities, and associated costs. For the new room 241A, the table may specify the number of additional labor hours required for tasks such as framing, drywall installation, and painting. Similarly, for the relocated main door 246A, the table may detail the materials needed for the new door frame, locks, and finishing work.

The system's analysis may extend beyond immediate construction constraints to include downstream impacts. For example, the addition of the new room 241A may alter the building's electrical layout, necessitating updates to wiring diagrams and circuit load calculations. Similarly, relocating the main door 246A may affect the flow of foot traffic within the building, prompting adjustments to corridor widths or furniture placement. The controller 163 may consider these secondary effects and provide corresponding recommendations or design updates.

The user interface 240 may further facilitate collaboration among multiple stakeholders involved in the construction process. For example, the system may enable the user to share the updated design plan 240B with architects, engineers, or contractors for review and approval. Notifications or alerts may be generated to inform stakeholders of the proposed changes and their implications. Stakeholders may provide feedback or request additional modifications, which can be incorporated into subsequent iterations of the design plan.

In another embodiment, the system may integrate with external databases or regulatory agencies to validate the updated design plan 240B. For example, the controller may query a database of local building codes to verify that the new room 241A and the relocated main door 246A comply with legal requirements. If discrepancies are identified, the system may suggest alternative configurations or request approval from the relevant authorities.

The system's ability to dynamically update and compare construction constraints enhances decision-making and project efficiency. By providing real-time feedback and generating detailed analyses, the system empowers users to make informed choices regarding design modifications. This process minimizes the risk of errors or delays, facilitating that the final construction aligns with the user's requirements and expectations.

For example, the controller (e.g., 163) may generate a first table 247 and a second table 248 on the interactive user interface. The first table 247 displays initial construction constraints 247A-247G associated with the initial design plan 240A, while the second table 248 displays updated construction constraints 248A-248G generated after processing a change order, such as adding a new room 241A or relocating the main door 246A.

The first table 247 includes fields such as “Plan Modification” 247A, “Regulatory Updates” 247B, “Ideal Labor Constraints” 247C, “Material Substitutions” 247D, “Parties Preferences” 247E, “Site Condition and Possibilities” 247F, and “Cost Constraints” 247G. Each of these fields provides baseline data, allowing the user (e.g., a contractor, architect, or client) to understand the construction constraints before any changes are introduced. For example, “Ideal Labor Constraints” 247C may represent the initial estimate of the labor force required, such as ten workers, while “Cost Constraints” 247G may show an initial budget allocation of $100K.

Similarly, the second table 248 reflects the updated construction constraints after incorporating the proposed changes. For example, “Plan Modified” 248A may indicate whether the design plan was altered to include a new room 241A or relocate the main door 246A. “Updated Regulatory” 248B may indicate compliance with updated building codes or zoning regulations. The updated “Actual Labor Constraints” 248C may reflect the increased number of workers, such as 15, required to accommodate the change. Likewise, the “Cost Constraints” 248G may reflect a new budget, such as $110K, accounting for additional materials, labor, or time.

The inclusion of the first table 247 and the second table 248 side-by-side enables the user to perform a direct comparison between the initial and updated construction constraints. This comparative view is highly beneficial for evaluating the impact of a change order on the overall construction process. For example, a user may assess whether the proposed changes significantly increase the project's cost, require additional labor, or impact timelines.

Each construction constraint, whether in the first table 247 or the second table 248, may also include an interactive option 249 to review the constraint in greater detail. For example, clicking on “Material Substitutions” 247D/248D may open a detailed breakdown of the materials required before and after the change order. This feature allows the user to view specific material lists, quantities, and associated costs, which may help in procurement planning. Similarly, selecting “Labor Constraints” 247C/248C may provide insights into the types of labor required, hourly rates, and estimated total man-hours.

The interactive review option 249 also serves as a tool for identifying specific areas of impact due to the change order. For example, reviewing “Regulatory Updates” 247B/248B may reveal whether the proposed changes comply with new safety codes, fire regulations, or accessibility standards. This capability is particularly useful in large-scale projects where multiple regulatory bodies and constraints must be accounted for.

By offering detailed, interactive views of both initial and updated construction constraints, the system aids users in making informed decisions about whether to approve, modify, or reject a change order. For example, if the “Cost Constraints” 247G/248G reveal a budget increase beyond acceptable limits, the user may decide to revisit the change order and explore alternative solutions, such as reducing the size of the added room 241A or using alternative materials.

Additionally, the comparative view of tables 247 and 248 helps stakeholders identify areas where efficiencies may be gained. For example, by analyzing “Site Condition and Possibilities”247F/248F, the user may determine whether existing site conditions support the proposed changes without significant excavation or structural adjustments. This analysis may lead to cost savings or a streamlined construction process.

The tables 247-248 may also integrate feedback mechanisms for collaborative decision-making. For example, the “Parties Preferences” 247E/248E fields may include comments or approvals from different stakeholders, such as contractors, clients, or regulatory authorities. This facilitates that all relevant parties are informed about the implications of the change order and can contribute to the decision-making process.

In some embodiments, the tables 247 and 248 may include visual indicators, such as color-coded fields, to highlight significant changes or deviations. For example, a red highlight in “Cost Constraints” 248G may indicate a budget increase exceeding a predefined threshold, prompting the user to review the change order more closely.

Furthermore, the system may allow users to simulate multiple scenarios by modifying the change order and observing how the updated construction constraints in table 248 respond to these modifications. For example, reducing the size of the new room 241A may lower the “Cost Constraints” 248G and “Actual Labor Constraints” 248C, helping the user identify a more feasible solution.

Referring now to FIG. 2F, the exemplary user interface 240 is illustrated for accessing detailed information about updated construction constraints following the change order in accordance with FIG. 2E. The user interface 240 displays an updated design plan 240B, which incorporates the addition of a new room 241A and highlights the change using a change indicator 250. The change indicator 250 serves as an interactive marker that, when selected or clicked by the user, reveals the second table 248 of updated construction constraints 248A-248G, enabling the user to analyze the impact of the change order at multiple levels of granularity.

The second table 248 comprises fields representing various updated construction constraints, such as “Modified Design Plans” 248A, “Updated Regulatory” 248B, “Actual Labor Constraints” 248C, “Substituted Materials” 248D, “Parties Approval” 248E, “Site Conditions and Possibilities” 248F, and “Cost Constraints” 248G. Each field is associated with an expandable drop-down option 249A-249G, allowing the user to delve deeper into specific constraints and their respective details. For example, by accessing the drop-down option 249A associated with “Modified Design Plans” 248A, the user can view information regarding updates to architectural layouts, electrical schematics, plumbing blueprints, or HVAC systems that may have been modified due to the addition of the new room 241A.

The “Modified Design Plans” 248A field, accessible via drop-down option 249A, may include detailed sub-plans generated or adjusted by the controller 163 to reflect the structural and functional modifications necessitated by the change order. For example, adding the new room 241A may require extending electrical wiring plans to accommodate additional outlets, light fixtures, or switches. Similarly, the plumbing plan may need modifications to include additional pipelines or water fixtures if the new room 241A includes a bathroom or washbasin. Likewise, the HVAC system may need to be reconfigured to add ducts, vents, or air-conditioning units to provide adequate ventilation or temperature control within the newly added space. The information accessed through drop-down option 249A thus enables users to comprehensively review all associated sub-design plans, facilitating complete visibility into how the modified design aligns with the updated constraints.

Similarly, the user may explore the “Actual Labor Constraints” 248C field by selecting drop-down option 249C, which opens a first drop-down window 251. This window may display specific details regarding the labor force adjustments necessitated by the change order. For example, the addition of the new room 241A may require hiring additional workers, such as masons, electricians, plumbers, or HVAC technicians, depending on the scope of the modification. The first drop-down window 251 may further provide data regarding hourly labor rates, estimated man-hours for each type of worker, and the total projected labor cost for implementing the change. In one embodiment, this labor information may also include scheduling details, such as availability of workers and their assigned shifts, enabling efficient resource allocation and timeline adjustments.

In another example, the user may access detailed information about “Cost Constraints” 248G by interacting with drop-down option 249G, which reveals a second drop-down window 252. This window provides an itemized breakdown of the updated cost estimates associated with the change order. For example, the cost breakdown may include categories such as materials (e.g., bricks, cement, tiles, wiring, and ductwork), labor expenses (e.g., wages for masons, electricians, plumbers, or HVAC installers), equipment rentals, and contingency reserves for unforeseen expenses. Additionally, the second drop-down window 252 may include comparative cost data, enabling the user to analyze how the new room 241A impacts the overall project budget compared to the original design plan.

The ability to review each construction constraint in detail using the drop-down options 249A-249G may be particularly beneficial for identifying and addressing potential challenges associated with the change order. For example, reviewing “Updated Regulatory” 248B may reveal compliance requirements related to building codes, fire safety, accessibility standards, or environmental regulations that were not applicable to the original design plan. This information enables the user to evaluate whether additional permits or approvals are required before proceeding with the modification.

The user interface 240 also facilitates collaborative decision-making by providing stakeholders with access to detailed, real-time information about the updated construction constraints. For example, contractors, clients, architects, and regulatory authorities can review the changes and provide feedback or approvals directly within the system. This collaborative approach enhances transparency and minimizes miscommunication, so that all parties are aligned with the project goals and constraints.

The integration of change indicators such as 250 within the updated design plan 240B further simplifies the navigation and review process. Users can quickly locate the specific areas affected by the change order and access the corresponding updated constraints in the second table 248. For example, clicking on change indicator 250 near the newly added room 241A may directly open the drop-down options related to “Modified Design Plans” 248A, “Actual Labor Constraints” 248C, or “Cost Constraints” 248G, saving time and improving usability.

In some embodiments, the system may also provide advanced analytics and simulation capabilities within the user interface 240. For example, the user may modify certain parameters within the updated construction constraints, such as labor rates or material costs, and observe the corresponding impact on the project timeline or budget. This simulation capability allows users to explore alternative scenarios and make informed decisions about the change order.

By offering a detailed, interactive interface for reviewing updated construction constraints, FIG. 2F demonstrates a highly efficient and user-friendly approach to managing change orders in construction projects. The combination of updated design plans, detailed tables of constraints, and interactive drop-down options so that users have access to all the information needed to successfully implement and evaluate the impact of a change order. This level of granularity and interactivity enhances the overall efficiency, accuracy, and transparency of the construction management process.

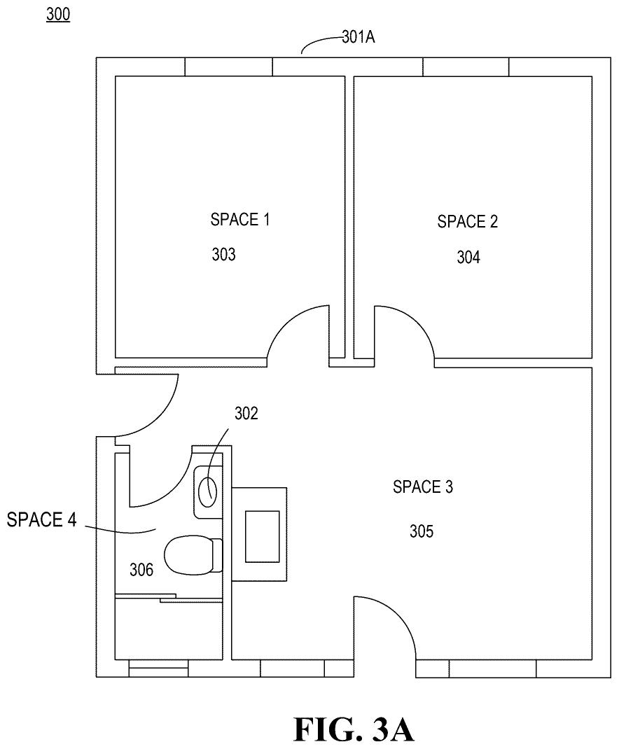

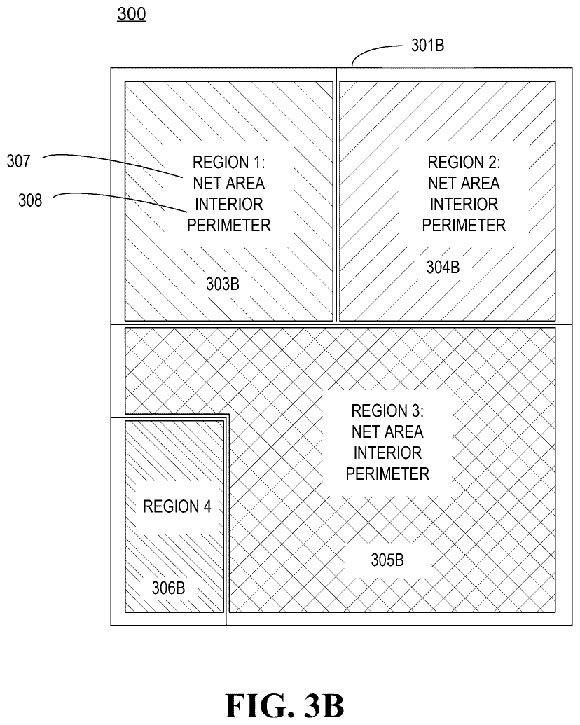

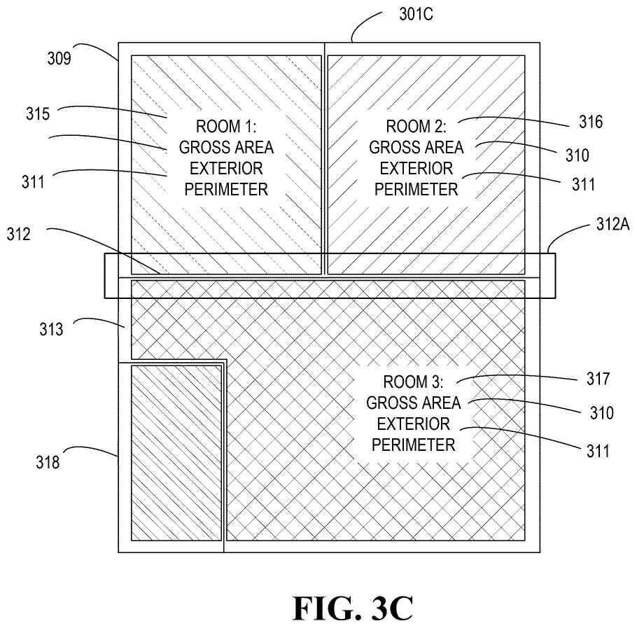

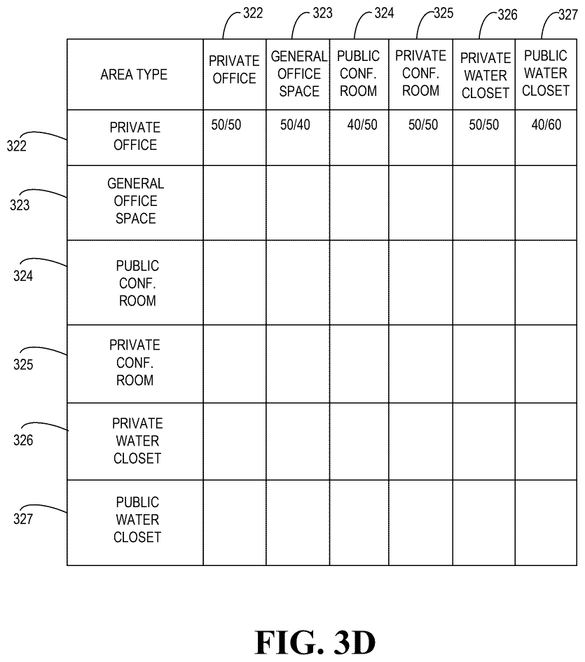

Referring now to FIGS. 3A-3C a user interface 300 may generate multiple different user views, each view has different aspects related to the two-dimensional reference drawing inputted. For example, referring now to FIG. 3A, a user interface 300 with a replication view 301A may include replication of an original floor plan represented by a two-dimensional reference, without any controller-added features, vectors, lines, or polygons integrated or overlaid into the floorplan. The replication view 301A includes various spaces 303-306 that are undefined in the replication view 301A but may be defined during the processes described herein. For example, some or all of a space 303-306 may correlate to a region in a region view 301B.

The replication view 301A, may also include one or more fixtures 302. A rasterized version (or pixel version) of the fixtures 302 may be identified via an AI engine. If a pattern is present that is not identified as a fixture 302, a user may train the AI engine to recognize the pattern as a fixture of a particular type. The controller may generate a tally of multiple fixtures 302 identified in the two-dimensional reference. The tally of multiple fixtures 302 may include some or all of the fixtures identified in the two-dimensional reference and may be used to generate an estimate for completion of a project illustrated by, or otherwise represented by, the two-dimensional reference.

Referring now to FIG. 3B, in the user interface 300 a user may specify to a controller that one of multiple views available is to be presented via the interface. For example, a user may designate via an interactive portion of a screen displaying the user interface 300 that a region view 301B be presented. The region view 301B may identify one or more regions and/or spaces 303B-306B identified via processing by a controller, such as, for example, via an AI engine running on the controller. The region view 301B may include information about one or more regions 303-306 delineated in the region view 301B of the user interface 300. For example, the controller may automatically generate and/or display information descriptive of one or more of: user displays, printouts or summary reports showing a net interior area 307 (e.g., a calculation of square footage available to an occupant of a region), an interior perimeter 308, a type of use a region 303B-306B will be deployed for, or a particular material to be used in the region 303B-306B. For example, Region 4 306B may be designated for use as a bathroom; and flooring and wallboard associated with Region 4 may be designated as needing to be waterproof material.

Referring now to FIG. 3C a gross area region view 301C and 309 is illustrated. As illustrated in FIG. 3B, a user interface may include interactive devices for display of additional parameters, such as, for example, one or more of: a net interior area 307 may generate a designation of a value that is in contrast to a gross area 310 and exterior perimeter 311. The selection of gross area 310 may be more useful to a proprietor charging for a leased space but may be less useful to an occupant than a net interior area 307 and interior perimeter 308. One or more of the net interior areas 307, interior perimeter 308 gross area 310 and exterior perimeter 311 may be calculated based upon analysis by an AI engine of a two-dimensional reference.

In addition, a height for a region may also be made available to the controller and/or an AI engine, then the controller may generate a net interior volume and vertical wall surface areas (interior and/or exterior).

In some embodiments, an output, such as a user interface of a computing device, smart device, tablet and the like, or a printout or other hardcopy, may illustrate one or both of: a gross area 310 and/or an exterior perimeter 311. Either output may include automatically populated information, such as the gross area of one or more rooms (based upon the above boundary computations) or exterior perimeters of one or more rooms.

In some embodiments, the present invention calculates an area bounded within a series of polygon elements (such as, for example, using mathematical principals or via pixel counting processes), and/or line segments.

In some embodiments, in an area of a bounded by lines intersecting at vertices, the vertices may be ordered such that they proceed in a single direction such as clockwise around the bounded area. The area may then be determined by cycling through the list of vertices and calculating an area between two points as the area of a rectangle between the lower coordinate point and an associated axis and the area of the triangle between the two points. When a path around the vertices reverses direction, the area calculations may be performed in the same manner, but the resulting area is subtracted from the total until the original vertex is reached. Other numerical methods may be employed to calculate areas, perimeters, volumes, and the like.

These views may be used in generating estimation analysis documents. Estimation analysis documents may rely on fixtures, region area, or other details. By assisting in generating net area, estimation documents may be generated more accurately and quickly than is possible through human-engendered estimation parameters.

With reference now again to FIGS. 3B and 3C, regions 303B-306B defined by an AI engine may include one or more Rooms in FIG. 3B subsequently have regions assigned as “Rooms” in FIG. 3C.

Referring now to FIG. 3D, a table is illustrated containing hierarchical relationships between area types 322-327 that may be defined in and/or by an AI engine and/or via the user interface. The area types 322-327 may be associated with dominance relationship values in relation to adjacent areas. For example, a border region 312-313 (as illustrated in FIG. 3C) will have an area associated with it. According to the present invention, an area 315-318 associated with the border region 312-313 may have an area type 322-327 associated with the area 315-318. An area 312A included in the border region 312-313 may be allocated according to a ratio based upon a dominance ranking of one feature as compared to another feature, which may be represented as a hierarchical relationship between the features, such as, for example, adjacent areas (e.g., area 315 and area 317 or area 317 and area 318), the hierarchical relationship may be used to generate a dominance ranking of one area over another area, or to ascertain factors useful in one or both of: annotating a design element or modifying a design element. For example, a dominance ranking may allocate space used to calculate one or more of: an occupancy load; a width and/or area of an egress path; a width and/or area of a common path; a length of a dead-end; egress capacity; and travel distance from a furthest point. In this context, regions assigned a higher dominance ranking are designated to be inherently associated with elevated safety standards.

Some embodiments of the present invention allocate one or more areas according to a user input (wherein the user input may be programmed to override and automated hierarchical relationship or be subservient to the automated hierarchical relationship). For example, as indicated in the table, a private office located adjacent to a private office may have an area in a border region split between the two adjacent areas in a 50/50 ratio, but a private office adjacent to a general office space may be allocated 60 percent of an area included in a border region, and so on.

Dominance associated with various areas or regions may be systemic throughout a project, according to customer preference, indicated on a two-dimensional reference by two-dimensional reference basis or another defined basis.

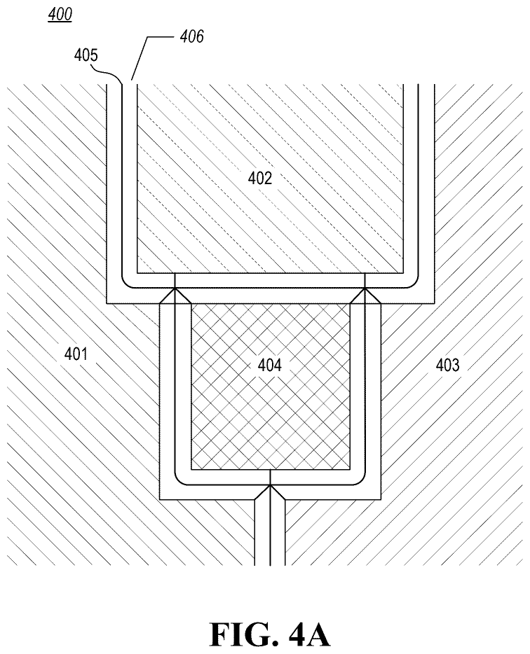

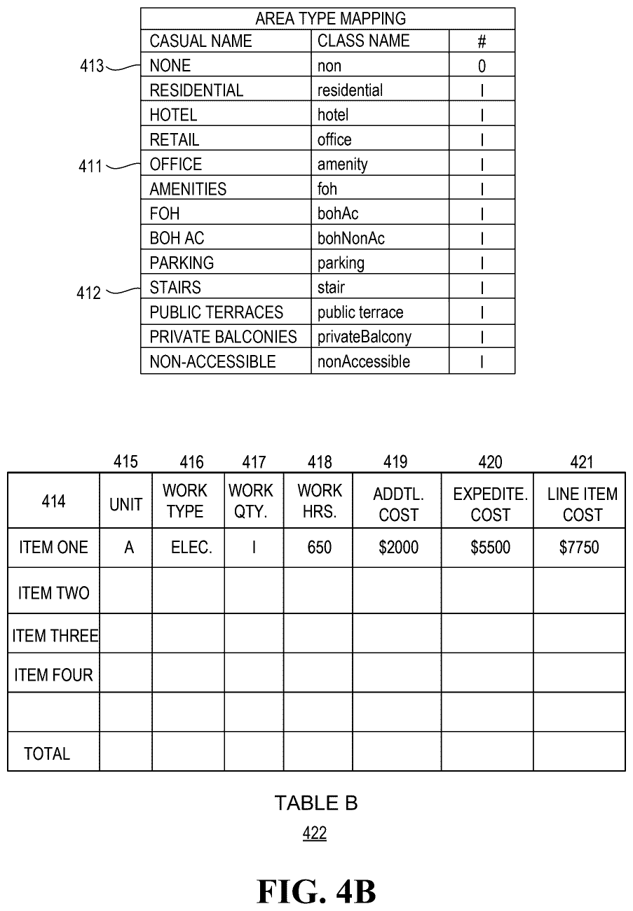

Referring now to FIG. 4A, an exemplary user interface 400 may include boundaries (which, as discussed above, may include one or more of: line segments, polygons, and icons) and regions overlaid on aspects included in a two-dimensional reference is illustrated. A defined space within a boundary (sometimes referred to as a region or area) may include an entire area within perimeters of a structure.

For example, a controller running an AI engine may determine locations of boundaries, edges, and inflections of neighboring and/or adjacent areas 401-404. There may be portions of boundary regions 405 and 406 that are initially not associated with an adjacent area 401-404. The controller may be operative via executing software in the AI engine to determine the nature of respective adjacent areas 401-404 on either side of a boundary, and apply a dominance-based ranking upon an area type, or an allocation of respective areas 401-404. Different classes or types of spaces or areas may be scored to be equal to, dominant (e.g., above) others or subservient (e.g., below) others.

Referring now to FIG. 4B, an exemplary table A indicating classes of space types and their associated ranks 411-413. In some embodiments, a controller may be operative via execution of software to determine relative ranks associated with a region on one or either side of a boundary. For example, area 402 may represent office space and area 404 may represent a stairwell. An associated rank lookup value for office space may be found at rank 411, and the associated rank lookup value for stairwells may be found at rank 413. Since the rank 412 of stairwells may be higher, or dominant, over the rank 411 of office space then the boundary space may be associated with the dominant stairs 412 or stairwell space. In some embodiments, a dominant rank may be allocated to an entirety of boundary space at an interface region. In other examples, more complicated allocations may be made where the dominant rank may get a larger share of boundary space than another rank allocated by some functional relationship. In still other examples (Table B), controller may execute logical code to be operative to assign pre-established work costs to elements identified within boundaries.

In some embodiments, a boundary region may transition from one set of interface neighbors to a different set. For example, again in FIG. 4A, a boundary 405 between office region 402 and stairwell 404 may transition to a boundary region between office region 402 and unallocated space 403. The unallocated space may have a rank associated with the unallocated space 403 that is dominant. Accordingly, the nature of allocated boundary space 405 may change at such transitions where one space may receive allocation of boundary space in one pairing and not in a neighboring region. The allocation of the boundary space 405 may support numerous downstream functionalities and provide an input to various application programs. Summary reports may be generated and/or included in an interface based upon a result after incorporation of assignment of boundary areas.

In another aspect, in FIG. 4B, a table 422 illustrates fields 414 that may have variable values 415-421 designated by an AI engine or other process run by a controller based upon the two-dimensional reference, such as a floor plan, design plan or architectural blueprint. For example, as illustrated, variables 415-421 may include a unit 415, a work type 416, work quantity 417, work hours 418, additional cost 419, expedite cost 420, and line-item cost 421. In some embodiments, the variables 415-421 may include aspects that may affect one or more of: one or both of: annotating a design element, modifying a design element, or modifying a physical version of the design element. In other embodiments, the variables 415-421 may include design considerations for the fields 414.

The determination of boundary definitions for a given inputted design plan, which may be a single drawing or set of drawings or other image, has many important uses and aspects as has been described. However, it can also be important for a supporting process executed by a controller, such as an AI algorithm to take boundary definitions and area definitions and generate classifications of a space. As mentioned, this can be important to support processes executed by a controller that assigns boundary areas based on dominance of these classifications.

Classification of areas can also be important for further aggregations of space. In a non-limiting example, accurate automatic classification of room spaces may allow for a combination of all interior spaces to be made and presented to a user. Overlays and boundary displays can accordingly be displayed for such aggregations. There may be numerous functionalities and purposes for automatic classification of regions from an input drawing.

An AI engine or other process executed by a controller may be refined, trained, or otherwise instructed to utilize a number of recognized characteristics to accomplish area classification. For example, an AI engine may base predictions for a type “/”category” of a region with a starting point of the determination that a region exists from the previous predictions by the segmentation engine.

In some embodiments, a type may be inferred from text located on an input drawing or other two-dimensional reference. An AI engine may utilize a combination of factors to classify a region, but it may be clear that the context of recognized text may provide direct evidence upon which to infer a decision. For example, a recognized textual comment in a region may directly identify the space as a bedroom, which may allow the AI engine to make a set of hierarchical assignments to space and neighboring spaces, such as adjoining bathrooms, closets, and the like.

Classification may also be influenced by, and use, a geometric shape of a predicted region. Common shapes of certain spaces may allow a training set to train a relevant AI engine to classify a space with added accuracy. Furthermore, certain space classes may typically fall into ranges of areas which also may aid in the identification of a region's class. Accordingly, it may be important to influence the makeup of training sets for classification that contain common examples of various classes as well as common variations on that theme.

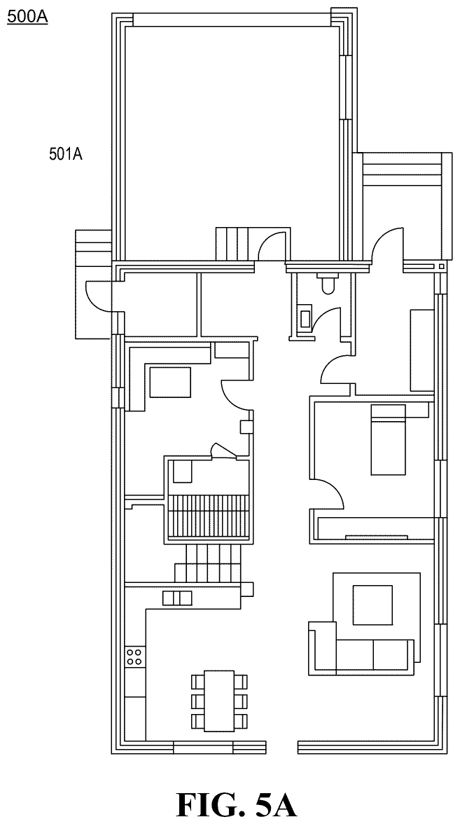

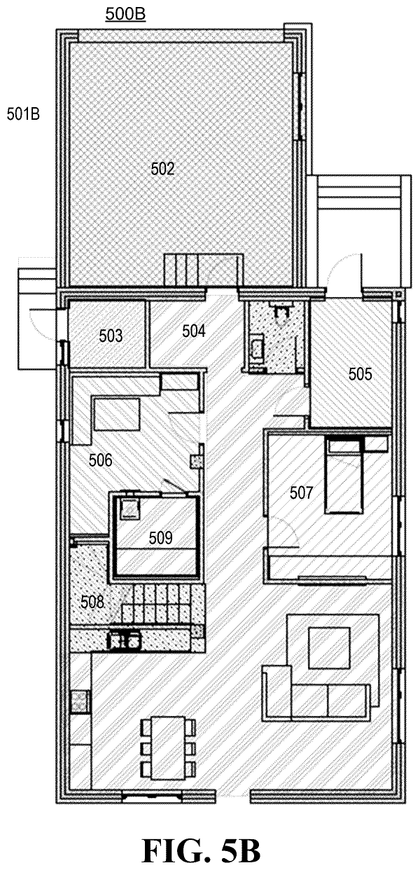

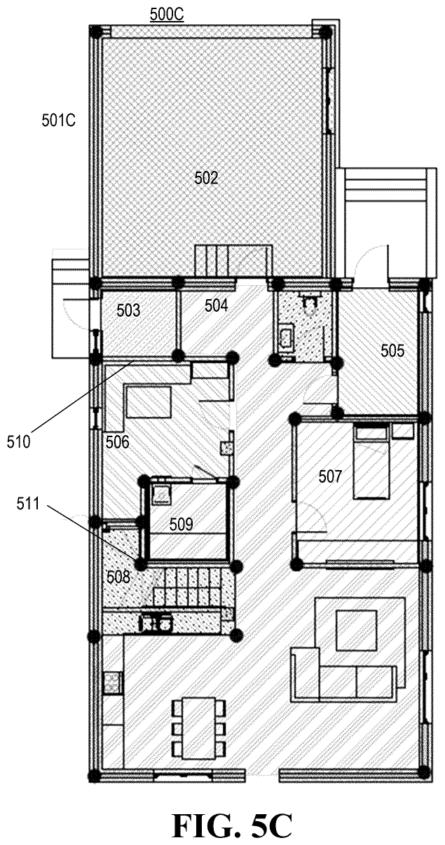

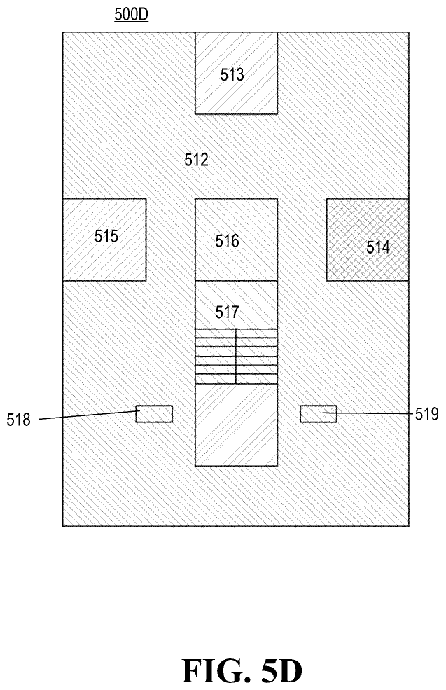

Referring now to FIGS. 5A-5D, a progressive series of outputs that may be included in various user interfaces are illustrated and provide examples of a recognition process that may be implemented in some embodiments of the present invention. Referring now to FIG. 5A, a relatively complex drawing of a floorplan may be input as a design plan 501A into a controller running an AI engine. The two-dimensional reference 501 may be included in an initial user interface 500A.

An AI engine based automated recognition process executes method steps via a controller, such as a cloud server, and identifies multiple disparate regions 502-509. Designation of the regions 502-509 may be integrated according to a shape and scale of the two-dimensional reference and presented as a region view 501B user interface 500B, with symbolic hatches or colors, etc., as shown in FIG. 5B.

The region view 501B may include the multiple regions 502-509 identified by the AI engine arranged based upon a size and shape and relative position derived from the two-dimensional reference 501.

Referring now to FIG. 5C, a line segment view 501C may include identified boundary line segments 510 and vertices 511 may also be presented as an overlay of the regions 502-509 illustrated as delineated symbolic hatches or colors etc., as illustrated in FIG. 5C. Said line segments 510 may also be represented as symbols such as but not limited to dots. Such an interactive user interface 500C may allow a user to review and correct assignments in some cases. A component of the AI engine may further be trained to recognize aggregations of regions 502-509 spaces, or areas, such as in a non-limiting sense the aggregation of internal regions 502-509, spaces or areas.

Referring now to FIG. 5D, an illustration of exemplary aggregation of regions 512-519 is provided where a user interface 500D includes patterned portions 512-519 and the patterned portions 512-519 may be representative of regions, spaces, or areas, such as, for example, aggregated interior living spaces.

In some embodiments, integrated and/or overlaid aggregations of some or all: of regions; spaces; patterned portions; line segments; polygons; symbols; icons or other portions of the user interfaces may be assembled and presented in a user output and our user interface, or as input into another automated process. In some embodiments, selection or marking of the desired segments or design elements may be incorporated on the user interfaces 500A-500D as shown in FIGS. 5A-5D.

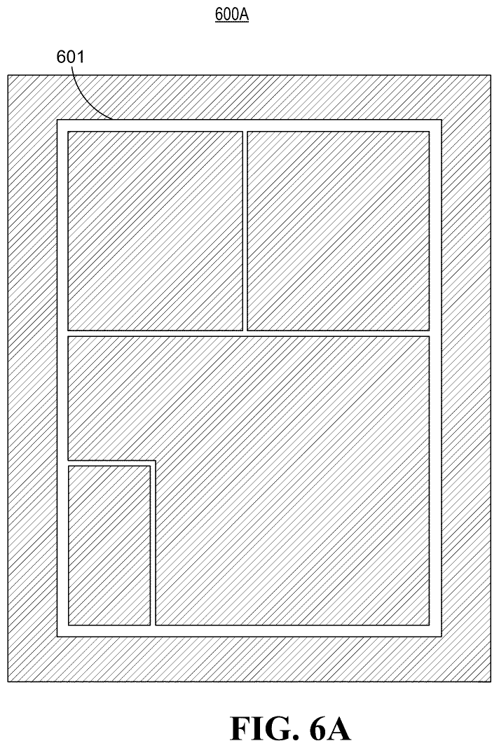

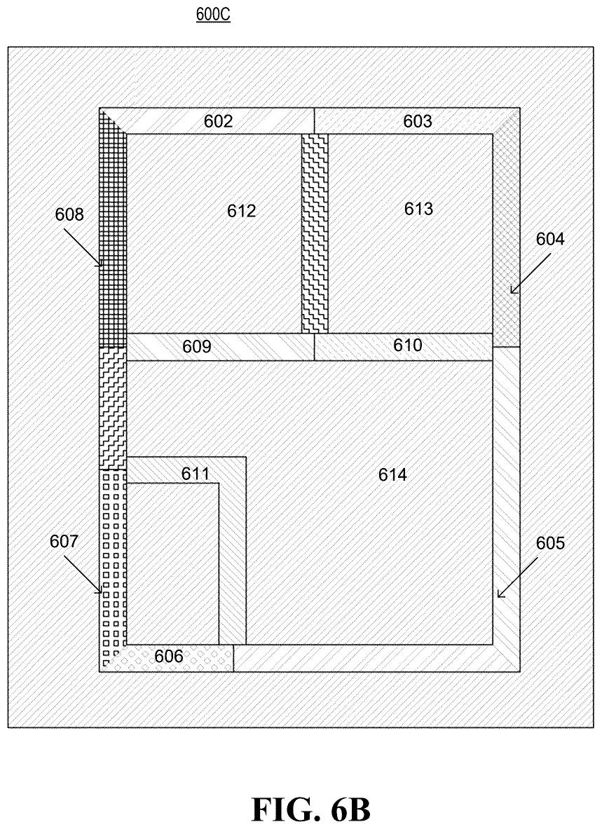

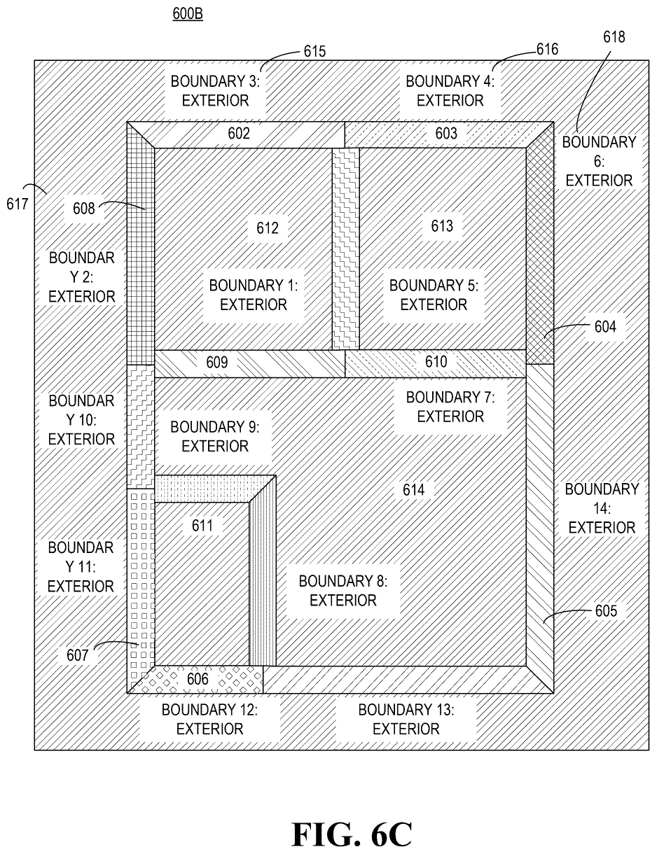

Referring now to FIGS. 6A-6C, in some embodiments, automated and/or user-initiated processes may include refinement of regions, spaces, or areas may involve one or both of a user and a controller identifying individual wall segments 211A from previously defined boundaries.

For example, in some embodiments, a controller running an AI engine may execute processes that are operative to divide a previously predicted boundary into individual wall segments. In FIG. 6A, a user interface 600A includes a representation of a design plan with an original boundary 601 defined from an inputted design.

In FIG. 6B, an AI engine may be operative to take one or more original boundaries 601 and isolate one or more individual line segments 602-611 as shown by different hatching symbols in an illustrated user interface 600B. The identification of individual line segments 602-611 of a boundary 601 enables one or both of a controller and a user to assign and/or retrieve information about the individual line segment 602-611 such as, for example, one or more of: the length of the segment 602-611, a type of wall segment 211A, materials used in the wall segment 211A, parameters of the segment 602-611, height of the segment 602-611, width of the segment 602-611, allocation of the segment 602-611 to a region 612-614 or another, and almost any digital content relevant to the segment.

Referring now to FIG. 6C, in some embodiments, a controller executing an AI engine or other method steps, may be operative, in some embodiments, to classify individual line segments 602-611 of a boundary 601 and present a user interface 600C indicating the classified individual line segments 602-611. The AI engine may be trained, and subsequently operative, to classify individual line segments 602-611 included in a boundary 601 in different classes. As a non-limiting example, an AI engine may classify walls as interior walls, exterior walls and/or demising walls that separate internal spaces.

As illustrated in FIG. 6C, in some embodiments, an individual line segment 602-611 may be classified by the AI engine and an indication of the classification 615-618, such as alphanumeric or symbolic content, may be associated with the individual line segment 602-611 and presented in the user interface 600C.

In some embodiments, functionality may be allocated to classified individual line segments 602-611, such as, by way of non-limiting example, a process that generates an estimated materials list for a region or an area defined by a boundary, based on the regions or area's characteristics and its classification. In some embodiments, selection or marking of the desired segments or design elements may be incorporated on the user interfaces 600A-600C as shown in FIGS. 6A-6C.

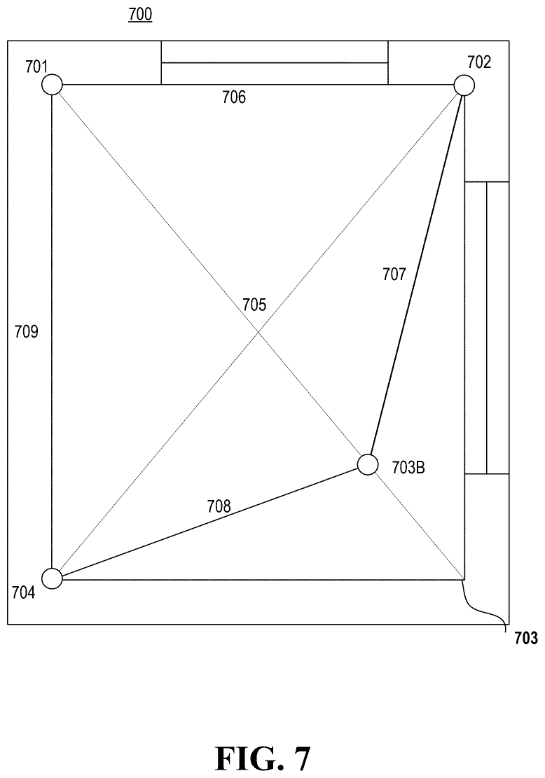

Referring now to FIG. 7, in some embodiments, a user interface 700 may include user interactive controls operative to execute process steps described herein (e.g. make a boundary determination, region classification, segmentation decision or the like) in an automated process (e.g. via an AI routine) and also be able to receive an instruction (e.g. from a user via a user interface, or a controller operative via executable software to perform a process) that modify one or more boundary segments.

For example, a user interface may include one or more vertex 701-704 (e.g., points where two or more line segments meet) that may be user interactive such that a user may position the one or more vertex 701-704 at a user selected position. User positioning may include, for example, user drag and drop of the one or more vertex 701-704 at a desired location or entering a desired position, such as via coordinates. A new position for a vertex 703B may allow an area 705 bounded by user defined boundaries 706-709 User interactive portions of a user interface 700 are not limited to vertex 701-704 and can be any other item 701-709 in the user interface 700 that may facilitate achievement of a purpose by allowing one or both of: the user, and the controller, to control dynamic sizing and/or placement of a feature or other item 701-709.

Still further, in some embodiments, user interaction involving positioning of a vertex 701-704 or modification of an item 705-709 may be used to train an AI engine to improve performance. Additionally, in some embodiments, user interaction involving positioning of a vertex 701-704 may comprise selection of a desired segment or design element in a design plan by marking and combining a plurality of vertex points similar to vertex 701-704.

An important aspect of the operation of the systems as have been described is the training of the AI engines that perform the functions as have been defined. A training dataset may involve a set of input drawings associated with a corresponding set of verified outputs. In some embodiments, a historical database of drawings may be analyzed by personnel with expertise in the field. user, including in some embodiments experts in a particular field of endeavor may manipulate dynamic features of a design plan or other aspects of a user interface to be used to train an AI engine, such as by creating or adding to an AI referenced database.

In some other examples, a trained version of an AI engine may produce user interfaces and/or other outputs based on the trained version of the AI engine. Teams of experts may review the results of the AI processing and make corrections as required. Corrected drawings may be provided to the AI engine for renewed training.

Aspects that are determined by a controller running an AI engine to be represented in a design plan may be used to generate an estimate of what will be required to complete a project. For example, according to various embodiments of the present invention, an AI engine may receive as input a two-dimensional reference and generate one or more of: boundaries, areas, fixtures, architectural components, perimeters, linear lengths, distances, volumes, and the like may be determined by a controller running an AI engine to be required to be required to complete a project.

For example, a derived area or region comprising a room and/or a boundary, perimeter or other beginning and end indicator may allow for a building estimate that may integrate choices of materials with associated raw materials costs and with labor estimates all scaled with the derived parameters. The boundary determination function may be integrated with other standard construction estimation software and feed its calculated parameters through APIs. In other examples, the boundary determination function may be supplemented with the equivalent functions of construction estimation to directly provide parametric input to an estimation function. For example, the parameters derived by the boundary determinations may result in estimation of needed quantities like cement, lumber, steel, wallboard, floor treatments, carpeting, and the like. Associated labor estimates may also be calculated.

As described herein, a controller executing an AI engine may be functional to perform pattern recognition and recognize features or other aspects that are present within an input two-dimensional reference or other graphic design. In a segmentation phase used to determine boundaries of regions or other space features, aspects that are recognized as some artifact other than a boundary may be replaced or deleted from the image. An AI engine and/or user modified resulting boundary determination can be used in additional pattern recognition processing to facilitate accurate recognition of the non-wall features present in the graphic.

For example, in some embodiments, a set of architectural drawings may include many elements depicted such as, by way of non-limiting example, one or more of: windows, exterior doors, interior doors, hallways, elevators, stairs, electrical outlets, wiring paths, floor treatments, lighting, appliances, and the like. In some two-dimensional references, furniture, desks, beds, and the like may be depicted in designated spaces. AI pattern recognition capabilities can also be trained to recognize each of these features and many other such features commonly included in design drawings. In some embodiments, a list of all the recognized image features may be created and also used in the cost estimation protocols as have been described.

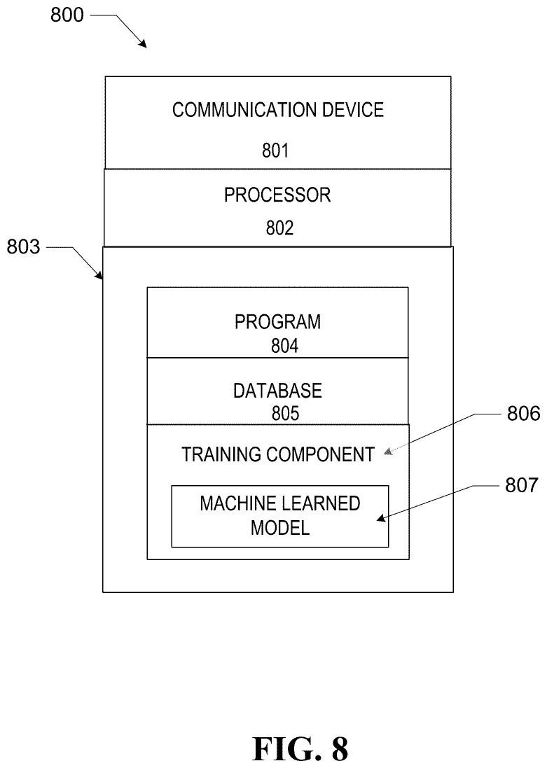

Referring now to FIG. 8 an automated controller is illustrated that may be used to implement various aspects of the present disclosure, in various embodiments, and for various aspects of the present disclosure, controller 800 may be included in one or more of: a wireless tablet or handheld device, a server, a rack mounted processor unit. The controller may be included in one or more of the apparatuses described above, such as a Server, and a Network Access Device. The controller 800 includes a processor unit 802, such as one or more semiconductor-based processors, coupled to a communication device 801 configured to communicate via a communication network (not shown in FIG. 8). The communication device 801 may be used to communicate, for example, with one or more online devices, such as a personal computer, laptop, or a handheld device.

The processor 802 is also in communication with a storage device 803. The storage device 803 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

The storage device 803 can store a software program 804 with executable logic for controlling the processor 802. The processor 802 performs instructions of the software program 804 and thereby operates in accordance with the present disclosure. In some embodiments, the processor may be supplemented with a specialized processor for AI related processing. The processor 802 may also cause the communication device 801 to transmit information, including, in some instances, control commands to operate apparatus to implement the processes described above. The storage device 803 can additionally store related data in a database 805. The processor and storage devices may access an AI training component 806 and database, as needed which may also include storage of machine-learned models 807.

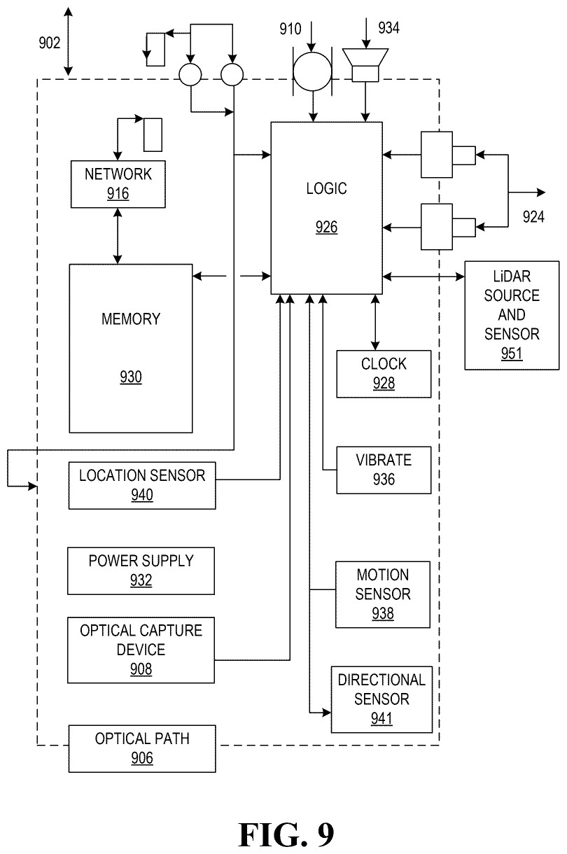

Referring now to FIG. 9, a block diagram of an exemplary mobile device 902 is illustrated. The mobile device 902 comprises an optical capture device 908 to capture an image and convert it to machine-compatible data, and an optical path 906, typically a lens, an aperture, or an image conduit to convey the image from the rendered document to the optical capture device 908. The optical capture device 908 may incorporate a Charge-Coupled Device (CCD), a Complementary Metal Oxide Semiconductor (CMOS) imaging device, or an optical Sensor 924 of another type.

A microphone 910 and associated circuitry may convert the sound of the environment, including spoken words, into machine-compatible signals. The microphone 910 may also be utilized by users to provide audio annotations (or for speech-to-text annotations) of the present invention. Input facilities may exist in the form of buttons, scroll wheels, or other tactile Sensors such as touchpads. In some embodiments, input facilities may include a touchscreen display.

Visual feedback to the user is possible through a visual display, touchscreen display, or indicator lights. Audible feedback 934 may come from a loudspeaker or other audio transducer. Tactile feedback may come from a vibrate module 936.

A motion Sensor 938 and associated circuitry convert the motion of the mobile device 902 into machine-compatible signals. The motion Sensor 938 may comprise an accelerometer that may be used to sense measurable physical acceleration, orientation, vibration, and other movements. In some embodiments, motion Sensor 938 may include a gyroscope or other device to sense different motions.

A location Sensor 940 and associated circuitry may be used to determine the location of the device. The location Sensor 940 may detect Global Position System (GPS) radio signals from satellites or may also use assisted GPS where the mobile device may use a cellular network to decrease the time required to determine location.

The mobile device 902 comprises logic 926 to interact with the various other components, possibly processing the received signals into different formats and/or interpretations. Logic 926 may be operable to read and write data and program instructions stored in associated storage or memory 930 such as RAM, ROM, flash, or other suitable memory. It may read a time signal from the clock unit 928. In some embodiments, the mobile device 902 may have an on-board power supply 932. In other embodiments, the mobile device 902 may be powered from a tethered connection to another device, such as a Universal Serial Bus (USB) connection.

The mobile device 902 also includes a network interface 916 to communicate data to a network and/or an associated computing device. Network interface 916 may provide two-way data communication. For example, network interface 916 may operate according to the internet protocol. As another example, network interface 916 may be a local area network (LAN) card allowing a data communication connection to a compatible LAN. As another example, network interface 916 may be a cellular antenna and associated circuitry which may allow the mobile device to communicate over standard wireless data communication networks. In some implementations, network interface 916 may include a Universal Serial Bus (USB) to supply power or transmit data. In some embodiments, other wireless links may also be implemented.

As an example of one use of mobile device 902, a reader may scan an input drawing with the mobile device 902. In some embodiments, the scan may include a bit-mapped image via the optical capture device 908. Logic 926 causes the bit-mapped image to be stored in memory 930 with an associated timestamp read from the clock unit 928. Logic 926 may also perform optical character recognition (OCR) or other post-scan processing on the bit-mapped image to convert it to text.

A directional sensor 941 may also be incorporated into the mobile device 902. The directional device may be a compass and be based upon a magnetic reading or based upon network settings.

A LiDAR sensing system 951 may also be incorporated into the mobile device 902. The LiDAR system may include a scannable laser light (or other collimated) light source which may operate at nonvisible wavelengths such as in the infrared. An associated sensor device, sensitive to the light of emission may be included in the system to record time and strength of returned signal that is reflected off of surfaces in the environment of the mobile device 902. In some embodiments, as have been described herein, a 2-dimensional drawing or representation may be used as the input data source and vector representations in various forms may be utilized as a fundamental or alternative input data source. Moreover, in some embodiments, files which may be classified as BIM input files may be directly used as a source on which method steps may be performed. BIM and CAD file formats may include, by way of non-limiting example, one or more of: BIM, RVT, NWD, DWG, IFC and COBie. Features in the BIM or CAD datafile may already have defined boundary aspects having innate definitions such as walls and ceilings and the like. An interactive interface may be generated that receives input from a user indicating a user choice of types of innate boundary aspects a user provides instruction to the controller to perform subsequent processing on.

In some embodiments, a controller may receive user input enabling input data from either a design plan format or similar such formats or also allow the user to access BIM or CAD formats. Artificial intelligence may be used to assess boundaries in different manners depending on the type of input data that is initially inputted. Subsequently, similar processing may be performed to segment defined spaces in useable manners as have been discussed. The segmented spaces may also be processed to determine classifications of the spaces.

As has been described, a system may operate (and AI Training aspects may be focused upon) recognition of lines or vectors as a basic element within an input design plan. However, in some embodiments, other elements may be used as a fundamental element, such as, for example, a polygon and/or series of polygons. The one or more polygons may be assembled to define an area with a boundary, as compared, in some embodiments, with an assembly of line segments or vectors, which together may define a boundary which may be used to define an area. Polygons may include different vertices; however common examples may include triangular facets and quadrilateral polygons. In some embodiments, AI training may be carried out with a singular type of polygonal primitive element (e.g., rectangles), other embodiments will use a more sophisticated model. In some other examples, AI engine training may involve characterizing spaces where the algorithms are allowed to access multiple diverse types of polygons simultaneously. In some embodiments, a system may be allowed to represent boundary conditions as combinations of both polygons and line elements or vectors.

Depending upon one or more factors, such as processing time, a complexity of the feature spaces defined, and a purpose for AI analysis, simplification protocols may be performed as have been described herein. In some embodiments, object recognition, space definition or general simplification may be aided by various object recognition algorithms. In some embodiments, Hough type algorithms may be used to extract diverse types of features from a representation of a space. In other examples, Watershed algorithms may be useful to infer division boundaries between segmented spaces. Other feature recognition algorithms may be useful in determining boundary definitions from building drawings or representations.

In some embodiments, the user may be given access to movement of boundary elements and vertices of boundary elements. In examples where lines or vectors are used to represent boundaries and surrounding areas, a user may move vertices between lines or center points of lines (which may move multiple vertices). In other examples, elements of polygons such as the user may move vertices, sides, and center points. In some embodiments, the determined elements of the space representation may be bundled together in a single layer. In other examples, multiple layers may be used to distinguish distinct aspects. For example, one layer may include the AI optimized boundary elements, another layer may represent area and segmentation aspects, and still another layer may include object elements. In some embodiments, when the user moves an element such as a vertex the effects may be limited only to elements within its own layer. In some examples, a user may elect to move multiple or all layers in an equivalent manner. In still further examples, all elements may be assigned to a single layer and treated equivalently. In some embodiments, users may be given multiple menu options to select disparate elements for processing and adjustment. Features of elements such as color and shading and stylizing aspects may be user selectable. A user may be presented with a user interface that includes dynamic representations of a feature or other aspects of a design plan, and associated values and changes may be input by a user. In some embodiments, an algorithm and processor may present (e.g., via a user interface) comparisons of various aspects within a single model or between different models. Accordingly, in various embodiments, a controller and a user may manipulate aspects of a user interface and AI engine.

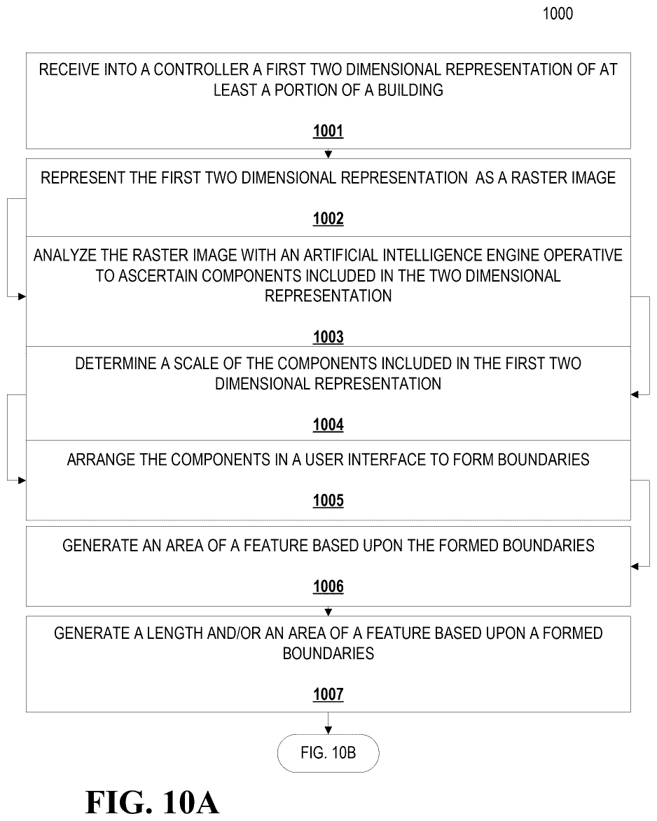

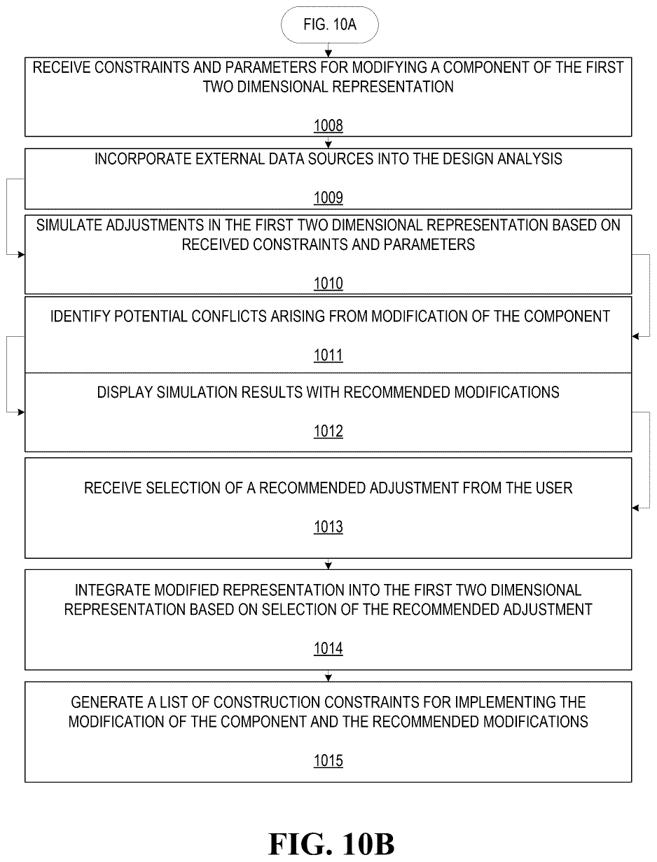

Referring now to FIGS. 10A-10B, method steps 1000 are depicted, outlining the processes for modifying a design plan in response to change order requests in accordance with certain implementations of the present invention.

At step 1001, the process begins by receiving into a controller a first two-dimensional representation of at least a portion of a building. This two-dimensional representation may come from a variety of sources, including a design file from a CAD system, a scanned architectural drawing, or even a hand-drawn sketch. For example, a user may submit a blueprint of a residential building or a commercial floor plan. This step is the starting point where the controller accesses the design that forms the basis of all further modifications and analysis. The input file can be in various formats, such as DWG, DXF, PDF, JPEG, or even TIFF, representing different types of drawings, including technical schematics or hand-rendered layouts. This initial submission is vital for the controller's analysis because it provides the spatial framework, dimensions, and elements that the system will work with throughout the process.

At step 1002, the controller processes the received two-dimensional representation by converting it into a raster image. This conversion is important when the input file is in vector format, such as a DWG or DXF file, which stores data as geometric shapes, lines, and curves. Rasterization turns these elements into pixels, allowing the controller to work with a detailed grid-based representation of the design. This step is important for enabling the AI engine to interpret the design in a way that supports component recognition, boundary formation, and further manipulation of the design. For example, if the design includes multiple walls and doorways in vector format, they will be translated into a raster image composed of pixels that represent those elements. This step enables the system to analyze the plan as an image, which becomes the basis for AI-driven analysis in subsequent steps.

At step 1003, the controller employs an artificial intelligence engine to analyze the rasterized image and identify architectural components. These components may include elements such as walls, doors, windows, columns, and other features present in the design. For example, if the input file contains a blueprint of a house, the AI engine recognizes where walls begin and end, the placement of windows, and the dimensions of rooms. This process may involve segmentation techniques where the AI divides the image into distinct regions based on pixel patterns and contrast. This segmentation allows the system to discern individual components in the design and associate them with specific architectural elements. The system may also rely on a pre-trained model, which has been trained on thousands of architectural designs to recognize common features. Once the components are identified, they are tagged and categorized for use in later steps.

At step 1004, the system determines the scale of the components identified in the two-dimensional representation. Scaling is important because architectural drawings are often reduced or enlarged for presentation purposes, and the system needs to work with real-world dimensions. The controller may extract scale information directly from the input file, such as a dimension line or a scale bar included in the original drawing. If no scale information is present, the user may be prompted to provide known dimensions, such as the width of a doorway or the length of a wall. For example, the user may input that a doorway is three feet wide, and the system would use that information to proportionally calculate the size of all other elements in the design. This step is important to the conversion of pixel-based data into accurate real-world measurements, allowing the system to manipulate the design with precision.

At step 1005, the controller arranges the identified components into a user interface to form boundaries between various spaces in the design. For example, walls identified by the AI engine in step 1003 are used to define the boundaries of rooms, hallways, and other architectural spaces. These boundaries are presented in the user interface, allowing the user to visualize how the different components relate to each other spatially. For example, in the design of an office floor plan, the system would use wall elements to separate individual office spaces, meeting rooms, and common areas. These boundaries are dynamic and can be adjusted by the user if needed. The user can interact with the interface by selecting boundaries to modify them, such as moving a wall or expanding a room, and the system will automatically update the design in real time based on those inputs.

At step 1006, the system generates an area for a feature based upon the boundaries that have been formed. Once the boundaries of rooms, hallways, and other spaces are defined, the system calculates the area of each enclosed space. For example, in a residential floor plan, the system will calculate the square footage of each bedroom, living area, kitchen, and other rooms. This information is important for both the user and the system, as it provides real-time feedback about the dimensions and proportions of spaces within the design. The system can use this area information to facilitate that the design adheres to user-specified requirements or spatial constraints, such as facilitating that a room meets minimum size requirements for comfort or function. The user can then adjust the layout if the calculated areas do not meet their expectations.

At step 1007, the system goes further to generate the length and/or area of a feature based upon a formed boundary. In this step, the system provides detailed dimensions for individual elements within the design. For example, the system may calculate the length of a hallway, or the area of a patio, based on the boundaries formed in the previous steps. If the design includes special features such as curved walls or non-rectangular rooms, the system will use advanced algorithms to calculate the precise area and length of those features. This allows the user to gain a more comprehensive understanding of the design and make any important modifications. The system also provides measurements for specific architectural details, such as the width of doorways, the height of ceilings, or the surface area of windows, giving the user the detailed information needed to refine the design.

At step 1008, the further process begins with receiving constraints and parameters for modifying a component of the first two-dimensional representation. These constraints and parameters can originate from the user, such as a contractor, architect, or client, and may include requirements like minimum room dimensions, permissible wall placements, or specific material choices. For example, in a residential floor plan, a user may specify a constraint that a bedroom must have a minimum area of 120 square feet or that a specific wall must accommodate electrical wiring. The received parameters may also relate to budget limitations, construction timelines, or aesthetic preferences. In some embodiments, the constraints and parameters can be dynamically entered by the user through an interactive user interface, allowing real-time feedback and adaptability during the design modification process.

Additionally, the constraints and parameters may include regulatory requirements or building code compliance criteria. For example, in a commercial building design, the constraints may specify fire escape regulations, accessibility standards for persons with disabilities, or ventilation requirements. The system interprets these constraints and parameters to form the foundational rules guiding the subsequent modifications to the two-dimensional representation. These inputs are stored in the system and later used to guide simulations and analyses performed in subsequent steps.

At step 1009, the process incorporates external data sources into the design analysis. These external data sources may include weather data, geospatial information, building code databases, or material cost repositories. For example, if the modification involves a rooftop design, the system can incorporate wind load data and local weather conditions to suggest modifications that increase structural stability. Similarly, if the user is designing a residential kitchen, external data sources may include a catalog of available materials, their costs, and delivery timelines. This step enhances the system's capacity to provide contextually relevant and accurate modifications by integrating real-world data into the analysis.

In one embodiment, the external data sources may also include information about nearby structures or utilities. For example, if the design involves modifying an exterior wall of a building, the system may access geospatial data to account for proximity to neighboring buildings or underground utilities. This integration facilitates that the proposed modifications are not only feasible within the design constraints but also considerate of external environmental and infrastructural factors. The system uses APIs or other data-sharing mechanisms to fetch this information, which is then processed by the controller for use in subsequent steps.

At step 1010, the controller simulates adjustments in the first two-dimensional representation, based on the received constraints and parameters. During this step, the system generates multiple scenarios, each showing how the modifications may impact the overall design. For example, if the modification involves extending a wall to increase the size of a room, the system simulates the effects of this change on adjacent spaces, material requirements, and the structural integrity of the design. The simulations may also include visual overlays, showing how the modified design would appear compared to the original.

In one example, a user may request the addition of a mezzanine level in a building. The system simulates this addition by calculating load distributions, identifying potential conflicts with existing components such as HVAC ducts or lighting systems, and displaying the simulated results in the user interface. The simulations are designed to provide the user with a comprehensive understanding of how the constraints and parameters influence the proposed changes.

At step 1011, the system identifies potential conflicts arising from the modification of the component. Conflicts may include overlapping design elements, violation of regulatory constraints, or incompatibility with structural limitations. For example, extending a wall may obstruct an existing window or reduce the size of an adjacent room below the minimum area specified in building codes. The system uses AI-driven algorithms to identify these conflicts and categorizes them by severity and type. For example, a conflict related to structural safety may be flagged as high priority, while an aesthetic issue may be flagged as low priority.

In another embodiment, the system may also suggest solutions to resolve identified conflicts. For example, if a user attempts to relocate a doorway to a position that violates structural support requirements, the system may suggest alternative positions for the doorway or propose reinforcements to accommodate the requested modification. These conflict analyses are displayed to the user for review and adjustment in subsequent steps.

At step 1012, the system displays simulation results along with recommended modifications. The recommendations are based on the constraints, parameters, and conflict analyses conducted in the earlier steps. For example, if a user proposes adding a balcony to an apartment, the system may recommend specific materials for the balcony railing based on budget constraints and weather resistance requirements. The simulation results are displayed in a visually intuitive format, such as side-by-side comparisons of the original and modified designs or heatmaps showing areas of potential conflict.

The user interface allows the user to interact with these recommendations, either by accepting them, modifying them further, or requesting additional simulations. For example, if the user is not satisfied with the proposed materials for the balcony, they may request the system to simulate other material options, adjusting the constraints as required.

At step 1013, the user selects one of the recommended adjustments provided by the system. This step allows the user to finalize their decision on how the modification should be implemented. For example, if the system provides three alternative positions for a relocated wall, the user selects the position that best aligns with their requirements. The system captures this selection and prepares to integrate the chosen modification into the design.

The selection process may also involve additional input from the user, such as specifying exact dimensions or providing feedback on the recommendations. For example, a user designing a retail space may select a recommended layout for shelving but request adjustments to the aisle width to accommodate larger shopping carts.

At step 1014, the system integrates the modified representation into the first two-dimensional representation. This step involves updating the design to incorporate the user's selected modification, so that all associated elements are adjusted accordingly. For example, if the modification involves relocating a wall, the system updates not only the wall's position but also adjusts related components such as doors, windows, and electrical outlets. The updated design is displayed to the user in the interactive interface, allowing them to review and make further refinements if required.

In some embodiments, the integration process may also involve updating associated metadata, such as cost estimates, material lists, and timelines. For example, if the modification requires additional materials, the system updates the material list to include the required items and adjusts the budget estimate to reflect the added cost.

At step 1015, the system generates a list of construction constraints for implementing the modification of the component and the recommended modifications. This list includes detailed instructions for contractors, such as material requirements, labor tasks, and timelines. For example, if the modification involves constructing a new partition wall, the list may specify the type and quantity of materials needed, the estimated time required for construction, and the labor categories involved.

The construction constraints may also include compliance checks to facilitate that the modifications align with regulatory requirements. For example, the list may highlight specific codes that the contractor needs to adhere to when implementing the modification. This step bridges the gap between design and execution, providing all stakeholders with the information needed to carry out the proposed changes effectively.

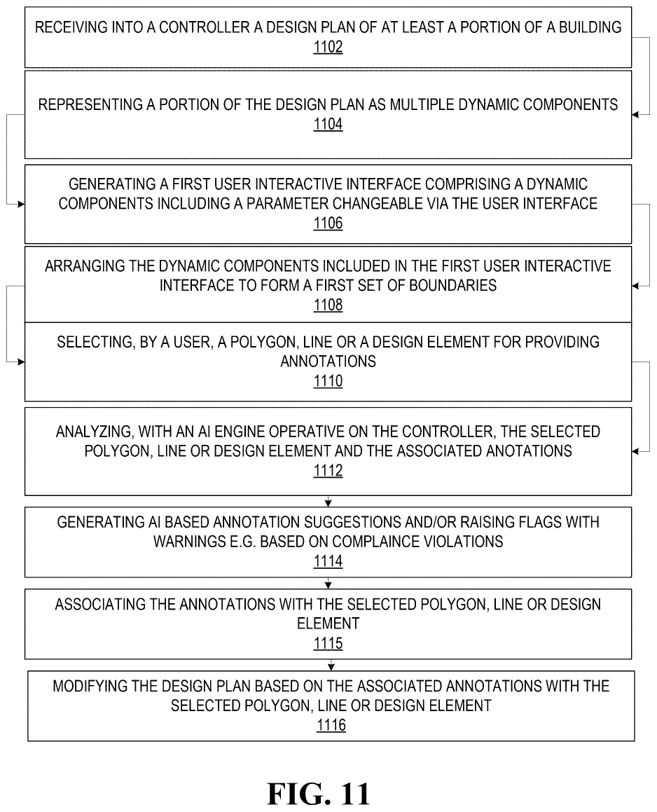

Referring now to FIG. 11, a system including one or more controllers (comprising AI engine) may be configured to perform particular operations or actions by virtue of having executable software, firmware, hardware, or a combination of them that in operation cause the controllers to be operative to perform method steps for annotating design elements, and analyzing annotations for providing automated annotation suggestions and for determining non-compliance to best practices or predefined rules within a collaborative environment.

At step 1102, receiving into a controller a design plan, which may be a static design plan, such as, for example, a design plan in PDF format, of at least a portion of a building or other structure.

At step 1104, the method may include representing a portion of the static design plan as multiple dynamic components. The dynamic components include, for example, one or more polygons, lines, and arcuate segments.

At step 1106, the method may include generating a first interactive user interface including at least some of the multiple dynamic components representing a portion of the design plan, each dynamic component including a parameter changeable via the interactive user interface.

At step 1108, the method may include arranging the dynamic components included in the first interactive user interface to form a first set of boundaries, the first set of boundaries including a respective length and area, and the first set of boundaries defining at least a portion of a first unit.

At step 1110, the user selects a design element within the first interactive user interface. This design element may be a polygon representing a room, a line indicating a boundary, or any specific feature on the design plan that requires further detail, installation instructions or clarification. The selection process is intuitive, allowing users to simply click or tap on the desired element within the interface. Other ways to select the design elements are also discussed in various embodiments of the present invention.

At step 1112, once a design element is selected, the AI engine operative on the controller analyzes the selected design element and its associated annotations. This analysis includes understanding the spatial context of the design element, its dimensions, the implications of its location, and any previously associated annotations or data. The AI uses this analysis to inform and enhance the subsequent steps of the annotation process.

At step 1114, the AI engine generates annotation suggestions, which can include text, images, and multimedia elements. These suggestions are based on a database of best practices, user preferences, past annotations, and compliance with best practices. These suggestions can be similar to the past annotations to the similar design elements or AI generated suggestions based on machine learning past annotations. For example, if a window (design element) is selected, the AI engine may suggest annotations related to glazing options, energy efficiency ratings, or aesthetic design considerations. Moreover, if the system detects potential non-compliance with best practices or predefined rules based on the selected element's attributes or the annotations, it may raise flags with warnings, prompting the users to adjust the design or update the annotations accordingly.

At step 1115, the system further associates the annotations with the selected design element. This association facilitates that the annotations are correctly positioned relative to the element and are displayed within the user interface in a manner that other users (possibly with appropriate permissions) can easily understand and interact with.

At step 1116,

Some embodiments of the present invention enable the collaborative platform to serve not just as a static repository of design plans but as a dynamic, intelligent system that guides users through the annotation process, helps maintain compliance, and facilitates a more efficient design workflow. For example, upon selecting a staircase element (design element), the system may suggest annotations regarding tread depth standards, highlight potential accessibility issues, or even propose alternative designs that are better suited to the overall building layout. This intelligent guidance may serve to streamline the collaborative process, making the system invaluable to architects, engineers, and other stakeholders involved in the design and building process.

In some embodiments of the present invention, the system's capabilities extend beyond the creation and management of annotations within design plans. The AI engine, through an integrated and responsive user interface, may offer intelligent equipment recommendations based on selected design elements, annotations context, or modifications within the design plan.

Upon selection of a design element for annotation or modification, the AI engine may analyze the context and specifics of the change, such as the function of the space, dimensions of the design element, or materials specified in annotations. Leveraging this information, the AI may then suggest equipment(s) that is optimally compatible with the design requirements. These suggestions may include a variety of equipment(s) from different brands, along with detailed pricing information.

The system may also integrate with third-party vendor databases to pull real-time pricing and availability data, providing users with a possible comprehensive shopping experience within the platform. Users can review these recommendations, compare options, and even access reviews or ratings within the same interface.

For example, if a user annotates a design element to convert a space into a high-traffic area, the AI engine may recommend durable flooring options available from specific brands and present the cost implications directly within the interface. If the annotation specifies the need for an eco-friendly HVAC system, the system may suggest several models that meet the latest environmental standards, complete with efficiency ratings and prices.

Moreover, the platform may also offer a feature to directly add recommended equipment to a virtual cart, facilitating immediate or later purchases. The platform may also automatically update a takeoff, material list, workforce requirements, project budget or other related project aspect. Platform integration into such associated functions may streamline bidding, procurement, labor engagement, supply chain, and other related processes, facilitating project planning and execution phases that are closely aligned. Required resources may be accounted for and procured efficiently.

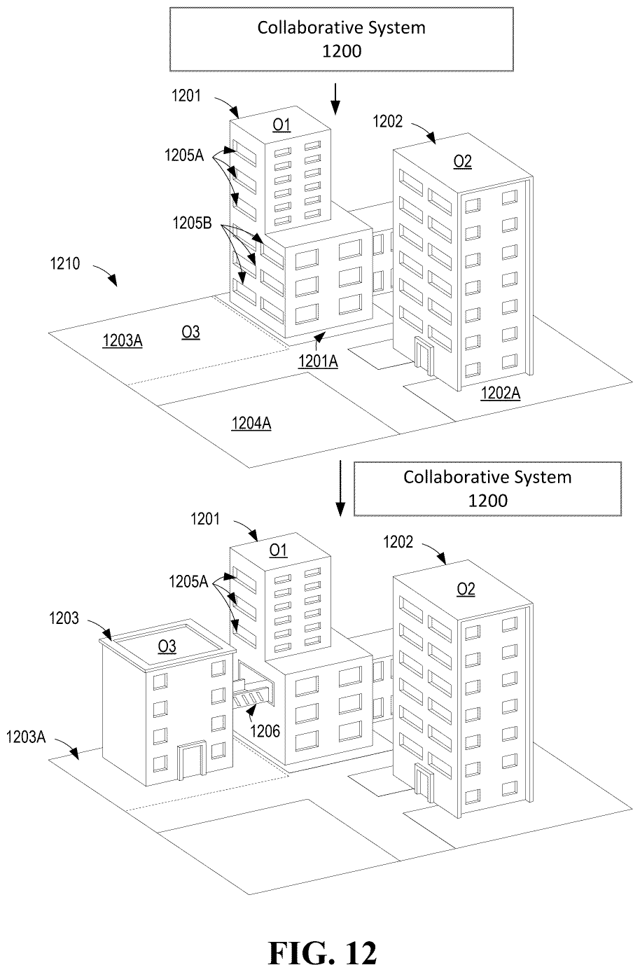

Referring now to FIG. 12, an exemplary system 1200 is illustrated for collaboratively managing design plans 1201-1203 for multiple buildings in a construction site 1210. The collaborative system 1200 facilitates interactions between multiple owners and their respective design plans (1201-1203) to evaluate and mitigate potential conflicts or dependencies arising from change orders in any one of the buildings. The collaborative system 1200 may be particularly advantageous in scenarios where two or more buildings are planned, constructed, or already exist in close proximity, as a change order affecting one building may significantly impact adjacent structures or their surrounding environment.

The construction site 1210 is shown to include four distinct plots, labelled as 1201A, 1202A, 1203A, and 1204A. Each plot may be allocated to a respective owner for building development. For example, the first plot 1201A is owned by a first owner Q1, the second plot 1202A is owned by a second owner Q2, and the third plot 1203A is owned by a third owner Q3. The collaborative system 1200 allows each owner to input their respective design plans into the system 1200, enabling a centralized review and analysis of interdependencies among the buildings represented by these design plans.

In this illustrated embodiment, the first design plan 1201 represents a building under construction on the first plot 1201A. The second design plan 1202 corresponds to an already constructed building on the second plot 1202A, while the third design plan 1203 pertains to a planned construction on the third plot 1203A. The first building 1201 has a series of windows 1205A-1205B initially facing the third plot 1203A. However, upon feeding the third design plan 1203 into the collaborative system 1200, the third owner Q3 provides detailed design information for their planned building, enabling the first owner Q1 to assess the potential impact of these plans on their structure.

For example, if the third building for the third design plan 1203 includes a high-rise structure that obstructs the view from the windows 1205B of the first building 1201, the first owner Q1 may decide to modify the initial design plan. This modification may include removing or relocating the windows 1205B to a different side of the building to optimize natural light and ventilation or to preserve privacy. Such modifications would then be updated in the collaborative system 1200 to reflect the revised first design plan 1201.

The collaborative system 1200 operates as an integrated platform that enables dynamic updates to design plans based on interdependencies among adjacent structures. For example, the system 1200 may automatically notify owner Q1 about potential conflicts arising from owner Q3's design plan 1203. Such conflicts may include overlapping building heights, encroachments into setback areas, or alignment issues with shared utilities like drainage, electricity, or gas lines. The system 1200 can provide actionable insights and suggestions to resolve these conflicts, such as recommending adjustments to building heights, window placements, or utility layouts.

In some embodiments, the collaborative system 1200 may also provide visualization tools that simulate the spatial relationship between the first building 1201, the second building 1202, and the third building 1203. For example, a three-dimensional rendering of the construction site 1210 may be generated to allow owners to visualize how design changes in one building impact the aesthetics, functionality, or regulatory compliance of adjacent buildings. This capability empowers owners to make informed decisions regarding their design plans while minimizing adverse effects on neighbouring properties.

Moreover, the collaborative system 1200 supports real-time collaboration among stakeholders, including owners, architects, contractors, and regulatory authorities. For example, Q1 may request input from Q3 regarding the feasibility of certain design changes, such as shifting windows 1205B to another side of the building or altering structural elements to accommodate shared infrastructure. This collaborative approach enhances communication and alignment among all parties, reducing the likelihood of disputes or project delays.

The system 1200 may also incorporate advanced analytical tools, such as those powered by artificial intelligence or machine learning algorithms, to predict and evaluate the long-term implications of design changes. For example, the system may analyze how modifying windows 1205B in the first building 1201 affects energy efficiency, daylight penetration, or heating and cooling requirements over time. Similarly, it may assess whether the design changes introduce any new regulatory challenges or approval requirements.

In one embodiment, the system 1200 may allow owners to establish predefined preferences or constraints that guide the evaluation of change orders. For example, Q1 may specify that all windows in the first building 1201 must maintain a minimum distance from adjacent buildings to preserve privacy or comply with local zoning ordinances. When Q3 feeds the third design plan 1203 into the system 1200, these preferences can be automatically applied to identify potential violations or conflicts, prompting Q1 to revise the design plan accordingly.

The collaborative system 1200 also facilitates the equitable resolution of disputes arising from change orders. For example, if Q3's design plan 1203 necessitates modifications to Q1's first design plan 1201, the system 1200 can provide a detailed breakdown of associated costs, timelines, and labor requirements. This transparency enables the parties to negotiate mutually agreeable terms for implementing the changes.

In some embodiments of the present invention, the collaborative system 1200 may facilitate communication and negotiation between two or more owners, such as the first owner Q1, the second owner Q2, and the third owner Q3, enabling them to collaboratively manage their respective design plans 1201-1203. For example, as shown in FIG. 12, the first owner Q1 may decide to construct a crossover stair or bridge stair 1206 connecting the first building for the first design plan 1201 and the third building for the third design plan 1203. This crossover stair 1206 may serve as a shared infrastructure element between the two buildings, allowing convenient access or creating a shared functional space.

The collaborative system 1200 enables the first owner Q1 to initiate a change order request to the third owner Q3 for constructing the crossover stair 1206. This request is sent through the centralized platform of the system 1200, which facilitates structured communication between the two parties. The request may include specific details such as the proposed location, dimensions, and materials of the crossover stair 1206, as well as the intended benefits and potential impacts of the change order on the third design plan 1203.

The third owner Q3, upon receiving the change order request from Q1, may review the details and evaluate the feasibility and implications of the proposal. The collaborative system 1200 provides tools and analytics to assist Q3 in this evaluation process, such as visualizing how the crossover stair 1206 affects the third building 1203A, estimating the additional costs or labor required, and assessing compliance with regulatory or design considerations. The third owner Q3 may choose to either approve, reject, or amend the change order request. For example, Q3 may approve the request with conditions, such as sharing the costs of construction or altering the dimensions of the crossover stair 1206 to better align with the third building's design constraints.

If Q3 approves the request, the collaborative system 1200 facilitates the integration of the crossover stair 1206 into both the first and third design plans (1201-1203), updating them accordingly. This update process includes recalculating construction constraints, such as labor, materials, timelines, and regulatory compliance, for both affected buildings. For example, the addition of the crossover stair 1206 may require new structural reinforcements, adjustments to entry points, or modifications to shared facilities like HVAC systems or electrical wiring.

If Q3 rejects the request, the collaborative system 1200 enables Q1 to modify the proposal based on Q3's feedback or to explore alternative solutions. For example, Q1 may propose a smaller stair or an alternative connection point to address concerns raised by Q3. The system tracks all communications, revisions, and approvals related to the change order request, facilitating transparency and accountability throughout the process.

In cases where Q3 amends the request with conditions, the collaborative system 1200 enables both Q1 and Q3 to negotiate the terms of the amendment. For example, Q3 may agree to the crossover stair 1206 on the condition that Q1 contributes to upgrading shared infrastructure, such as drainage or parking facilities. The system 1200 facilitates this negotiation by providing real-time updates to both parties, visualizing the impacts of proposed changes, and generating detailed cost and labor breakdowns to support decision-making.

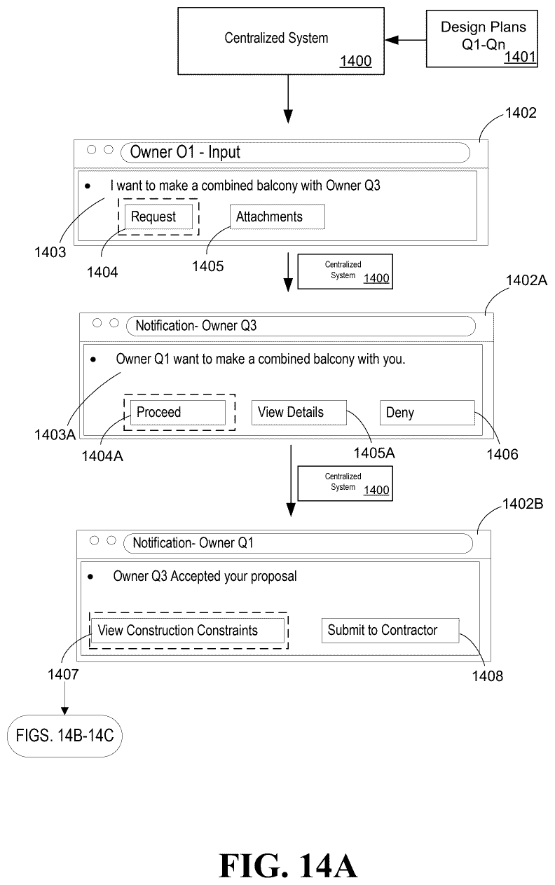

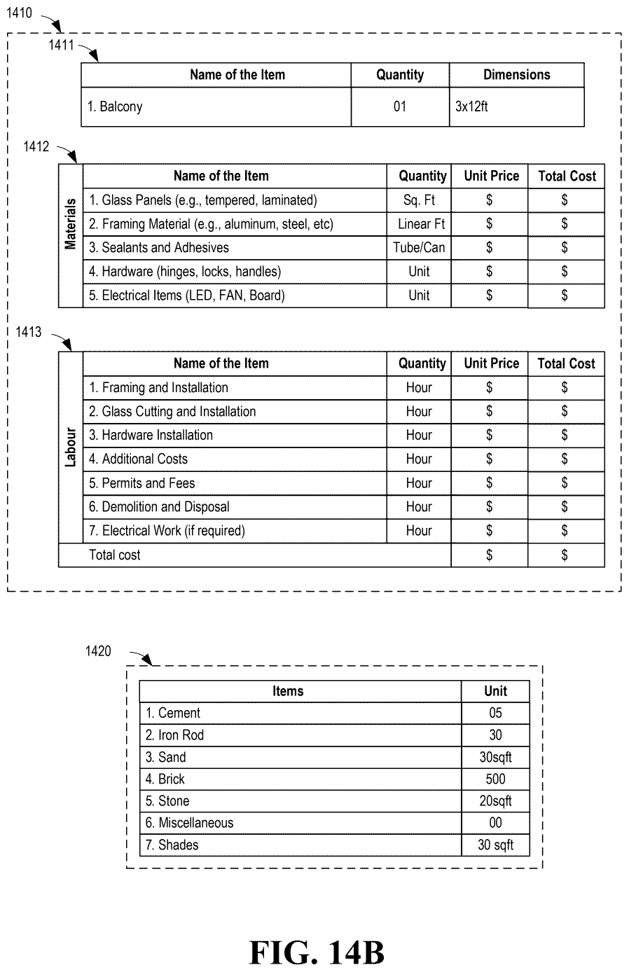

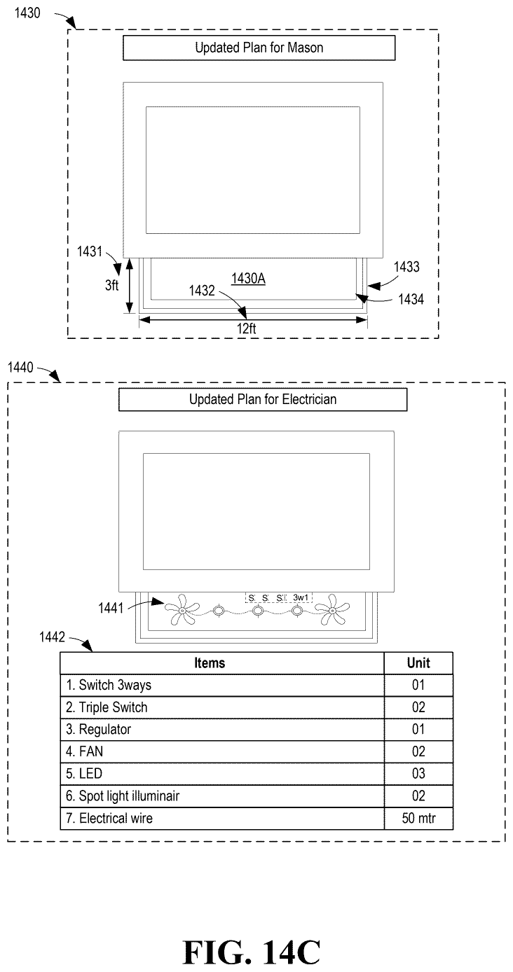

The request-approval process for such change orders is explained in further detail in FIG. 14A below. The collaborative system 1200 enables structured workflows for submitting, reviewing, and responding to change order requests, streamlining collaboration among multiple owners. This capability is particularly useful in scenarios where shared infrastructure elements, such as the crossover stair 1206, create interdependencies between adjacent buildings or plots.

Additionally, the collaborative system 1200 supports broader applications beyond shared staircases. For example, owners may use the system to coordinate shared utility lines, align construction schedules to minimize disruptions, or negotiate agreements for shared amenities like gardens or recreational spaces. The system's centralized platform enables seamless communication and data sharing, reducing the risk of misunderstandings or conflicts among owners.

In one embodiment, the collaborative system 1200 may also provide predictive analytics to assess the long-term implications of shared infrastructure elements like the crossover stair 1206. For example, the system may analyze the projected maintenance costs, lifespan, and usage patterns of the stair to help Q1 and Q3 make informed decisions. The system may also generate alerts or recommendations for periodic inspections or upgrades to ensure the functionality and safety of shared infrastructure over time.

Furthermore, the collaborative system 1200 may integrate regulatory compliance checks to identify potential issues with proposed shared elements. For example, the system 1200 may flag the crossover stair 1206 for violating setback requirements or exceeding height restrictions, prompting Q1 and Q3 to revise their design plans accordingly. The system 1200 also supports integration with third-party platforms, such as municipal approval systems, to streamline the regulatory approval process for shared infrastructure projects.

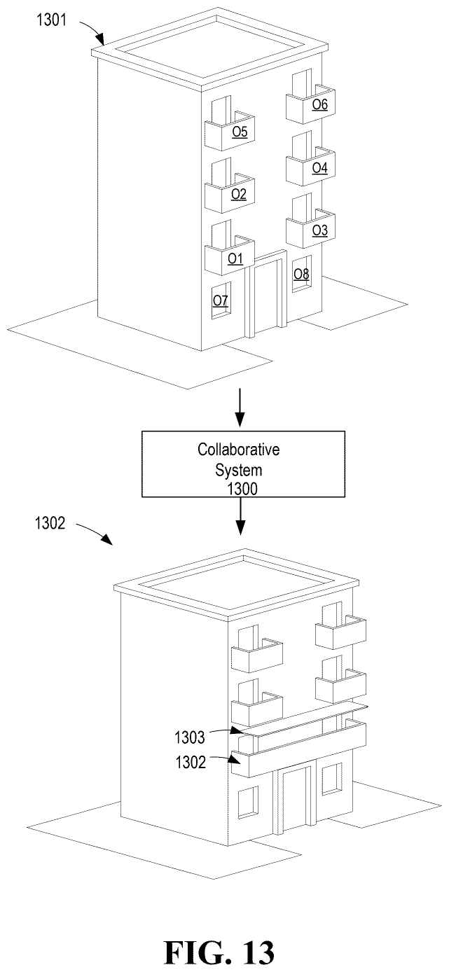

Referring now to FIG. 13, an exemplary collaborative system 1300 is depicted for managing change orders in a multi-owner building, in accordance with the present invention. FIG. 13 illustrates a scenario where a design plan 1301, representing a single building with various portions owned by different owners Q1 through Q8, is processed through the collaborative system 1300 to handle and execute change order requests in a collaborative manner. The design plan 1301 is uploaded into the collaborative system 1300 by the respective owners, and the system facilitates coordination and negotiation among the owners regarding any proposed changes to the building structure or design elements.

The design plan 1301 represents an apartment building comprising multiple units, each owned by a different owner, Q1 to Q8. The owners may use the collaborative system 1300 to propose, review, and approve modifications to shared or individual portions of the building. For example, the first owner Q1, owning one of the apartments, may propose to construct a combined balcony with the third owner Q3, who owns an adjacent unit. Such a proposal is submitted to the collaborative system 1300, which processes the request and notifies the relevant parties, in this case, the third owner Q3.

Upon receiving the request, the collaborative system 1300 allows the third owner Q3 to review the proposal in detail. The system provides tools for Q3 to approve, reject, or modify the proposal. For example, the third owner Q3 may agree to the combined balcony under certain conditions, such as adding an awning 1304 for enhanced functionality or agreeing on shared costs. The collaborative system 1300 enables seamless communication and documentation of such conditions, so that all parties are informed and their agreements recorded.

If the third owner Q3 approves the request, the collaborative system 1300 generates an updated design plan 1302. This updated design plan 1302 includes the newly constructed combined balcony 1303 shared between the first owner Q1 and the third owner Q3, along with additional modifications such as the awning 1304. The system may also provide a breakdown of the materials required, the estimated costs, the labor involved, and the timelines for implementing these changes.

In another embodiment, the collaborative system 1300 allows the inclusion of regulatory checks to determine whether the proposed changes comply with local building codes and regulations. For example, before finalizing the construction of the combined balcony 1303, the system may verify the structural integrity of the building to support the additional load and facilitate proper drainage solutions are integrated into the design. Such compliance checks are automatically conducted by the system and flagged for review if required.

The collaborative system 1300 provides significant benefits in managing change orders in multi-owner properties. It fosters transparency among owners by allowing them to collaboratively review and negotiate changes. Additionally, the system reduces potential conflicts by documenting all approvals, conditions, and modifications, so that every party involved has a clear understanding of the proposed and finalized changes. For example, the agreement between Q1 and Q3 regarding the shared balcony 1303 and awning 1304 is stored within the system, accessible for future reference.

The system also facilitates cost-sharing mechanisms for shared changes. For example, the collaborative system 1300 can calculate the proportional costs to be borne by each owner based on the square footage of their respective portions affected by the combined balcony 1303. Owners can use the system to review and agree on these costs before proceeding with the construction. This feature streamlines financial negotiations and avoids disputes during or after the implementation of the changes.

Furthermore, the collaborative system 1300 can incorporate feedback from other stakeholders, such as contractors or architects, to refine the proposed changes. For example, if the proposed awning 1304 requires specific materials for durability or aesthetics, the system may notify both Q1 and Q3 to review the revised material requirements and associated costs. Such inputs are invaluable in facilitating the feasibility and quality of the modifications.

In yet another embodiment, the collaborative system 1300 may support the simultaneous management of multiple change orders from different owners. For example, while Q1 and Q3 are collaborating on the combined balcony 1303, another owner Q5 may propose changes to the entrance design of the building. The system processes these change orders concurrently, so that they do not conflict with one another. If any conflicts arise, such as overlapping construction timelines or resource allocations, the system alerts the respective owners and suggests alternative solutions.

The collaborative system 1300 also enhances efficiency by integrating advanced technologies such as artificial intelligence (AI) and machine learning (ML). These technologies enable the system to predict potential impacts of the proposed changes on the building's overall design, such as structural stability, ventilation, or lighting. For example, the system may analyze how the combined balcony 1303 and awning 1304 affect the natural light reaching lower floors and suggest adjustments to mitigate any negative impacts.

Additionally, the collaborative system 1300 provides visualization tools to help owners better understand the implications of their change orders. For example, 3D models of the updated design plan 1302, including the combined balcony 1303 and awning 1304, can be generated and shared with Q1 and Q3. Such visual representations make it easier for owners to make informed decisions and gain consensus.

The collaborative system 1300 also maintains a historical log of all change orders and updates, facilitating traceability and accountability. For example, if any disputes arise in the future regarding the construction of the combined balcony 1303, the system provides access to the original request, the approval conditions, and the final implementation details.

FIGS. 14A, 14B, and 14C illustrate an exemplary collaborative process in which multiple users engage in managing change orders through a centralized system 1400. The process involves initiating change requests by one or more users, reviewing and approving or amending these requests by other affected or concerned users, and generating updated plans that reflect the approved changes. The centralized system 1400 facilitates the coordination by providing detailed outputs, including updated materials, labor requirements, and cost estimates, facilitating seamless collaboration and efficient implementation of the requested changes.

In the collaborative process, the users interacting with the centralized system 1400 may include, but are not limited to, clients, property owners, contractors, regulatory authorities, architects, and project managers. Each of these users may possess distinct roles and responsibilities within the construction or renovation workflow. For example, property owners or clients may initiate change order requests to reflect evolving preferences or requirements, such as altering the layout of a room, adding new structural features, or modifying aesthetic elements like windows or finishes. Similarly, contractors or architects may propose changes based on practical considerations, including compliance with updated building codes, unforeseen site conditions, or the availability of materials.

Approvals may be required to address the collaborative nature of construction projects, where changes introduced by one user can potentially affect other stakeholders. For example, if a client requests a change that impacts the structural integrity or aesthetic design shared with other property owners, those affected parties may need to review and approve the request to facilitate alignment with their own interests. In scenarios involving multi-tenant buildings, such as apartment complexes or commercial properties, changes initiated by one owner may require approval from other owners to maintain design consistency, adhere to shared budget constraints, or avoid disruptions to ongoing construction processes.

The centralized system 1400 facilitates this multi-user collaboration by providing a systematic framework for handling approvals. Upon receiving a change request, the system 1400 may notify all affected parties and generate detailed data outputs to assist them in evaluating the proposed changes. Such outputs may include projected costs, revised timelines, and potential impacts on shared resources like labor or materials. Users can review this data through the system's interactive interface and either approve the change as proposed, reject it, or suggest amendments to address their concerns.

For example, a contractor reviewing a change order to modify a structural feature may request additional labor or materials to implement the change effectively. Likewise, an architect may suggest design modifications to accommodate the requested change while preserving the overall aesthetic or functional objectives of the project. In such cases, the system 1400 enables dynamic communication between users, documenting all interactions and updates to maintain an audit trail of the decision-making process.

Approvals may also depend on compliance with regulatory requirements or project-specific constraints, such as budget limits or time-sensitive milestones. For example, a building code update may necessitate additional approvals for changes impacting safety-critical elements like fire exits or load-bearing structures. The system 1400 aids in identifying such regulatory dependencies and incorporating them into the approval workflow, thereby minimizing the risk of non-compliance.

In addition to facilitating approvals, the system 1400 may allow users to negotiate terms related to the proposed changes. For example, a contractor may agree to implement a change order under specific conditions, such as additional payment or an extended deadline. The system 1400 enables these negotiations by providing tools for users to propose conditions, accept or reject counter offers, and finalize agreements seamlessly within the collaborative environment.

By providing a centralized platform for initiating, reviewing, and approving change orders, the system 1400 facilitates that all users remain informed of the current status of the project and the implications of any proposed changes. This streamlined approach reduces delays, prevents miscommunication, and promotes efficient decision-making, ultimately contributing to the successful execution of construction or renovation projects.

Referring to FIG. 14A, the exemplary centralized system 1400 enables multiple owners Q1-Qn to manage and collaborate on change orders that may affect their respective design plans 1401. The centralized system 1400 allows owners to share design plans of their respective buildings and coordinate changes that may require approval from other stakeholders. In this example, as related to FIG. 13, the first owner Q1 may initiate a change order request using a pop-up window 1402 provided by the centralized system 1400. The change order request may include a description 1403 detailing the intended modification. For example, the first owner Q1 may request to construct a shared balcony with the third owner Q3 (as discussed in FIG. 13 above), specifying the exact design or dimensions in the description 1403.

The pop-up window 1402 further allows the first owner Q1 to add relevant attachments 1405, which may include architectural sketches, regulatory approvals, engineering calculations, or any additional documents required to support the change order request. For example, if the change involves altering a structural component, the attachment 1405 may include stress analysis reports or material specifications. By clicking on the request button 1404, the first owner Q1 submits the change order request to the centralized system 1400.

Upon submission, the centralized system 1400 generates a notification 1402A that is sent to the third owner Q3, whose design plans may be affected by the proposed change. The third owner Q3 can review the details of the change order request, including the description 1403A and any associated attachments 1405A, by clicking on the view details button 1405A. This step allows the third owner Q3 to assess the impact of the proposed change on their own design plan and overall project goals. For example, if the shared balcony requires alterations to an existing wall or affects the privacy of an adjoining space, the third owner Q3 may evaluate these considerations before making a decision.

The centralized system 1400 provides the third owner Q3 with two primary options: deny the request by clicking the deny button 1406 or proceed with the request by clicking the proceed button 1404A. If the third owner Q3 chooses to deny the request, the centralized system 1400 may notify the first owner Q1 of the denial and may include comments or feedback explaining the reason for rejection. For example, the third owner Q3 may reject the request due to budgetary constraints or conflicting design goals.

If the third owner Q3 selects the proceed button 1404A, the centralized system 1400 generates an approval notification 1402B, which is sent back to the first owner Q1. The approval notification 1402B informs the first owner Q1 that the proposed change has been accepted and may include additional details or conditions set by the third owner Q3. For example, the third owner Q3 may request a specific material or design modification for the shared balcony as a condition for approval.

Following approval, the first owner Q1 may take further action by clicking on the submit to contractor button 1408. This action sends the approved change order details, including any construction constraints and additional requirements, to the concerned contractor responsible for implementing the change. The contractor may receive all required information, such as updated design plans, material lists, labor requirements, and cost estimates, enabling them to proceed with the construction work without delay.

Additionally, the first owner Q1 may choose to click on the view construction constraints button 1407 before submitting the change order to the contractor. This action provides access to a detailed breakdown of the construction constraints associated with the change order, including timelines, material substitutions, labor allocations, and cost implications. The detailed construction constraints help the first owner Q1 evaluate the feasibility of the change and make informed decisions regarding project execution. These constraints are discussed in greater detail in FIGS. 14B-14C.

In scenarios involving multi-user collaboration, the centralized system 1400 serves as a vital tool for streamlining communication, reducing disputes, and maintaining transparency. For example, if the first owner Q1 and the third owner Q3 are part of a larger project involving multiple stakeholders, the centralized system 1400 facilitates that all communications and approvals are documented and accessible. This functionality not only facilitates efficient collaboration but also minimizes the risk of errors or misunderstandings during project execution.

The centralized system 1400 can be further customized to accommodate various types of change orders and user preferences. For example, the system may support additional features such as setting deadlines for approvals, incorporating automated reminders for pending actions, and generating real-time updates on the status of the change order. These enhancements improve the overall user experience and enable seamless coordination among all stakeholders involved in the project.

Referring now to FIG. 14B, the figure illustrates a detailed list of pricings 1410 and an items table 1420 generated by the centralized system 1400 to provide comprehensive information for implementing the change order 1403, as discussed in FIG. 14A. The list of pricings 1410 is segmented into three sub-tables, specifically a summary table 1411, a materials table 1412, and a labor table 1413. These tables offer a granular breakdown of the costs and resources associated with the proposed change order. Furthermore, the items table 1420 lists the individual components required for execution, with unit measurements to assist in procurement planning and logistics.

The summary table 1411 within the list of pricings 1410 provides a high-level overview of the primary items included in the change order. For example, in this scenario, the first row of the table highlights the addition of a balcony, specifying a quantity of one unit with dimensions of 3×12 feet. This concise summary allows users, such as contractors or project managers, to quickly understand the scope of the proposed changes. For example, the summary may also include other elements, such as modifications to interior partitions or the addition of structural supports, depending on the specific requirements of the change order.

The materials table 1412 expands on the summary by detailing the specific materials required for implementing the change order. Each row specifies the type of material, the required quantity, the unit price, and the total cost. For example, the table may list glass panels, framing materials such as aluminum or steel, and associated items like adhesives, hardware, and electrical components. For example, the row for glass panels may detail whether they are tempered or laminated, while the row for framing materials may specify the type and dimensions of the required aluminum or steel sections. This breakdown facilitates precise budgeting and procurement, so that all required materials are accounted for before construction begins.

Additionally, the labor table 1413 provides a detailed accounting of the human resources required to execute the change order. The table includes rows for framing and installation, glass cutting, hardware installation, and other tasks, such as permits and fees or demolition and disposal. Each row specifies the number of hours required, the hourly rate, and the total cost for the associated task. For example, framing and installation may require 10 hours of labor at a rate of $50 per hour, resulting in a total cost of $500. The labor table also includes provisions for additional costs, such as safety measures or specialized expertise, providing a comprehensive view of the human effort involved.

The items table 1420 complements the list of pricings 1410 by enumerating the raw materials required for the change order. This table includes columns for the item name, unit, and any relevant notes or specifications. For example, the table may list materials such as cement, sand, and bricks for structural modifications, as well as miscellaneous items like fasteners or sealants. The inclusion of unit measurements facilitates clarity, allowing users to determine the precise quantities required. For example, the row for cement may indicate a requirement of five bags, while the row for sand specifies 300 square feet.

The centralized system 1400 may generate the list of pricings 1410 and the items table 1420 dynamically based on the parameters of the change order. For example, if the change order involves constructing a balcony, the system may automatically calculate the required quantities of glass panels, framing materials, and other components based on the specified dimensions. Similarly, the system may adjust the labor table 1413 to account for the complexity of the design, such as the inclusion of intricate railing patterns or additional structural reinforcements.

The integration of the items table 1420 with the materials and labor tables 1412-1413 provides a holistic view of the resources required for the change order. For example, the user can cross-reference the quantities specified in the items table with the rows in the materials table to verify accuracy. Similarly, the user can review the labor table to facilitate that the estimated hours align with the scope of the project. This cross-referencing capability enhances transparency and minimizes the risk of errors or omissions in the planning process.

The list of pricings 1410 and the items table 1420 also serve as a valuable communication tool between stakeholders. For example, the first owner Q1 can share these tables with the third owner Q3 to facilitate discussions about the proposed change order. The detailed breakdown of costs and resources enables both parties to make informed decisions, such as agreeing on shared expenses or adjusting the design to reduce costs. The tables can also be used to negotiate terms with contractors, as they provide a clear representation of the project's requirements and associated expenses.

In some embodiments, the centralized system 1400 may allow users to customize the tables by adding or modifying rows to reflect specific project needs. For example, the user (e.g., Q3) may add a row to the materials table 1412 for a unique type of glass panel or include a new task in the labor table for painting the completed balcony. This customization capability enhances the system's flexibility, allowing it to accommodate a wide range of project scenarios.

Furthermore, the centralized system 1400 may include features for real-time updates to the tables based on user inputs or changes in project parameters. For example, if the user modifies the dimensions of the balcony in the summary table 1411, the system may automatically adjust the quantities and costs in the materials and labor tables. This dynamic updating capability facilitates that the tables remain accurate and relevant throughout the project lifecycle.

Referring now to FIG. 14C, the figure illustrates a detailed representation of design plans generated for the construction and implementation of the common balcony requested as part of the change order 1403. Specifically, FIG. 14C includes a first design plan 1430, which represents the structural layout of the common balcony, and a second design plan 1440, which represents the electrical layout required for the same. These design plans are tailored to facilitate the seamless execution of the requested changes and include comprehensive dimensions, specifications, and component details for precise planning and implementation.

The first design plan 1430 is a structural blueprint that provides the required dimensions, such as the width 1431 and length 1432, as well as other key specifications like shapes and sizes 1433-1434 for constructing the common balcony. For example, the balcony is shown to have a length of 12 feet (1432) and a width of 3 feet (1431), making it suitable for shared usage between the first owner Q1 and the third owner Q3. The design also includes shapes and sizes of elements like supporting columns 1433 or railings 1434, providing structural stability and aesthetics. For example, the supporting columns 1433 may be circular with a specified diameter, while the railings 1434 may include vertical bars with a specific spacing. These details are important for guiding contractors during the construction phase and for procuring the required materials.

The second design plan 1440 complements the first design plan 1430 by outlining the electrical requirements for the common balcony. This plan includes the positioning 1441 of electrical components, such as lights, fans, and switches, facilitating that the space is adequately equipped for functionality and comfort. For example, the positioning 1441 indicates the placement of two ceiling fans, one on either side of the balcony, along with LED lights at regular intervals for optimal illumination. The electrical design also includes a table 1442 listing the required components, such as three-way switches, triple switches, regulators, and electrical wiring. For example, the table specifies that two triple switches and 50 meters of electrical wire are needed, enabling precise procurement and installation planning.

The first design plan 1430 and the second design plan 1440 are generated by the centralized system 1400 in response to the change order 1403. These plans may be accessed by the first owner Q1 using the “view construction constraints” button 1407, as shown in FIG. 14A. This feature allows the owner to review the detailed plans before submitting them to the contractor. For example, the first owner Q1 may verify the dimensions and materials in the first design plan 1430 and facilitate that the electrical layout in the second design plan 1440 meets their requirements. This review process helps to identify any discrepancies or additional requirements before proceeding with construction.

Once the design plans are reviewed and approved by one or both the first owner Q1 and the third owner Q3, they can be transmitted to the contractor using the “submit to contractor” button 1408, as shown in FIG. 14A. This step facilitates that the contractor receives all required details, including the structural and electrical design plans, for executing the change order. For example, the contractor may use the first design plan 1430 to calculate the amount of concrete and steel required for constructing the balcony, while the second design plan 1440 provides a clear guide for installing the electrical components.

In some embodiments, the centralized system 1400 may allow further customization of the design plans based on user inputs. For example, the first owner Q1 may request additional features, such as a built-in seating area or a planter box on the balcony. These changes can be incorporated into the first design plan 1430, and the updated plan can be shared with the contractor. Similarly, the second design plan 1440 can be modified to include additional electrical components, such as a sound system or outdoor heaters, based on the owner's preferences.

The generation of detailed design plans, as shown in FIG. 14C, highlights the collaborative and dynamic capabilities of the centralized system 1400. By providing both structural and electrical layouts, the system facilitates that all aspects of the change order are addressed comprehensively. For example, the structural design plan 1430 facilitates that the balcony is safe and functional, while the electrical design plan 1440 enhances its usability and comfort. These features demonstrate the system's ability to streamline the construction process and minimize the risk of errors or omissions.

The detailed plans also serve as a communication tool between the owners and the contractor. For example, the contractor can use the first design plan 1430 to explain the construction process to the owners and obtain their approval for any deviations. Similarly, the second design plan 1440 can be used to discuss the electrical layout and address any concerns regarding the placement or type of components. This collaborative approach facilitates that all stakeholders are aligned and that the project is executed efficiently.

Furthermore, the centralized system 1400 may integrate additional features to enhance the utility of the design plans. For example, the system 1400 may provide a cost analysis for the materials and labor required for implementing the plans. This analysis can be presented alongside the design plans, allowing the owners to make informed decisions about the project. For example, the cost analysis may show that using LED lights instead of traditional bulbs can reduce long-term energy costs, prompting the owners to opt for the more sustainable option.

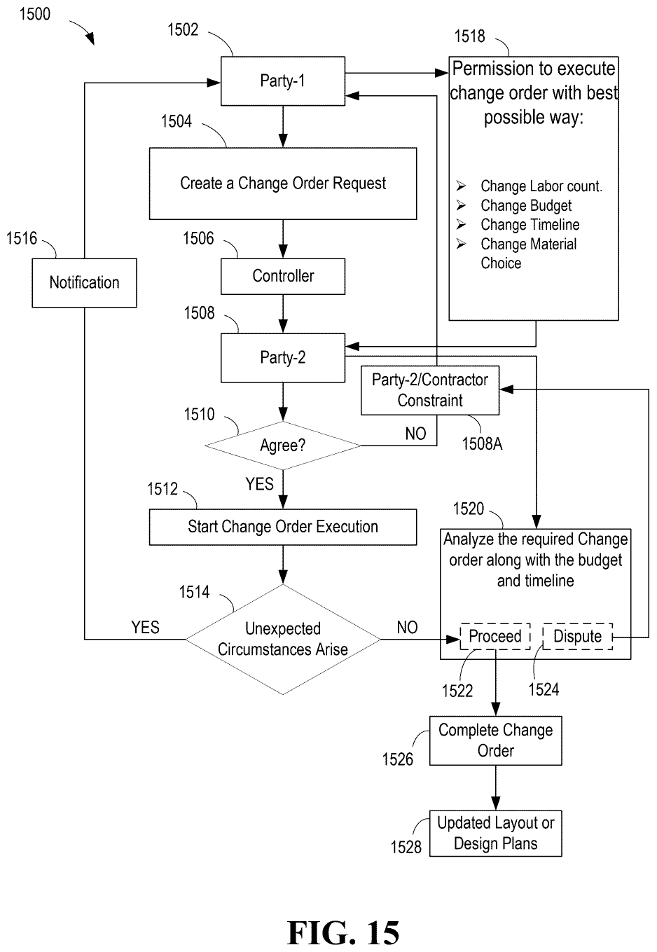

Referring now to FIG. 15, the figure illustrates an exemplary flowchart 1500 for the creation, approval, execution, and finalization of change orders related to construction or design plans. The flowchart showcases a step-by-step process to handle change requests, constraints, and collaborative interactions between multiple parties, including real-time updates to plans and associated data. The centralized system depicted in the figure facilitates efficient communication, analysis of interdependencies, and execution of approved modifications while addressing potential disputes or unexpected circumstances during implementation.

At Step 1502, a first party, which may be a client, contractor, or owner, accesses the design plan of at least a portion of a building through an interactive user interface. The design plan may include details of structural elements, layout configurations, and associated constraints such as timelines, budgets, or material requirements. For example, the first party may access a layout of an apartment building, a commercial complex, or an industrial plant. The interactive interface provides tools to visualize, mark, and annotate the design plan, allowing the first party to identify potential areas where modifications are needed. This access sets the foundation for initiating a change request.

At Step 1504, the first party creates a change order request by selecting a specific area or element on the design plan requiring modification. For example, the first party may wish to extend a balcony, relocate a staircase, or upgrade materials for certain components of the structure. The change order request may include detailed descriptions, supporting documents, or specifications, such as required dimensions, material preferences, and aesthetic considerations. Additionally, the first party may input associated constraints such as a budget ceiling, a specific timeline for completion, or material choices, all of which are factored into the subsequent analysis by the controller.

At Step 1506, the controller receives the change order request and initiates a detailed analysis to evaluate its feasibility and compliance. The controller, which may include an AI engine or a GAN engine, determines whether the proposed changes align with existing constraints, regulatory standards, and construction codes. The controller also identifies interdependencies with other elements or sub-plans, such as electrical wiring, plumbing layouts, or HVAC configurations, which may require adjustments due to the proposed change. For example, extending a balcony may necessitate relocating electrical outlets or rerouting HVAC ducts. The controller also identifies other parties affected by the proposed changes, such as adjacent property owners, contractors, or regulatory authorities, and sends notifications for their review and approval.

At Step 1508, a second party, who may be another property owner, contractor, or regulatory authority, receives the notification about the change order request. For example, if the first party proposes to construct a shared amenity, such as a combined balcony, the second party involved in the shared area receives detailed information about the change request. This notification includes the description of the change, associated constraints, and any supporting documents or visualizations submitted by the first party. The second party reviews this information to assess the implications of the proposed changes on their property or responsibilities.

At Step 1510, the second party evaluates the change order request and decides whether to agree or disagree. If the second party agrees, they send their approval to the centralized system, which moves the process to Step 1512, where a contractor begins executing the change order. For example, the second party may agree to a proposed modification of shared access areas or structural reinforcements. Alternatively, if the second party disagrees, the process diverts to Step 1508A, where the second party provides their constraints or suggestions, such as budget limitations, material preferences, or scheduling conflicts, for further review by the first party.

At Step 1512, once all required approvals are obtained, the contractor initiates the execution of the change order request. The contractor reviews the updated design plan and associated constraints to allocate resources and organize the workflow. For example, adding a new room may involve procuring materials, hiring skilled labor, and scheduling equipment deliveries. The centralized system provides real-time updates on progress, enabling all parties to track the status of the implementation.

At Step 1514, the contractor may encounter unexpected circumstances that hinder the smooth execution of the change order. These circumstances may include adverse weather conditions, unforeseen site conditions such as unstable soil, or personal issues affecting workforce availability. For example, during the construction of a new room, the contractor may discover an underground utility line that requires rerouting, thereby causing delays and additional costs. In such cases, the contractor sends a notification 1516 to the first party to discuss potential resolutions.

At Step 1508A, if the second party disagrees (from 1510) or the contractor raises a dispute 1524 at Step 1520 or unexpected circumstances arise (1514), the respective constraints or concerns are communicated back to the first party (1502) for review. For example, a contractor may request additional budget or extended timelines to accommodate unforeseen challenges. The centralized system facilitates transparent communication between all parties, allowing the first party to reassess and update the construction constraints at Step 1518. The updated constraints are then shared with all stakeholders, enabling iterative collaboration.

At Step 1520, the contractor evaluates the updated change order request, taking into account the budget, timeline, and other constraints. If the updated request aligns with the contractor's resources and expectations, the contractor proceeds 1522 with the task. Otherwise, the contractor may raise further disputes or request modifications, creating a feedback loop until a consensus is reached.

At Step 1526, the contractor completes the change order task as per the agreed-upon constraints. The centralized system records the completion status and notifies all stakeholders. For example, after constructing a shared balcony, the contractor uploads photographs and inspection reports to the centralized system for verification and documentation.

At Step 1528, the design plan and associated sub-plans, such as electrical, plumbing, or structural layouts, are updated in real-time to reflect the completed change order. These updates are made accessible to all parties through the interactive user interface, so that all stakeholders have the most recent version of the design plan. For example, the finalized design may include a shared balcony with reinforced supports and modified wiring schematics, reflecting the collaborative effort of all parties involved.

This flowchart 1500 exemplifies a robust process for managing change orders in a collaborative construction environment, addressing feasibility, interdependencies, and real-time updates through a centralized system. It demonstrates the seamless integration of user interactions, automated analysis, and coordinated execution to facilitate efficient and transparent decision-making.

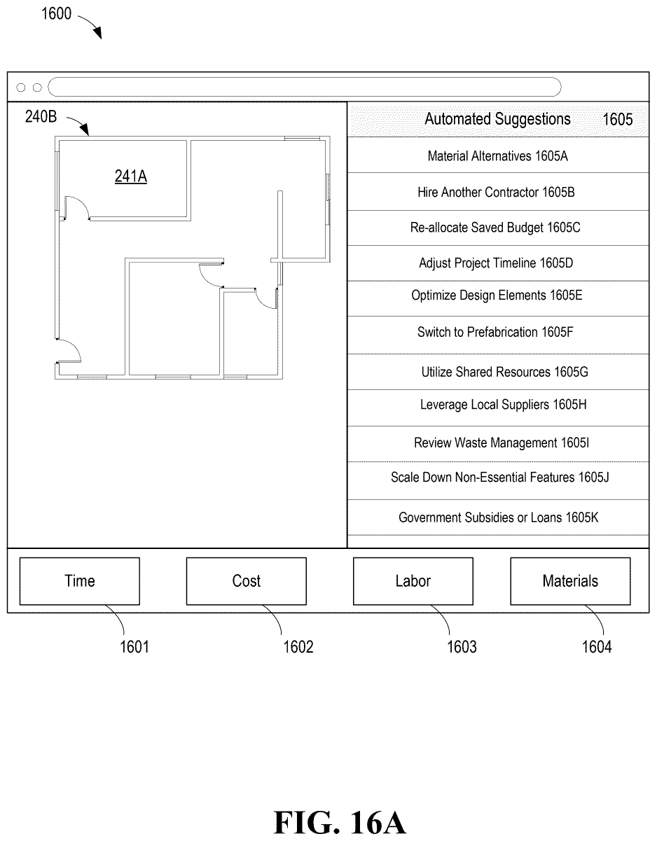

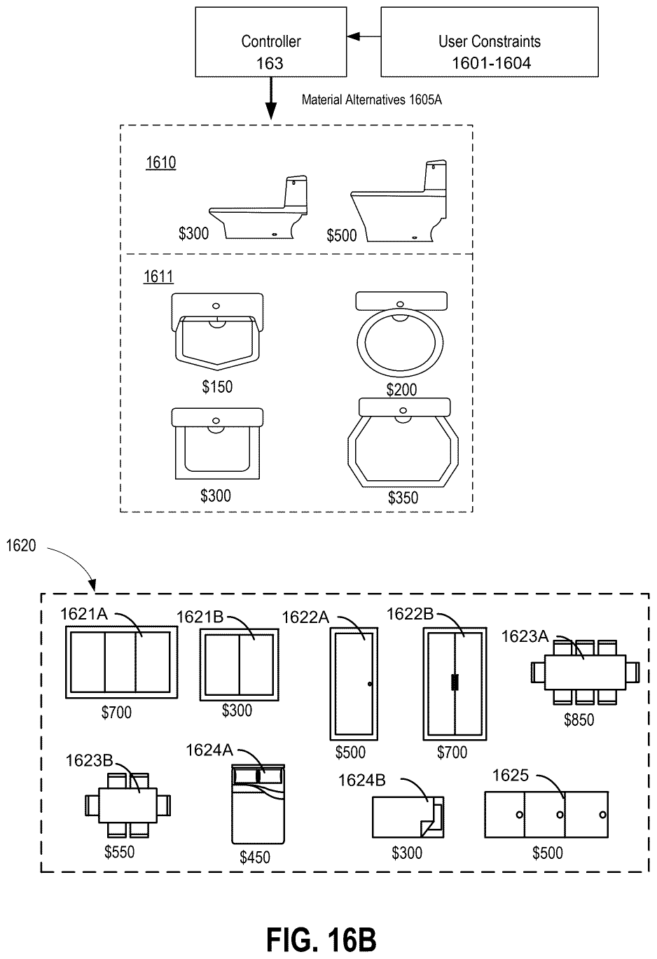

Referring now to FIGS. 16A-16B, these figures illustrate an exemplary user interface that enables a user to define fixed constraints for completing change orders, which are subsequently analyzed by the controller to generate automated suggestions. The user interface offers a dynamic and interactive platform where users, such as clients, contractors, or property owners, can specify their preferences or limitations, including fixed budgets, timelines, labor requirements, or material choices. By incorporating these constraints into the change order process, the system allows users to exercise control over the execution of changes while maintaining alignment with their defined parameters.

The controller, equipped with advanced processing capabilities such as an AI engine or a GAN engine, evaluates the fixed constraints input by the user and provides tailored automated suggestions for implementing the requested change orders. For example, if a user sets a fixed budget for constructing a new room, the controller may suggest material alternatives, labor reallocations, or adjustments in the timeline to complete the change order within the defined constraints. The user interface provides a seamless mechanism to review and approve these suggestions, so that the change orders are processed efficiently and transparently while adhering to user-defined constraints. These features enhance collaboration and decision-making, allowing users to optimize resources and achieve their objectives effectively.

FIG. 16A illustrates an interactive user interface 1600 that facilitates user interaction with a design plan of at least a portion of a building. The interface 1600 is designed to allow users, such as contractors, clients, or property owners, to initiate change order requests, adjust design elements, and set specific construction constraints for implementing modifications. In the embodiment shown, the interactive user interface 1600 presents an updated design plan 240B, which includes a newly added room 241A, as previously discussed in FIGS. 2E-2F. Users can interact with the design plan to perform actions such as moving, resizing, or modifying existing elements, adding new components, or annotating changes. These interactions are captured and processed by the controller (not shown in FIG. 16A), which evaluates the feasibility and implications of the requested changes.

The interactive user interface 1600 includes dedicated options for defining construction constraints, such as time 1601, cost or budget 1602, labor 1603, and materials 1604. These options enable users to specify fixed values or ranges for each constraint, so that the requested changes are implemented within the desired parameters. For example, a user may set a maximum budget using the cost constraint 1602 or define a strict deadline using the time constraint 1601. Additionally, the interface 1600 may offer other constraint options, such as environmental impact, regulatory compliance, or aesthetic considerations, depending on the nature of the project and the user's requirements. These constraints provide a structured framework for the controller to analyze and generate automated suggestions 1605 tailored to the user-defined parameters.

The automated suggestions 1605 presented on the interactive user interface 1600 provide actionable recommendations for implementing the change order request in alignment with the specified constraints 1601-1604. These suggestions are generated by the controller based on a comprehensive analysis of the constraints and the design plan. Each suggestion is aimed at optimizing the execution of the change order while maintaining adherence to the user-defined values. The following paragraphs describe each automated suggestion 1605A-1605K in detail, along with relevant examples and embodiments.

The first automated suggestion, Material Alternatives 1605A, proposes alternative materials that align with the defined constraints. For example, if a user sets a lower budget constraint 1602, the controller may suggest replacing high-cost materials, such as marble, with more affordable options, such as ceramic tiles or engineered stone. Similarly, if a project requires sustainable materials, the controller may recommend eco-friendly options, such as recycled wood or low-carbon concrete. This suggestion helps users achieve cost savings or meet specific project requirements without compromising on quality or functionality.

The second automated suggestion, Hire Another Contractor 1605B, recommends engaging additional contractors or subcontractors to expedite the implementation of the change order. For example, if the time constraint 1601 is set to a short duration, the controller may suggest hiring a specialized contractor with expertise in the required tasks to meet the deadline. This option facilitates that labor resources are effectively allocated to optimize project timelines.

The third automated suggestion, Re-allocate Saved Budget 1605C, advises users on reallocating funds saved from other aspects of the project to accommodate the change order or vice-versa. For example, if the labor costs for a specific task are lower than estimated, the controller may suggest using the saved budget to upgrade materials or add new design elements. This feature provides flexibility in resource allocation and enhances the overall project outcome.

The fourth automated suggestion, Adjust Project Timeline 1605D, recommends extending or revising the project timeline to accommodate the change order within the defined budget and labor constraints. For example, if the user sets a fixed budget constraint 1602 that limits material or labor options, the controller may propose a longer timeline to allow for phased implementation or alternative scheduling strategies.

The fifth automated suggestion, Optimize Design Elements 1605E, involves modifying the design plan to reduce complexity or resource requirements. For example, the controller may suggest simplifying intricate architectural details or reducing the dimensions of certain components to fit within the constraints. This option helps balance design aspirations with practical limitations.

The sixth automated suggestion, Switch to Prefabrication 1605F, advocates using prefabricated components to save time and labor. For example, if the labor constraint 1603 is set to a limited workforce, the controller may recommend using prefabricated walls or modular units that require minimal on-site assembly. This approach enhances efficiency and minimizes construction delays.

The seventh automated suggestion, Utilize Shared Resources 1605G, proposes leveraging shared resources, such as equipment or facilities, to reduce costs. For example, if the project site is located near another construction site, the controller may suggest sharing machinery or storage spaces to optimize resource utilization and minimize expenses.

The eighth automated suggestion, Leverage Local Suppliers 1605H, emphasizes sourcing materials from local suppliers to reduce transportation costs and timelines. For example, if the time constraint 1601 is tight, the controller may recommend procuring materials from nearby vendors to expedite delivery and facilitate timely project execution.

The ninth automated suggestion, Review Waste Management 1605I, focuses on minimizing construction waste to save costs and improve sustainability. For example, the controller may propose reusing demolition debris or recycling materials from previous construction activities to meet budget and environmental constraints.

The tenth automated suggestion, Scale Down Non-Essential Features 1605J, advises reducing or eliminating optional design features to prioritize important components. For example, if the budget constraint 1602 is restrictive, the controller may suggest omitting decorative elements or luxury finishes to allocate resources to structural or functional aspects.

The eleventh automated suggestion, Government Subsidies or Loans 1605K, highlights available financial assistance programs that align with the project's scope. For example, the controller may identify grants or subsidies for energy-efficient construction or recommend loan options for users facing budget constraints. This feature provides users with additional financial flexibility to complete the change order.

In some embodiments, the controller integrated with the interactive user interface may provide additional automated options tailored to the user-defined construction constraints such as time, cost, labor, and materials. These automated suggestions utilize advanced data analytics and predictive modeling to generate practical and efficient recommendations for implementing the change order while adhering to the user-defined limitations. For example, the controller may analyze the set constraints and propose dividing the change order into multiple phases. This phased construction approach allows important elements to be prioritized and implemented within the existing budget, while deferring non-essential components to subsequent phases, thus balancing financial limitations with project goals.

The controller may further suggest the use of sustainable and recyclable materials that align with the set material constraints or specific preferences for eco-friendly construction. For example, it may recommend alternatives such as recycled steel, reclaimed wood, or bamboo, which not only fit within the defined constraints but also reduce environmental impact. This recommendation can be particularly beneficial for projects aiming to achieve green certification or comply with environmental regulations. Additionally, the controller may propose sourcing these materials locally to minimize transportation costs and facilitate timely availability.

To address labor constraints, the controller may recommend strategies for optimizing workforce allocation. For example, it may identify tasks that can be outsourced to specialized subcontractors or propose dynamic reallocation of existing labor resources to maximize productivity. In cases where specific skills are required for implementing the change order, the controller may suggest training or upskilling existing workers. For example, short training sessions on the use of new construction techniques or tools may be organized, thereby reducing the dependency on external labor while maintaining project timelines.

In some cases, the controller may suggest modular design adjustments to streamline the construction process. For example, if the time constraint is particularly stringent, the controller may propose using prefabricated components or modular sections that can be easily integrated into the existing structure. This approach significantly reduces on-site construction time and allows the project to proceed without compromising the defined timeline. Additionally, the controller may identify opportunities for using temporary infrastructure, such as scaffolding or reinforcement, to support the implementation of the change order while maintaining the structural integrity of the site.

To optimize procurement strategies, the controller may analyze material constraints and recommend bulk purchasing options or shared procurement with nearby projects. For example, if two neighboring construction sites require similar materials, the controller may propose a joint procurement strategy to reduce overall costs. It may also recommend alternative vendors offering competitive pricing or faster delivery times, facilitating that the materials required for the change order are procured within the allocated budget and time constraints.

The controller may also provide suggestions to address budgetary constraints by proposing alternative financing options. For example, it may identify project-based loans, flexible payment plans, or government subsidies that align with the nature of the change order. In collaborative projects, the controller may facilitate shared financing arrangements between multiple stakeholders, distributing costs proportionally based on their respective contributions or benefits from the proposed changes.

For projects located in regions with unpredictable weather conditions, the controller may provide recommendations for weather-resistant materials or temporary site modifications to prevent delays. For example, it may suggest setting up protective shelters for workers and materials or adjusting the project schedule to prioritize tasks that can be completed regardless of weather conditions. This approach facilitates that the change order is implemented efficiently while mitigating potential risks posed by environmental factors.

In collaborative projects, the controller may facilitate resource-sharing arrangements between different stakeholders. For example, if two projects require the same construction equipment or tools, the controller may propose a shared usage schedule to optimize resource utilization and reduce rental costs. Similarly, the controller may identify overlapping labor requirements and suggest collaborative hiring or subcontracting to address these needs.

The controller may also generate adaptive design resolutions to simplify the implementation of complex change orders. For example, it may propose replacing intricate structural additions with simpler yet functional designs that are easier to construct and align with the defined constraints. Additionally, the controller may generate cost-benefit analysis reports for proposed changes, highlighting their financial impact and long-term benefits. For example, a report may demonstrate how premium materials with higher upfront costs reduce maintenance expenses over time, providing a comprehensive understanding of the value associated with the change order.

In some scenarios, the controller may provide recommendations for conflict mitigation strategies in projects involving multiple stakeholders. For example, it may propose phased implementation of shared changes or suggest incentives to address disputes between parties. Additionally, the controller may utilize a smart notification system to keep all stakeholders informed about the status of the change order, including approvals, progress updates, or adjustments to constraints. By addressing diverse constraints and providing actionable recommendations, the controller enables efficient and informed decision-making, facilitating the seamless implementation of change orders.

Referring now to FIG. 16B, the user-defined construction constraints 1601-1604 (shown in FIG. 16A) are analyzed by the controller 163, which then provides automated suggestions tailored to implement a change order request. The interactive user interface 1600 integrates these suggestions, offering detailed material, labor, cost, and timeline recommendations. The material alternatives 1605A provided by the controller 163 enable users to make informed decisions that align with their constraints while also facilitating direct procurement through the interface itself.

For example, when a fixed lower budget constraint is set through the cost field 1602, the controller 163 may suggest alternative water closets 1610. The options may include a basic model priced at $300 and a higher-end model priced at $500. These alternatives, displayed alongside their price tags, allow users to evaluate and select options that fit within their financial limitations. The interface further enables seamless integration of these materials into the project by providing procurement options, reducing the time and effort typically involved in sourcing materials.

Similarly, alternative wash basins 1611 are displayed with various price points. These include budget-friendly models at $150 and $200, as well as premium designs priced at $300 and $350. Such alternatives cater to diverse user preferences, whether prioritizing cost-effectiveness or design quality. The controller 163 processes real-time data, such as market availability and supplier pricing, to curate these options, so that they are both practical and accessible.

In another example, the controller 163 extends its automated suggestions to furniture alternatives, as depicted in section 1620. For example, window options include sliding windows 1621A priced at $700 and fixed-pane windows 1621B priced at $300. Depending on constraints such as labor availability 1603 or material preferences 1604, the user can select an appropriate design. The controller 163 also offers door alternatives, with options such as a basic wooden door 1622A priced at $500 and a reinforced steel door 1622B priced at $700. These suggestions balance functionality with user-defined constraints, facilitating optimal outcomes.

Dining table alternatives include 1623A priced at $ 850, designed for larger dining spaces, and 1623B priced at $550, suitable for compact areas. Similarly, bed designs are displayed as alternatives 1624A priced at $450 and 1624B priced at $300, catering to different space and cost considerations. Additional furniture, such as cabins 1625 priced at $500, is also included in the suggestions, offering users a comprehensive selection to fulfill their project requirements.

The interactive user interface 1600 allows users to adjust constraints dynamically, instantly updating the suggestions provided by the controller 163. For example, if the user modifies the budget constraint 1602 to allocate additional funds, the controller may replace lower-cost alternatives with premium options that offer enhanced durability or aesthetic appeal. This real-time adaptability empowers users to evaluate various scenarios and finalize a plan that aligns with their priorities.

The controller 163 also incorporates advanced algorithms to analyze interdependencies between constraints and materials. For example, if labor availability 1603 is limited, the controller may prioritize pre-assembled or easy-to-install options such as modular furniture or prefabricated windows and doors. Similarly, for projects with tight time constraints 1601, the controller may suggest materials readily available in the local market to expedite procurement and installation.

Beyond materials and furniture, the controller 163 provides recommendations to optimize labor allocation and project timelines. For example, if the project requires skilled labor for specific tasks, such as installing reinforced doors 1622B, the controller may suggest hiring contractors with expertise in that area. The system may also recommend alternative materials or methods to reduce labor intensity and meet project deadlines effectively.

The material alternatives displayed in FIG. 16B are not exhaustive. The controller 163 can generate a wide range of suggestions based on the complexity of the project and user-defined constraints. For example, for environmentally conscious users, the controller may prioritize sustainable options such as recycled materials for windows 1621A or bamboo for doors 1622A. Similarly, for projects with shared spaces or collaborative designs, the controller may recommend multifunctional furniture or modular components to maximize utility and minimize costs. In some embodiment, the controller 163 may also provide a detailed breakdown for other automated suggestions 1605B-1605K, offering users actionable insights for implementing the change order effectively.

In collaborative projects involving multiple stakeholders, the controller 163 harmonizes individual constraints to generate collective recommendations. For example, if two users are co-developing a shared space, the controller may suggest cost-sharing arrangements for premium materials or propose alternative designs that satisfy the preferences of both parties. This collaborative functionality enhances the efficiency and coordination of construction projects.

The automated suggestions (1605) provided by the controller 163 are designed to reduce project risks and optimize resource utilization. For example, by analyzing historical data and market trends, the controller may identify materials that are prone to supply chain disruptions and recommend alternatives to mitigate delays. Similarly, the controller may alert users to potential cost overruns based on fluctuating labor rates or material prices, enabling proactive adjustments to project plans.

The integration of automated suggestions into the interactive user interface 1600 streamlines the decision-making process for users, offering a holistic view of options and their implications. Whether selecting materials, adjusting labor plans, or reallocating budgets, the system provides actionable insights that empower users to execute change orders with precision and confidence.

In some embodiments of the present invention, the method additionally comprises determining a scale of the components included in the design plan and/or generating a user interface including user interactive areas to change at least one of: a size and shape of at least one of the dynamic components, the dynamic components may include, by way of non-limiting example, one or more of: architectural features, polygons or arcuate shapes; regions, areas, spaces, travel paths, egress paths, dominance hierarchies, occupancy loads, doorways, stairs, or other portion of a design plan that may be modified.

In some embodiments, dynamic components may include a polygon and/or arcuate shape. A method of practice of the present invention may further include the steps of: receiving an instruction via the interactive user interface to modify a parameter of the polygon and modifying the parameter of the polygon based upon the instruction received via the interactive user interface. The parameter modified may include one or both of: an area of the polygon; and a shape of the polygon.

In another aspect a dynamic component may include a line segment and/or arcuate segment, and methods of practice may include one or more of: receiving an instruction via an interactive user interface to modify a parameter of the line segment, and the method further includes the step of modifying the parameter of the line segment based upon the instruction received via the interactive user interface. The parameter of the line segment may include a length of the line segment, and the method may additionally include modifying a length of a wall based upon the modifying the length of the line segment.

The parameter modified may additionally include a direction of the line segment and the method may additionally include modifying an area of a room based upon the modifying of the length and direction of the line segment. A boundary may be set based upon reference to a boundary allocation hierarchy.

In another aspect, a price may be associated with each of the quantities of items to be included in construction of the building. In addition, a type of labor associated with at least one of the items to be included in construction of the building may be designated based upon AI analysis of the first two-dimensional reference (i.e., first design plan) and the second two-dimensional reference (i.e., second design plan), respectively.

Methods of practice may additionally include the steps of: determining whether a design plan received into the controller includes a vector image, and if one of the first and the second design plans received into the controller includes a vector image, converting at least a portion of the vector image into a raster image. Implementations of the described techniques may include hardware, a method or process, or computer software on a computer-accessible medium.

A dynamic component may include a line segment and/or vector, and the method may further include the steps of: receiving an instruction via the interactive user interface to modify a parameter of the line segment and/or vector and modifying the parameter of the line segment and/or vector based upon the instruction received via the interactive user interface. The modified parameter may include a magnitude of the line segment, and/or vector, and/or a direction of the vector.

The method may additionally include the step of training the AI engine based upon a human identifying portions of a design plan to indicate that it includes a particular type of item; or to identify portions of the design plan that include a boundary. The AI engine via may also be trained by reference to a boundary allocation hierarchy.

The methods may additionally include the steps of: determining whether the design plans received into the controller includes a vector image, and if the design plan received into the controller does include a vector image converting at least a portion of the vector image into a raster image; and/or whether a design plan includes a vector image format. Implementations of the described techniques and method steps may include hardware (such as a controller and/or computer server), a method or process, or computer software on a computer-accessible medium.

Still further, in some embodiments, the controller may assess how assignment of different classes of space to one or more designated areas may alter conformance of a design with a specified code. Furthermore, in some embodiments, particular attributes of a building may be analyzed based upon laws or regulations in effect within a geopolitical boundary encompassing the building. In some embodiments, multiple disparate user interfaces may be used to communicate calculated parameters associated with determined attributes.

There may be alternative methods of receiving data from various sources that can be used to generate a design or to supplement a design created in the manners as have been described previously. For example, the system may receive an architectural file with intelligent features of various kinds which will be discussed in further detail following. The present system may operate in concert with a BIM or CAD design system, for example, as an add-in to these design systems and then the present system may have access to design elements, location data and the like directly. In other examples, the present system may access BIM or CAD design system data by loading data files from said systems. In still further examples, the present system may operate to capture data from display screens that are displaying designs from the said BIM or CAD design systems. As an additional example, the present compliance assessment system exhibits its versatility by harmoniously integrating with prominent design frameworks like BIM or CAD. This integration facilitates a proactive approach to evaluate the compliance of building designs in the nascent or initial stages of the creative process, considering an array of potential best practices. This early-stage assessment not only facilitates that the design in progress aligns with regulatory standards but also serves as a strategic time-saving measure, optimizing the efficiency of the overall design workflow. The synergy between compliance analysis and design systems not only enhances the precision of the evaluation at early stages, but also contributes to a more streamlined and resource-efficient architectural and engineering endeavour.

In a non-limiting example, the present system may receive a file in one of the REVIT native formats such as files of types RVT, RFA, RTE and RFT. Embodiments may also include receiving non-Revit compatible file formats, such as, one or more of: BMP, PNG, JPG, JPEG, and TIF.

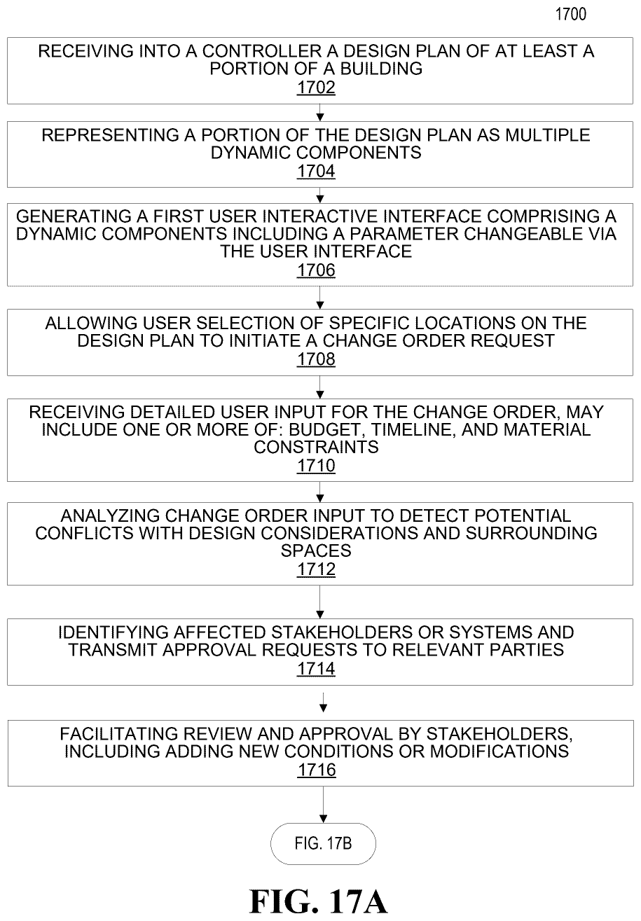

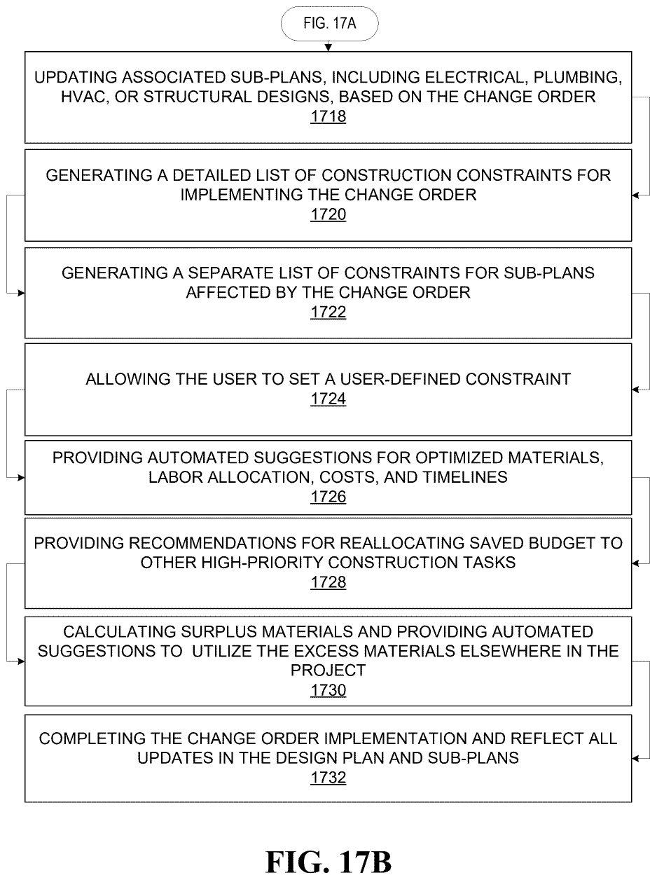

FIGS. 17A-17B illustrate exemplary flowchart 1700 of method steps 1702-1732 that outline a systematic approach for managing, processing, and executing change orders in design plans using a centralized system. These method steps 1702-1732 may be executed in some embodiments of the present invention to streamline the coordination and implementation of design modifications, particularly in scenarios involving multiple stakeholders, such as building owners, contractors, or regulatory authorities. The illustrated process is designed to incorporate user inputs, analyze potential conflicts or dependencies, provide automated suggestions for optimal execution, and update associated plans and constraints in real time. By leveraging advanced data processing and user-interactive interfaces, the method facilitates efficient collaboration, dynamic updates, and accurate execution of changes, thereby addressing challenges associated with traditional manual workflows.

At step 1702, the process begins by receiving into a controller a design plan of at least a portion of a building. This design plan may be provided in various formats, such as a CAD file, scanned blueprint, or even a digital drawing created using a compatible design software. For example, the design plan may represent a floor layout of a residential building, an industrial warehouse, or a commercial office space. This step establishes the starting point for all further processes, as it provides the spatial and architectural framework to which modifications will be applied. The received design plan serves as the input for the subsequent analysis and user interactions facilitated by the controller.

At step 1704, the controller processes the design plan by representing a portion of it as multiple dynamic components. These dynamic components may include individual architectural features such as walls, doors, windows, fixtures, or spaces like rooms or hallways. For example, in the context of a residential layout, a dynamic component may represent a bedroom, a kitchen, or a bathroom, each of which is assigned distinct attributes such as dimensions, material types, or functionalities. The dynamic representation enables the controller to isolate and manipulate these components individually, which is vital for analyzing dependencies and implementing user-initiated changes effectively.

At step 1706, the controller generates a first user-interactive interface comprising the dynamic components, including parameters changeable via the interface. The interactive interface allows users to view the design plan and interact with its components directly. For example, a user may select a wall component and adjust its height or move a window to a different position within a room. This interface not only visualizes the design but also empowers users to experiment with potential modifications, such as altering the dimensions of a space or relocating a fixture. The ability to manipulate parameters dynamically provides flexibility and precision in accommodating user preferences or project requirements.

At step 1708, the user is allowed to select specific locations on the design plan to initiate a change order request. For example, a contractor may select a portion of a floor plan to add a partition wall, or a client may choose to replace an existing window with a larger one for better ventilation. This selection process is typically performed using the interactive interface, where users can click or drag to highlight the area or component they wish to modify. The system may also support advanced selection tools, such as snapping to architectural features or filtering components by type, to facilitate precise inputs from the user.

At step 1710, the system receives detailed user input for the change order, which may include specifications such as budget, timeline, and material constraints. For example, a user may specify that the modification must be completed within a $10,000 budget, using eco-friendly materials, and within a two-week timeline. These inputs are important for the controller to tailor its analysis and suggestions to meet the user's constraints and project objectives. The user may also attach supplementary documents, such as sketches or technical specifications, to provide additional context for the requested changes.

At step 1712, the controller analyzes the change order input to detect potential conflicts with design considerations and surrounding spaces. For example, if the user requests to extend a room, the controller may evaluate whether the expansion interferes with adjacent spaces, structural supports, or compliance requirements such as building codes. The analysis may also account for interdependencies between various subsystems, such as HVAC, plumbing, or electrical layouts, to assess how the requested changes impact the overall design. If conflicts are identified, the controller may propose adjustments or alternatives to address these issues.

At step 1714, the controller identifies affected stakeholders or systems and transmits approval requests to relevant parties. For example, if the change order impacts a neighboring property, the controller may notify the respective property owner for consent. Similarly, if the change requires reconfiguration of an HVAC system, the relevant contractor may be notified. The controller facilitates that all affected parties, including regulatory authorities or project managers, are included in the decision-making process. Notifications may include detailed descriptions of the proposed changes, their implications, and any supporting documentation provided by the initiating user.

At step 1716, the process facilitates review and approval by stakeholders, including adding new conditions or modifications to the proposed change order. For example, a neighboring property owner may approve the change order on the condition that noise-reducing measures are implemented during construction. Alternatively, a contractor may request additional budget or time to accommodate unforeseen complexities in the modification. These conditions are incorporated into the change order process, allowing for collaborative resolution and consensus among all involved parties before proceeding further.

At step 1718, the system updates associated sub-plans, including electrical, plumbing, HVAC, or structural designs, based on the change order. For example, if a wall is relocated in the architectural design, the HVAC sub-plan may need to adjust duct placements, and the electrical sub-plan may need to move outlets or switches to align with the new layout. Similarly, the plumbing sub-plan may require modifications to reroute pipes if the relocation impacts bathrooms or kitchens. The system analyzes all interconnected plans and generates updates dynamically to maintain consistency and compliance across all affected areas. For example, if a new room is added, the structural sub-plan may add support beams, while the electrical sub-plan may introduce additional circuits.

Regulatory changes introduced during the project can also affect the original design plan. Building codes and safety standards are frequently updated, often requiring mid-project adjustments. For example, new fire safety regulations might mandate additional exits or updated sprinkler systems. Compliance with these regulatory changes necessitates alterations to structural, HVAC, and fire safety plans, which must be documented through change orders to maintain regulatory alignment.

Advancements in technology can prompt clients to request new features during construction. For example, as smart building technologies become more prevalent, clients may decide to incorporate IoT devices, requiring adjustments to electrical, HVAC, and security plans. The infrastructure needed for these devices often differs from traditional systems, creating a need for design revisions to support modern technology.

Material substitutions, often driven by supply chain disruptions, are another frequent cause of design changes. When specific materials are unavailable, contractors may need to identify substitutes, impacting structural integrity, insulation properties, or aesthetic features. For example, if a particular type of steel beam is unavailable, a substitute material may affect load-bearing calculations and necessitate structural adjustments. Each substitution requires recalculations and updates to all relevant plans to maintain cohesion.

A change to a design plan may impact a project's budget, as initial cost estimates are based on the original specifications. Alterations, whether in materials, layout, or systems, may require a new cost calculation to reflect the added expenses or resource shifts. For example, choosing sustainable materials over standard options often incurs higher costs, which must be accounted for in the project budget. Change orders formalize these updates, helping maintain financial transparency and accountability.

Modifications to design elements may also influence the project's timeline, as each adjustment requires coordination across multiple teams. For example, expanding a floor space to include additional rooms affects structural reinforcements, HVAC capacity, and electrical configurations. Contractors must adjust their schedules to accommodate these changes, underscoring the need for well-documented and promptly communicated change orders.

At step 1720, the controller generates a detailed list of construction constraints for implementing the change order. This list may include materials required, labor hours, estimated costs, and timelines. For example, if a change order involves adding a balcony, the construction constraints may detail the type of materials, such as reinforced steel and concrete, the labor resources required for installation, and the estimated duration for completion. This comprehensive list is presented to the user or stakeholders to facilitate planning and approval, so that all required resources and timelines are clearly defined.

At step 1722, the system generates a separate list of constraints for sub-plans affected by the change order. For example, if a room is expanded, the HVAC sub-plan may require modifications to include additional air ducts, and the plumbing sub-plan may need to extend water supply lines. The generated constraints for each sub-plan provide detailed information specific to that domain, such as the number of additional duct sections, the type of insulation needed for HVAC systems, or the size and type of pipes required for plumbing. This separation of constraints facilitates that contractors and stakeholders for each domain receive targeted and actionable information to implement the required changes.

At step 1724, the system allows the user to set user-defined constraints, such as budget limitations, timelines, material preferences, or labor allocation. For example, a user may set a budget cap for a specific change order, such as limiting the cost of a new room addition to $15,000. Similarly, the user may specify a preference for eco-friendly materials or a requirement to complete the project within two weeks. These constraints are incorporated into the system's planning and suggestion algorithms, so that the proposed solutions align with the user's goals and limitations.

At step 1726, the controller provides automated suggestions for optimized materials, labor allocation, costs, and timelines. For example, if a user-defined constraint limits the budget for a change order, the system may recommend less expensive material alternatives, such as composite wood instead of hardwood for flooring. Similarly, if the timeline is a priority, the system may suggest prefabricated components to reduce on-site labor time. These automated suggestions help users make informed decisions by presenting cost-effective, time-saving, and resource-efficient options for completing the change order.

At step 1728, the system provides recommendations for reallocating saved budgets to other high-priority construction tasks. For example, if a change order is completed under budget, the system may suggest using the surplus funds to upgrade other areas, such as installing energy-efficient lighting or enhancing landscaping. These recommendations are presented dynamically, taking into account the overall project scope and user-defined priorities, so that surplus resources are utilized effectively to enhance the project's value.

At step 1730, the system calculates surplus materials resulting from the change order and provides automated suggestions for utilizing these materials elsewhere in the project. For example, if surplus bricks remain after constructing a new wall, the system may recommend using them for landscaping or creating a small boundary wall. Similarly, excess wood from furniture modifications may be repurposed for shelving or decorative elements. This step promotes sustainability by minimizing waste and optimizing resource utilization.

At step 1732, the system completes the change order implementation and reflects all updates in the design plan and associated sub-plans. For example, after a room addition, the updated design plan may include revised architectural layouts, new electrical diagrams showing outlet placements, and adjusted HVAC and plumbing plans. These updates are shared with all relevant stakeholders, including contractors and project managers, to maintain consistency and transparency. The finalized plans facilitate that all parties have access to the latest information, facilitating seamless execution of the change order and the integration of modifications into the overall project.

### Glossary

“Artificial Intelligence” as used herein means machine-based decision making and machine learning including but not limited to: supervised and unsupervised recognition of patterns, classification, and numerical regression. Supervised learning of patterns includes a human indicating that a pattern (such as a pattern of dots formed via the rasterization of a two-dimensional image) is representative of a line, polygon, shape, angle or other geometric form, or an architectural aspect, unsupervised learning can include a machine finding a pattern submitted for analysis. One or both may use mathematical optimization, formal logic, artificial neural networks, and methods based on one or more of: statistics, probability, linear regression, linear algebra, and/or matrix multiplication.

“AI Engine” as used herein an AI Engine (sometimes referred to as an AI model) refers to methods and apparatus for applying artificial intelligence and/or machine learning to a task performed by a controller. In some embodiments, a controller may be operative via executable software to function as an AI engine capable of recognizing aspects and/or tally aspects of a design plan that are relevant to generating an estimate for performing projects included in construction of a building or other activities related to construction of a building.

“Computer Aided Design,” sometimes referred to as “CAD,” as used herein shall mean the use of automation for the creation, modification, analysis, or optimization of a design plan or design plan file.

“Building Information Modeling” sometimes referred to as “BIM,” as used herein.

“Vector File” as used herein a vector file is a computer graphic that uses mathematical formulas to render its image. In some embodiments, a sharpness of a vector file will be agnostic to size within a range of sizes viewable on smart devices and personal computer display screens.

Typically, a vector image includes segments with two points. These two points create a path. Paths can be straight or curved. Paths may be connected at connection points. Connected paths form more complex shapes. More points may be used to form longer paths or closed shapes. Each path, curve, or shape has its own formula, so they can be sized up or down and the formulas will maintain the crispness and sharp qualities of each path.

A vector file may include connected paths that may be viewed as graphics. The paths that make up the graphics may include geometric shapes or portions of geometric shapes, such as: circles, ellipsis, Bezier curves, squares, rectangles, polygons, and lines. More sophisticated designs may be created by joining and intersecting shapes and/or paths. Each shape may be treated as an individual object within the larger image. Vector graphics are scalable, such that they may be increased or decreased without significantly distorting the image.

The terms “design plan,” “building plan,” “building design,” “floor plan,” “two-dimensional reference,” “two-dimensional or three-dimensional static representation,” or simply “design” are used interchangeably, often referring to the same or similar concepts in the context of architectural or construction documentation.

The present invention provides for systems of one or more computers that can be configured to perform particular operations or actions by virtue of having software, firmware, hardware, or a combination of them installed on the system that in operation causes or cause the system to perform the actions. One or more computer programs can be configured to perform artificial intelligence operations or actions by virtue of including instructions that, when executed by data processing apparatus, cause the apparatus to perform the actions.

### Conclusion

A number of embodiments of the present disclosure have been described. While this specification contains many specific implementation details, they should not be construed as limitations on the scope of any disclosures or of what may be claimed, but rather as descriptions of features specific to particular embodiments of the present disclosure. While embodiments of the present disclosure are described herein by way of example using several illustrative drawings, those skilled in the art will recognize the present disclosure is not limited to the embodiments or drawings described. It should be understood the drawings, and the detailed description thereto, are not intended to limit the present disclosure to the form disclosed, but to the contrary, the present disclosure is to cover all modifications, equivalents and alternatives falling within the spirit and scope of embodiments of the present disclosure as defined by the appended claims.

The headings used herein are for organizational purposes only and are not meant to be used to limit the scope of the description or the claims. As used throughout this application, the word “may” be used in a permissive sense (i.e., meaning having the potential to), rather than the mandatory sense (i.e., meaning must). Similarly, the words “include,” “including,” and “includes” mean including but not limited to. To facilitate understanding like reference numerals have been used, where possible, to designate like elements common to the figures.

The phrases “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted the terms “comprising,” “including,” and “having” can be used interchangeably.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while method steps may be depicted in the drawings in a particular order, this should not be understood as requiring that such operations be performed in the particular order shown or in a sequential order, or that all illustrated operations be performed, to achieve desirable results.

Moreover, the separation of various system components in the embodiments described above should not be understood as requiring such separation in all embodiments, and it should be understood that the described program components and systems can generally be integrated together into a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous. Nevertheless, it will be understood that various modifications may be made without departing from the spirit and scope of the claimed disclosure.

1. A computer-implemented system for processing building design plans and authorizing change orders, the system comprising:
a display screen configured to present an interactive user interface;
a digital storage medium comprising an executable software code; and
a controller operating one or both of: an Artificial Intelligence (AI) engine and a Generative Adversarial Network (GAN) engine, wherein the controller comprises a processor, and wherein the executable software code, when executed by the processor, causes the processor to:
a. receive, by the controller, an initial design plan of at least a portion of a building;
b. generate, with the controller, the interactive user interface based upon artificial intelligence analysis of the initial design plan, wherein the interactive user interface allows a user to view, select, and interact with one or more design elements of the initial design plan;
c. receive, via the interactive user interface, a change order request from the user, the change order request specifying modification to the one or more design elements of the initial design plan:
d. analyze, by the controller, the received change order request to determine an impact on one or more initial constraints and on one or more interrelated design elements of the initial design plan, wherein the one or more initial constraints comprise contractually agreed constraints established among stakeholders of the initial design plan;
e. generate, by the controller, a set of updated constraints based on the analysis in step (d), the set of updated constraints comprising recalculated values for one or more of: time, cost, labor, and materials required to implement the change order request;
f. identify, by the controller, one or more stakeholders affected by the change order request; and
g. transmit, by the controller, the change order request along with the set of updated constraints to the one or more stakeholders affected by the change order request for approval.

2. The system of claim 1, wherein the AI engine is further configured to simulate the impact of the change order request on the initial design plan and provide visual feedback through the interactive user interface.

3. The system of claim 1, wherein the controller is configured to integrate external data sources, such as building codes and material availability, into an evaluation of the change order request.

4. The system of claim 1, wherein the interactive user interface includes tools for annotating the one or more design elements with comments, measurements, and other relevant data.

5. The system of claim 1, wherein the interactive user interface allows the user to view a comparison between the one or more initial constraints and the set of updated constraints.

6. The system of claim 1, further comprising a database storing historical change orders and their outcomes, which the AI engine uses to predict potential challenges and solutions for new change orders.

7. The system of claim 1, wherein the executable software code, when executed by the processor, causes the processor to send alerts to the stakeholders via one or more of: email, SMS, and a project management platform.

8. The system of claim 1, wherein the interactive user interface allows for real-time collaboration among multiple users, enabling simultaneous review and discussion of the change orders.

9. The system of claim 1, wherein the AI engine is configured to provide automated suggestions for optimizing the initial design plan based on user-defined priorities, such as cost efficiency or sustainability.

10. The system of claim 1, wherein the executable software code, when executed by the processor, causes the processor to generate a detailed report outlining a rationale for the approval of the change order request, including any conditions or modifications required.

11. The system of claim 1, wherein the executable software code, when executed by the processor, causes the processor to allow the users to order materials directly through the interactive user interface.

12. The system of claim 1, wherein the AI engine is configured to identify potential conflicts between the change order request and existing design elements, and to propose resolutions.

13. The system of claim 1, wherein the interactive user interface includes a dashboard displaying key metrics related to the change order request, such as cost impact, timeline adjustments, and resource allocation.

14. The system of claim 1, wherein the AI engine is configured to learn from user interactions to improve accuracy and relevance of its analyses and suggestions.

15. The system of claim 1, wherein the system is configured to track a status of the change orders and provide updates to the stakeholders throughout an authorization process.

16. The system of claim 1, wherein the interactive user interface includes a feature for visualizing changes in the initial design plan in three dimensions, enhancing user understanding of the impact.

17. The system of claim 1, wherein the system is configured to prioritize the change orders based on urgency, impact, and stakeholder input.

18. The system of claim 1, wherein the AI engine is configured to assess an environmental impact of the change order request and suggest eco-friendly alternatives.

19. The system of claim 1, wherein the controller is configured to generate a summary of a change order process, including key decisions, stakeholder feedback, and final outcomes, for archival and review purposes.

20. The system of claim 1, wherein the controller is configured to identify conflicts between the change order request and one or more design considerations stored in a design consideration database.

21. A method for managing change order in a design plan of a building, the method comprising the steps of:
a. receiving, by a controller, an initial design plan of at least a portion of the building, wherein the controller operating one or both of: an Artificial Intelligence (AI) engine and a Generative Adversarial Network (GAN) engine;
b. with the controller, generating an interactive user interface based upon artificial intelligence analysis of the initial design plan, wherein the interactive user interface allows a user to view, select, and interact with one or more design elements of the initial design plan;
c. receiving, via the interactive user interface, a change order input from the user, the change order input specifying modification to the one or more design elements of the initial design plan;
d. analyzing, by the controller, the received change order input to determine an impact on one or more initial constraints and on one or more interrelated design elements of the initial design plan, wherein the one or more initial constraints comprise contractually agreed constraints established among stakeholders of the initial design plan;
e. generating, by the controller, a set of updated constraints based on the analysis in step (d), the set of updated constraints comprising recalculated values for one or more of: time, cost, labor, and materials required to implement the change order;
f. identifying, by the controller, one or more stakeholders affected by the change order input; and
g. transmitting, by the controller, the change order input along with the set of updated constraints to the one or more stakeholders affected by the change order input for approval.

22. The method of claim 21, wherein the interactive user interface allows the user to view a comparison between the one or more initial constraints and the set of updated constraints.

23. The method of claim 21, wherein the change order input is added by selecting a specific spot on the design plan displayed on the interactive user interface and providing a description for the change order.

24. The method of claim 21, further comprising receiving, by the controller, design considerations including at least one of: regulatory requirements, structural integrity parameters, and user-defined preferences.

25. The method of claim 24, further comprising determining compliance of the change order input with the design considerations.

26. The method of claim 21, wherein the interactive user interface allows the user to input additional constraints, including at least one of: a fixed budget, timeline, the labor, and material choice.

27. The method of claim 21, wherein the controller calculates surplus materials resulting from the change order and provides automated suggestions for utilizing the surplus materials elsewhere in the building.

28. The method of claim 21, further comprising receiving, by the controller, a response from the one or more stakeholders affected by the change order input, wherein the response includes one of: approval, rejection, and modification condition.

29. The method of claim 21, wherein the one or more stakeholders include one or more of: a building owner, a contractor, a sub-contractor, a secondary owner, a regulatory authority, and a design consultant.

30. The method of claim 21, wherein the set of updated constraints includes a breakdown of labor requirements for implementing the change order.

31. The method of claim 21, wherein the interactive user interface allows real-time collaboration between multiple users for discussing and approving the change order.

32. An apparatus for managing change order in a design plan of a building, the apparatus comprising:
a display screen configured to present an interactive user interface;
a digital storage medium comprising an executable software code; and
a controller operating one or both of: an Artificial Intelligence (AI) engine and a Generative Adversarial Network (GAN) engine, wherein the controller comprises a processor, and wherein the executable software code, when executed by the processor, causes the processor to:
a. receive, by the controller, an initial design plan of at least a portion of the building;
b. generate, with the controller, the interactive user interface based upon artificial intelligence analysis of the initial design plan, wherein the interactive user interface allows a user to view, select, and interact with one or more design elements of the initial design plan;
c. receive, via the interactive user interface, a change order request from the user, the change order request specifying modification to the one or more design elements of the initial design plan;
d. analyze, by the controller, the received change order request to determine an impact on one or more initial constraints and on one or more interrelated design elements of the initial design plan, wherein the one or more initial constraints comprise contractually agreed constraints established among stakeholders of the initial design plan;
e. generate, by the controller, a set of updated constraints based on the analysis in step (d), the set of updated constraints comprising recalculated values for one or more of: time, cost, labor, and materials required to implement the change order;
f. identify, by the controller, one or more stakeholders affected by the change order request; and
g. transmit, by the controller, the change order request along with the set of updated constraints to the one or more stakeholders affected by the change order request for approval.

33. The apparatus of claim 32, wherein the controller is configured to identify conflicts between the change order request and one or more design considerations stored in a design consideration database.

34. The apparatus of claim 32, wherein the interactive user interface provides a drag-and-drop functionality for moving the one or more design elements within the design plan.

35. The apparatus of claim 32, wherein the controller determines whether the change order request affects structural integrity by analyzing interdependencies between structural components.

36. The apparatus of claim 32, wherein the controller notifies one or more affected parties about the change order request and receives their approvals or conditions via the interactive user interface.

37. The apparatus of claim 32, wherein the controller integrates real-time data from external databases to verify material availability for the change order request.

38. The apparatus of claim 32, wherein the set of updated constraints includes recommendations for reallocation of budget savings to other design elements or additional features.

39. The apparatus of claim 32, wherein the controller generates sub-plans, such as electrical or plumbing plans, based on the set of updated constraints resulting from the change order request.

40. The apparatus of claim 32, wherein the interactive user interface includes options for defining fixed or flexible construction constraints, such as cost ceilings or labor hours.
